(19) United States
(12) Patent Application Publication
(10) Pub. No.: US 2025/0381526 A1
(43) Pub. Date: Dec. 18, 2025

(54) A HIGH SELECTIVITY, HIGH DISSOCIATION SIMPLE AND EFFICIENT SYSTEM FOR THE LASER SEPARATION OF THE UF6 ISOTOPES AND OTHER HEXAFLUORIDES

(71) Applicant: LUMENAUTICS LIMITED, Limassol (CY)

(72) Inventor: Doros ANDREOU, Limassol (CY)

(73) Assignee: LUMENAUTICS LIMITED, Limassol (CY)

(21) Appl. No.: 18/726,983

(22) PCT Filed: Dec. 13, 2022
(86) PCT No.: PCT/EP2022/085552

§ 371 Date: Jul. 5, 2024

(30) Foreign Application Priority Data
Jan. 6, 2022 (LU) LU102898

(51) Int. Cl. B01D 59/34

(52) U.S. Cl. CPC B01D 59/34

(57) ABSTRACT

The discovery of a method and the invention of a system for obtaining very high selectivity—and dissociation of the desired ²³⁵UF₆ isotope in the Molecular Laser Isotope Separation (MLIS) process of the Uranium Hexafluoride (UF₆) isotopes, in a single highly selective step, is described. The principle of the process and the concept of the invention are very simple: At temperatures below 100° K., and. preferably in the region of 60° K, nearly all the molecules of the expansion supercooled UE₆ gas are in the ground state enabling the principles of the invention to be practically applied without-any ‘interference from other inherent, processes. Then the frequency of the selecting laser must be at 628.527 cm⁻¹, or very close to it, for a three-photon absorption resonance with the [m(A₂):(3V₃)] sublevel of the third energy excitation state of the desired ²³⁵UF₆ isotope. The fixing of the frequency of the selecting laser is the first basic step of the invention. The second basic step is to increase the pumping intensity of the selecting laser to a. level at which the—three-photon absorption resonance with the [m(A₂):(3V₃)]sublevel, of the desired ²³⁵UF₆ isotope is established, elevating the molecules of the desired isotope ²³⁵UF₆ to the third energy excitation state. This is achieved through the power broadening at the fundamental and the second energy excitation level as the pumping intensity of the selecting laser is increased and as a consequence of the proximity of these levels to ‘the pumping frequency. There is an intensity range for the selecting laser within which the molecules of the desired ²³⁵UF₆ isotope can be selectively elevated to the third energy level through the establishment of a three-photon absorption resonance without disturbing the molecules of the unwanted, isotope ²³⁸UF₆, leaving them unexcited. The selectively excited molecules of the desired ²³⁵UF₆ isotope are then driven to dissociation through, the higher vibrational levels of the v₃-vibrational mode and. the quasicontinuum of energy states, by a simultaneously applied dissociating laser whose exact intensity and optimum frequency can again be experimentally determined, or by any other dissociation or separation-process following the original excitation of the ²³⁵UF₆ molecules to the ‘third energy excitation state (3v₃) through three-photon resonance with the [m(A₂):(3V₃)] sublevel. The process is unique in that it can be applied, to the treatment and separation of the desired ²³⁵UF₆ isotope from the Tails percentages of any isotope separation process. The method may also be. applicable to the SILEX system for enhancing the selectivity and efficiency of the process. The simplicity and versatility of the method enables: it to be applied to the separation of other hexafluoride isotopes or similar polyatomic molecules.

### CROSS REFERENCE TO RELATED APPLICATION(S)

This application is a 35 U.S.C. § 371 National Stage of International Patent Application No. PCT/EP2022/085552, filed Dec. 13, 2022, claiming benefit from Luxembourg Patent Application No. LU102898, filed Jan. 6, 2022, the disclosures of which are incorporated herein in their entirety by reference, and priority is claimed to each of the foregoing.

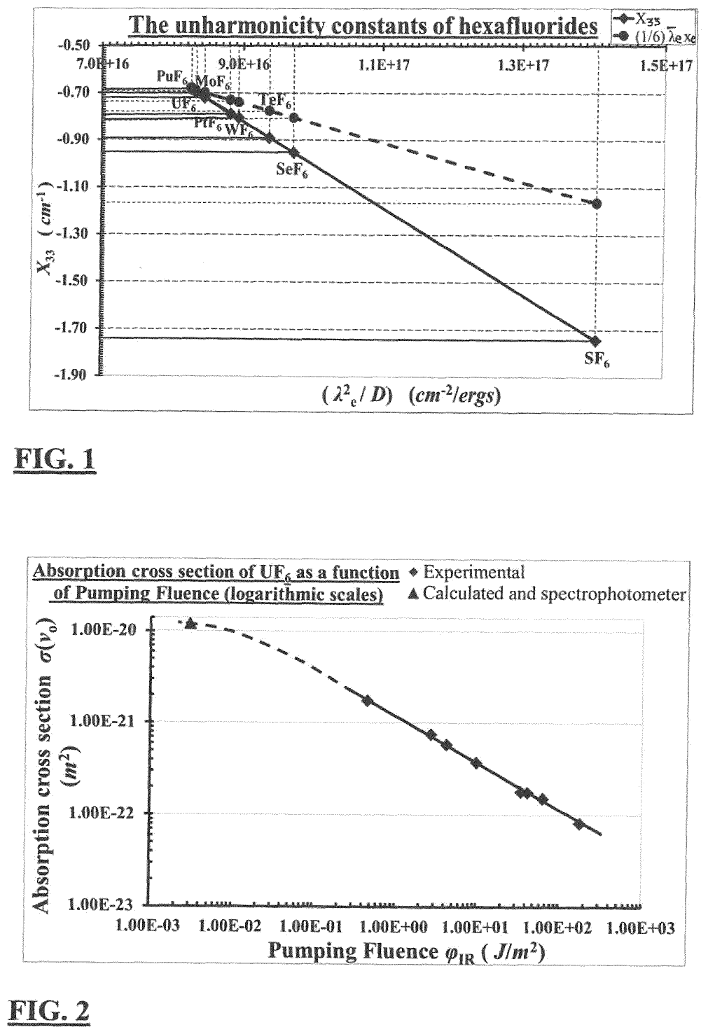

The Molecular Laser Isotope Separation (MLIS) method is the most desirable process for the separation of the Uranium isotopes because it can readily be incorporated into the well established technology of the Uranium Hexafluoride (UF₆) fuel cycle. The discovery of a method and the invention of a very simple system for application in the MLIS process are described. Very high selectivity of the desired isotope ²³⁵UF₆ with high dissociation yield can be achieved. The process and the invention rely on engineering which has already been demonstrated to the prototype stage, and on lasers which can be provided at the level of commercial application by any laser company within a few months. The system can be applied for the separation of any other closely spaced Hexafluorides. Another important factor is that, unlike any other UF₆ isotope separation process, the invention can be used for the treatment of the Tails percentages of depleted UF₆. The commercial realization of the MLIS process has hitherto stumbled on two factors: The achievement of high selectivity for the molecules of the desired isotope ″′UF₆, and the subsequent dissociation of the selectively excited molecules. Both these factors are easily solved through the present invention. A method for obtaining high dissociation yield in a single highly selective step in the Molecular Laser Isotope Separation (MLIS) process is embodied in the present invention and it is described with reference to FIGS. 1-19:

FIG. 1 shows the measured and calculated (from the analysis of the Schrödinger equation using the equivalent Morse potential) anharmonicity constants of the Hexafluorides. It is clear that as we move towards the heavy Hexafluorides the two values become identical demonstrating the equivalence of the vibrational ladder of the heavy Hexafluorides to that of an ideal harmonic oscillator.

FIG. 2 shows the absorption cross section of UF₆ as a function of Pumping Fluence on a logarithmic scale at a gas temperature of 105° K and frequency of 627.6 cm⁻¹ It demonstrates that when the graph of the experimental measurements obtained using a diode laser are extended towards very low pumping fluences they are in very good agreement With the calculated theoretical results and the results from low fluence spectrophotometer experiments. This supports the consistency of the theoretical expressions given in the text and demonstrates that the vibrational ladder of the heavy Hexafluorides is a very dose match to that of an ideal harmonic oscillator.

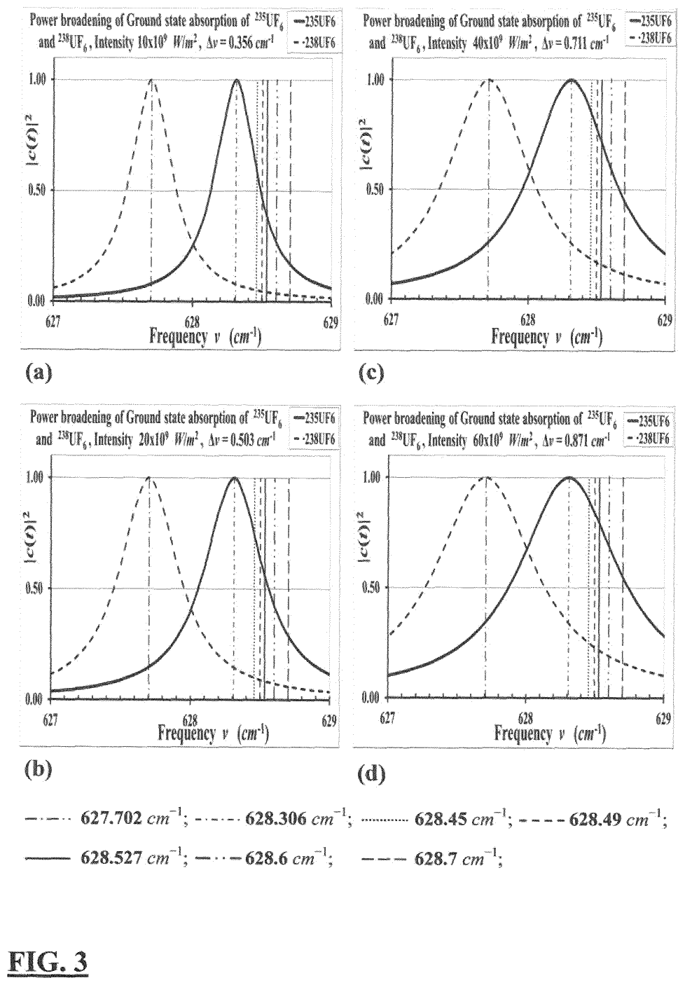

FIG. 3 shows the power broadened absorption probabilities of the fundamental for the two Uranium isotopes ²³⁸UF₆ and ²³⁵UF₆, for four different pumping beam intensities ranging from 10×10⁹ W/m² to 60×10⁹ W/m², graphs (a) to (d). The peaks of the curves are located at the center of the absorption lines. We see that as we increase the pumping intensity the widths of tire absorption curves increase rapidly. Our interest in this invention lies mostly in the 5×10⁹ W/m² to 30×10² W/m² region.

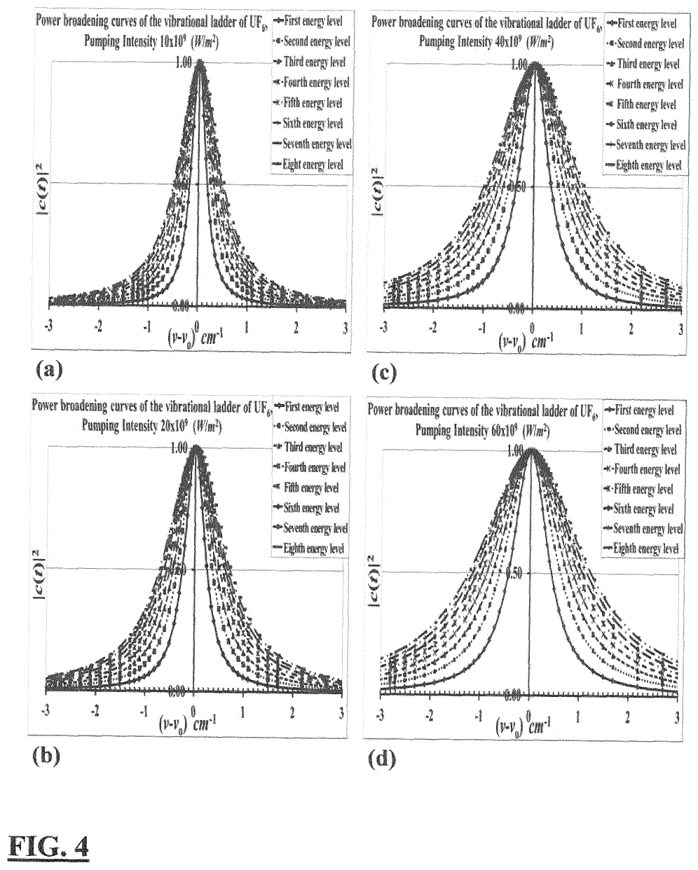

FIG. 4 shows the power broadening curves for the consecutive transitions of the first eight vibrational levels of the UF₆ ν₃-vibrational ladder, for four different pumping intensities ranging from 10×10⁹ W/m² to 60×10⁹ W/m². The power broadening of the transitions increases progressively with higher vibrational levels as well as with higher pumping intensity. Only the lower levels are of particular interest in the invention.

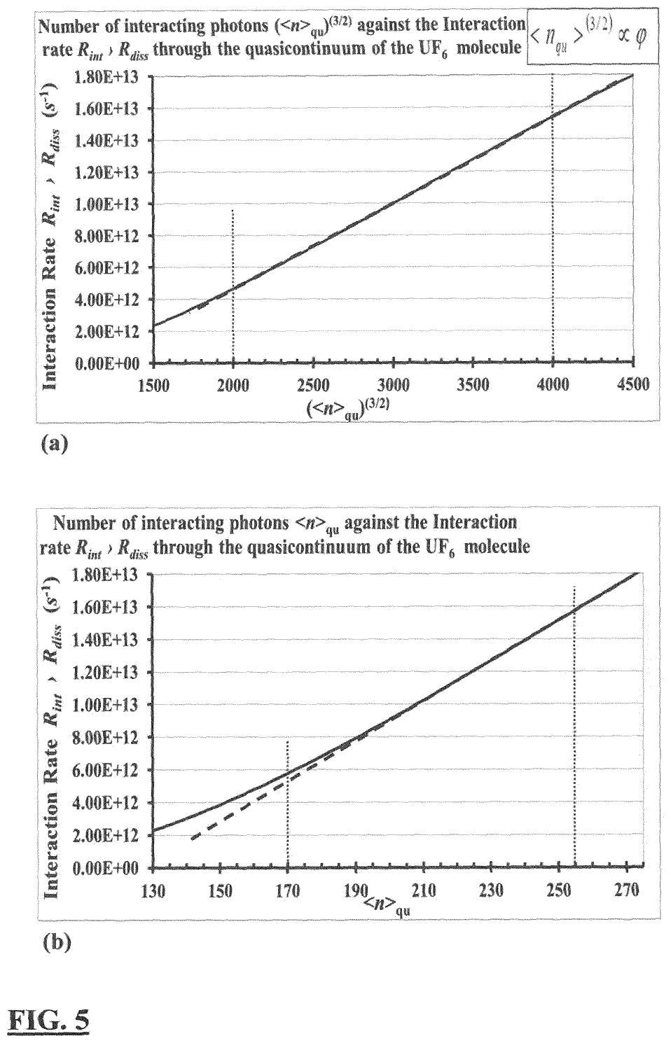

FIG. 5: (a) The number of photons

$${( {〈 n 〉}_{qu} )}^{\frac{3}{2}}$$

interacting with the quasicontinuum of states is proportional to the interaction rate Rᵢₙₜ when the number of absorbed photons is 170< [symbol] n [symbol] _{qu}=255. In this case [symbol] n [symbol] , ∝

$${( {φ}_{IR} )}^{\frac{2}{3}} [ i . e . σ ∝ {( {φ}_{IR} )}^{- \frac{1}{3}} ]$$

as observed theoretically and experimentally; (b) The number of photons [symbol] n [symbol] interacting with the quasicontinuum of states is found not to be proportional to the interaction rate Rᵢₙₜ within the same range of absorbed photons. The dotted vertical lines on both graphs correspond to an applied number of photons of approximately 170 and 255 interacting with the quasicontinuum of energy states and corresponds to the interval in which

$${R}_{im} ∝ {( {〈 n 〉}_{qu} )}^{\frac{3}{2}} .$$

FIG. 6 shows the variation of the population of the UF₆ gas in the ground state as a function of temperature. It is clear that at a temperature of around 60° K more than 85% of the molecules are in the ground state. Notice the dramatic drop of the ground state population of the UF₆ gas down to 30% at a temperature of 110%.

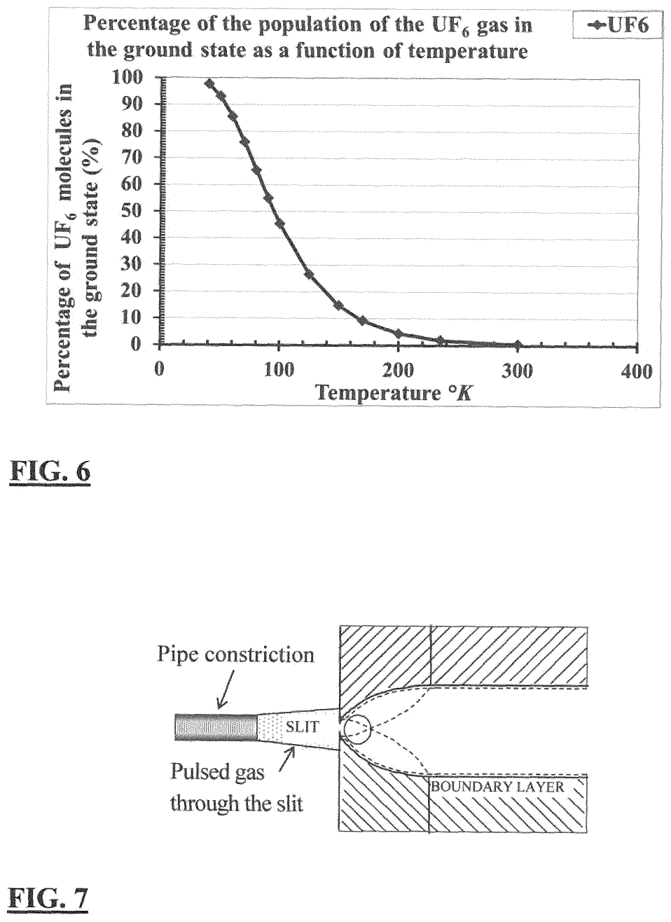

FIG. 7 depicts a gas dynamic expansion through a two dimensional nozzle, having a slit throat.

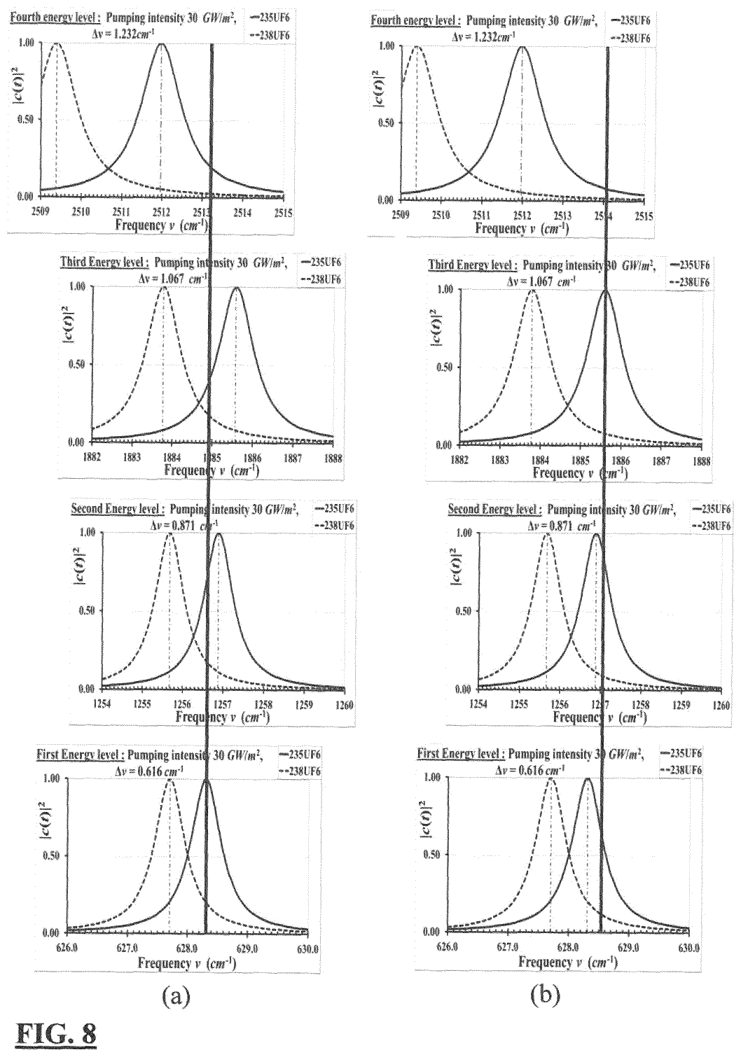

FIG. 8: (a) Resonances of the first four energy levels for the two UF₆ isotopes when pumping at the frequency of the fundamental at 628.306 cm⁻¹ at a pumping intensity of 30×10⁹ W/m²; broken line curves correspond to the ²³⁸UF₆ isotope and the solid line curves correspond to the ²³⁵UF₆ isotope. (b) Resonances of the first four energy levels for the two UF₆ isotopes when pumping at the three-photon resonance frequency with the [m(Δ₂):(3ν₃)] sublevel of the third energy excitation state of the desired ²³⁵UF₆ isotope at 628.527 cm⁻¹ at a pumping intensity of 30×10⁹ W/m²; broken line curves correspond to the ²³⁸UF₆ isotope and the solid line curves correspond to the ²³⁵UF₆ isotope. Comparison of FIG. 8(a) with FIG. 8(b) demonstrates the enormous difference in selectively elevating the molecules of the desired isotope ²³⁵UF₆ to the third energy excitation level when pumping at the three-photon resonance frequency of 628.527 cm⁻¹ as compared with pumping at the frequency of the fundamental at 628.306 cm⁻¹.

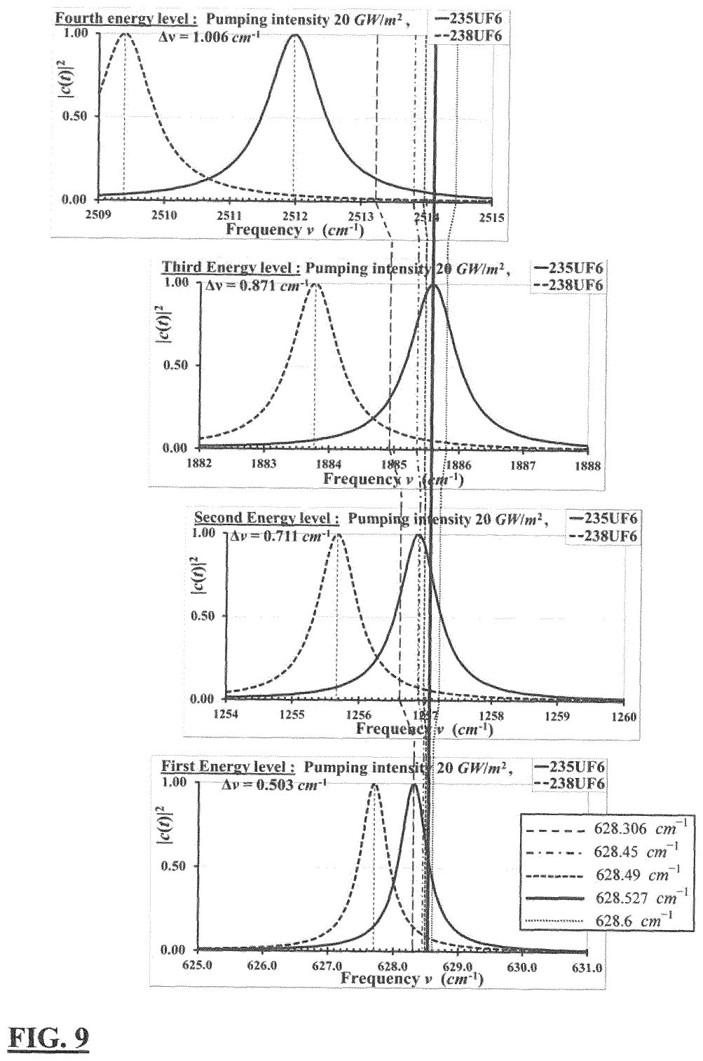

FIG. 9 depicts the selectivity of the desired isotope ²³⁵UF₆ to the third energy excitation state through the power broadening of the lower vibrational levels and pumping frequencies near the three-photon resonance with the [m(A₂):(3ν₃)] sublevel of the state, at 628.527 cm. The pumping intensity is set at 20 GW/m². The solid line curves correspond to the desired ²³⁵UF₆ isotope whilst the broken line curves correspond to the unwanted ²³⁸UF₆ isotope. The black solid line corresponds to the exact three-photon resonance with the [m(A₂):(3ν₃)] sublevel at 628.527 cm⁻¹. The other frequencies correspond to the lines indicated on the figure.

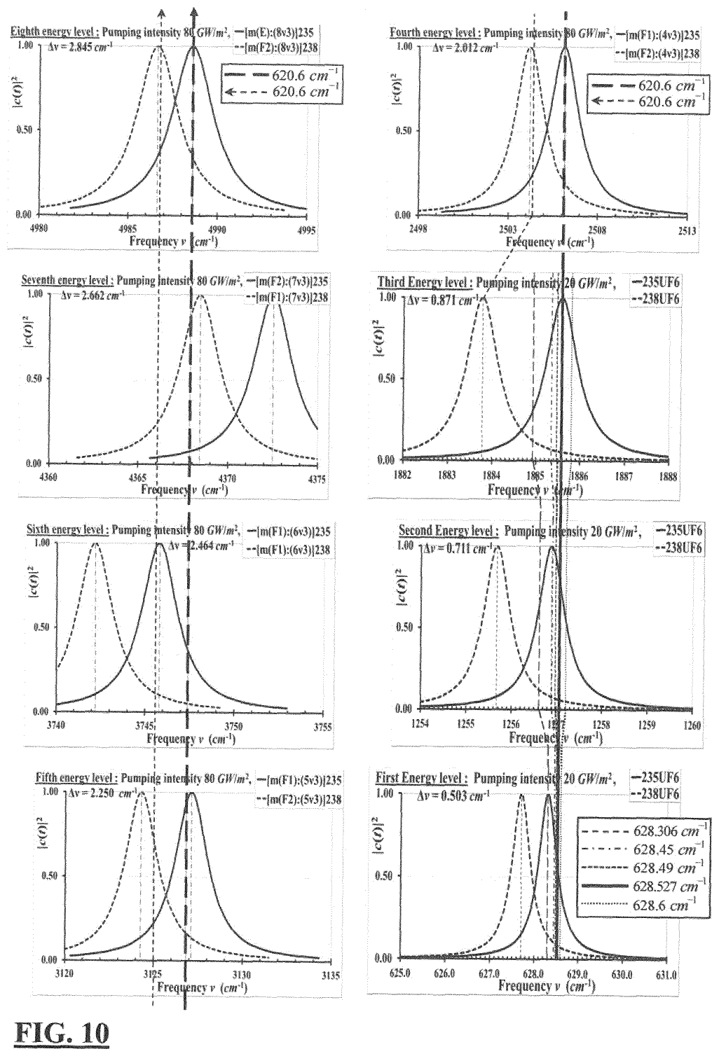

FIG. 10 depicts the entire selectivity and dissociation process for a selective beam frequency of 628.527 cm⁻¹ (continuous black line in the first three energy excitation states) at a pumping intensity of 20 GW/m² and a dissociating beam at a frequency of 620.6 cm⁻¹ (thick broken line from the third to the eighth energy excitation state) and pumping intensity of 80 GW/m². The solid line curves correspond to the desired ²³⁵UF₆ isotope whilst the broken line curves correspond to the unwanted ²³⁸UF₆ isotope. We see that the dissociating frequency is in direct resonance with three of the five levels keeping the excitation energy within the ν₃-vibrational mode up to the eighth energy excitation state of the desired isotope ²³⁵UF₆ without affecting or resonating with any of the levels of the unwanted isotope ²³⁸UF₆, which in any case are not populated at all at the low temperatures of the UF₆ gas. Note the importance of not elevating molecules of the unwanted ²³⁸UF₆ isotope to the third energy excitation level. The actual pumping intensities can be smaller or higher than those depicted in the figure.

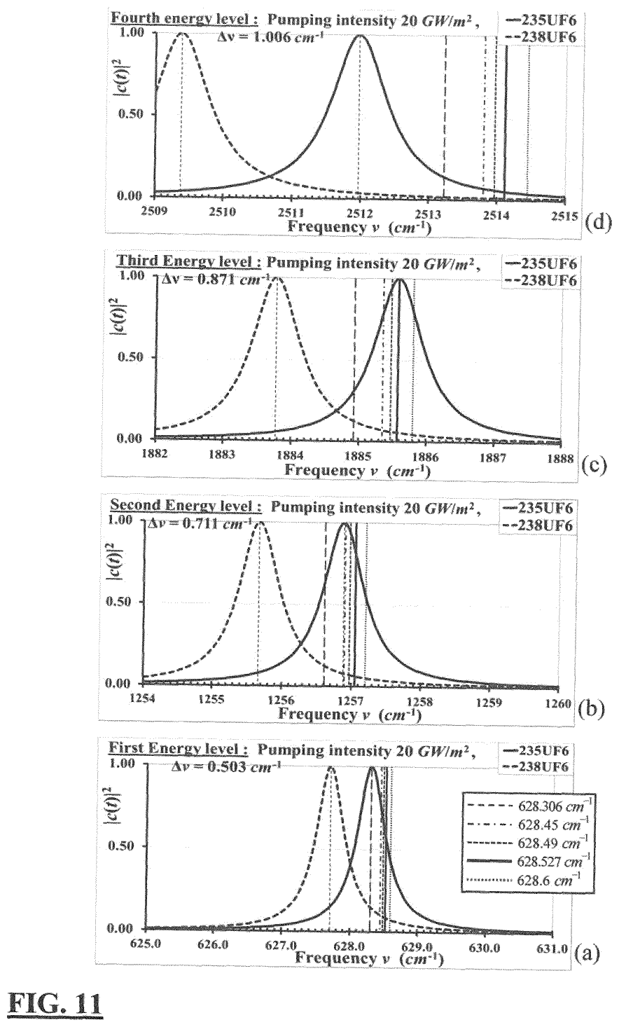

FIG. 11 shows a typical graph (one of hundreds drawn) for obtaining the selectivity between the two isotopes at the various pumping frequencies and intensities. All four graphs are drawn for a pumping intensity of 20 GW/m². The abscissa |c(t)|² provides information for the absorption probability of the corresponding frequency on the ordinate. From the analysis of such graphs we have calculated the relative selectivities to the third energy state for the two isotopes ²³⁵UF₆ and ²³⁸UF₆. The fourth energy level is included as an indication for qualitative comparisons. Note that the calculation of the selectivity and the graphic representations are relative and approximate but they give a good practical indication of the trends and the limits for the intensities, pulse durations and frequencies which must be applied to the molecular gas for obtaining outstanding selectivity.

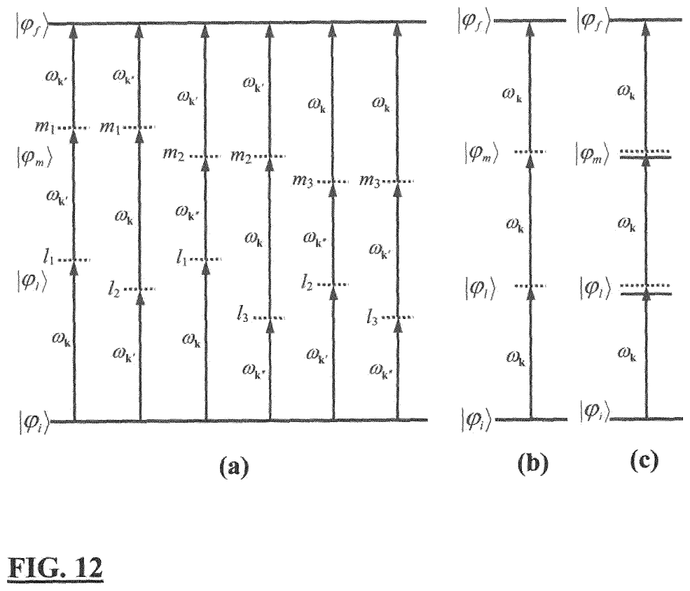

FIG. 12 depicts the three-photon absorption resonance process. (a) All pathways contribute to the third order term in the interaction Hamiltonian during the three-photon absorption process; (b) The situation when the three photons are the same i.e. ωₖ=ω′_{k′}=ω″_{k″}. The intermediate states |φᵢ [symbol] and |φₘ [symbol] although imaginary they nevertheless constitute solutions to the atomic Schrödinger equation; (c) The situation when the intermediate states |φᵢ [symbol] and |φₘ [symbol] are real atomic or molecular states as in the case of a vibrational ladder where their position may differ slightly from exact resonance. This is the case of three-photon resonance with the third energy excitation level [m(A₂):(3ν₃)] of the ²³⁵UF₆ isotope when the vibrational ladder interacts with a one frequency pumping beam i.e. with reference to Figs. (a), (b) we set ωₖ=ω_{k′}=ω_{k″}, n_{kζ}=n_{k′ζ′}=n_{k″ζ″}, m₁=m₂=m₃=m, l₁=l₂=l₃=l.

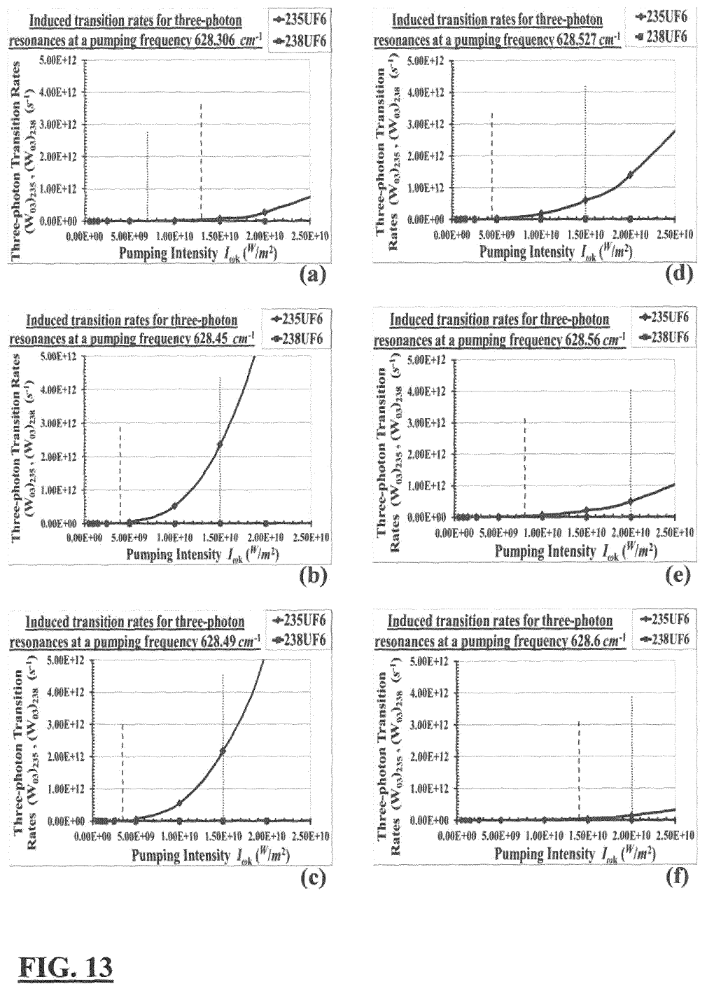

FIG. 13: The three-photon transition rate plotted against intensity for six different pumping frequencies. The broken vertical lines indicate the intensity level at which the three-photon transition rate to the third energy excitation level, exceeds the equivalent two-level transition rate with the same transition parameters. The dotted vertical lines on the graphs indicate the intensity level at which the selectivity of the desired isotope ²³⁵UF₆ to the third energy excitation level remains very high. It is evident that at the pumping frequency of the fundamental (628.306 cm⁻¹, graph (a)) it is extremely difficult to achieve any considerable selectivity of the desired isotope to the third energy excitation level. The optimum frequency range for achieving high selectivity of the desired isotope ²³⁵UF₆ is between 628.45 cm⁻¹ and 628.527 cm⁻¹ both from the point of view of the effective transition rate to the third energy level and the intensity range over which high selectivity to the third energy excitation level can be achieved 5×10⁹ W/m² to 30×10⁹ W/m² (graphs (b), (c) and (d)). It is clear that whilst the induced transition rate for the desired isotope ²³⁵UF₆ takes off to enormous values as the intensity is increased the corresponding transition rate for the unwanted isotope remains extremely low.

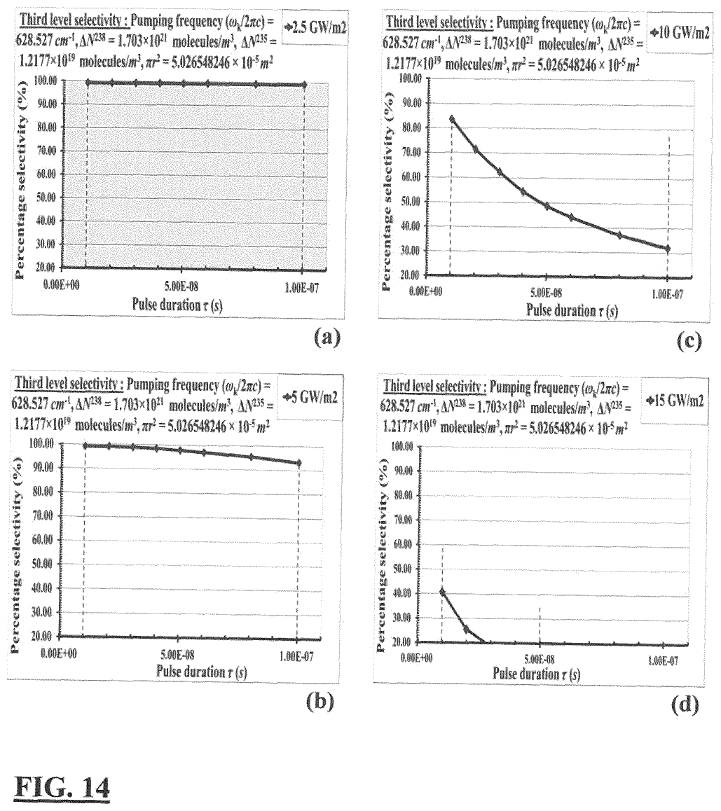

FIG. 14: shows the selectivity to the third energy excitation level for the beam and gas parameters shown on the graphs, for various pumping intensities. The broken vertical lines indicate the intervals over which eq. (71) and conditions (68)-(70) are strictly valid. The first graph (a) (dotted background) corresponds to pumping intensity levels (<4.5×10⁹ W/m²) at which difficulties may arise in establishing three-photon resonance with the third energy excitation level. The last three graphs (c), (d) and (e) correspond to pumping intensity levels (>4.5×10⁹ W/m²) at which the three-photon absorption resonance, with the same pumping parameters, can easily be established. It can be seen that the selectivity drops with increasing pulse duration and also with increasing intensity levels. For the selective excitation of the molecules of the desired isotope ²³⁵UF₆ to the third energy excitation level [m(A₂):(3ν₃)] the optimum pumping intensities should be in the region 5-15 GW/m² with pulse durations of less than 30×10⁻⁹ s. With these pumping parameters all the molecules of the desired isotope ²³⁵UF₆ are selectively elevated to the third energy excitation level. Note that these results have been obtained under the strict application of eq. (71) and the conditions (68)-(70), which are the strictest minimum conditions set in the calculations for achieving very high selectivity to the third energy level. The actual experimental conditions can be much more flexible and in practice much higher pumping intensities, exceeding 30×10⁹ W/m² can be applied whilst preserving very high selectivity since three-photon absorption with the unwanted isotope ²³⁸UF₆ is very difficult to establish at the pumping frequency of 628.527 cm⁻¹.

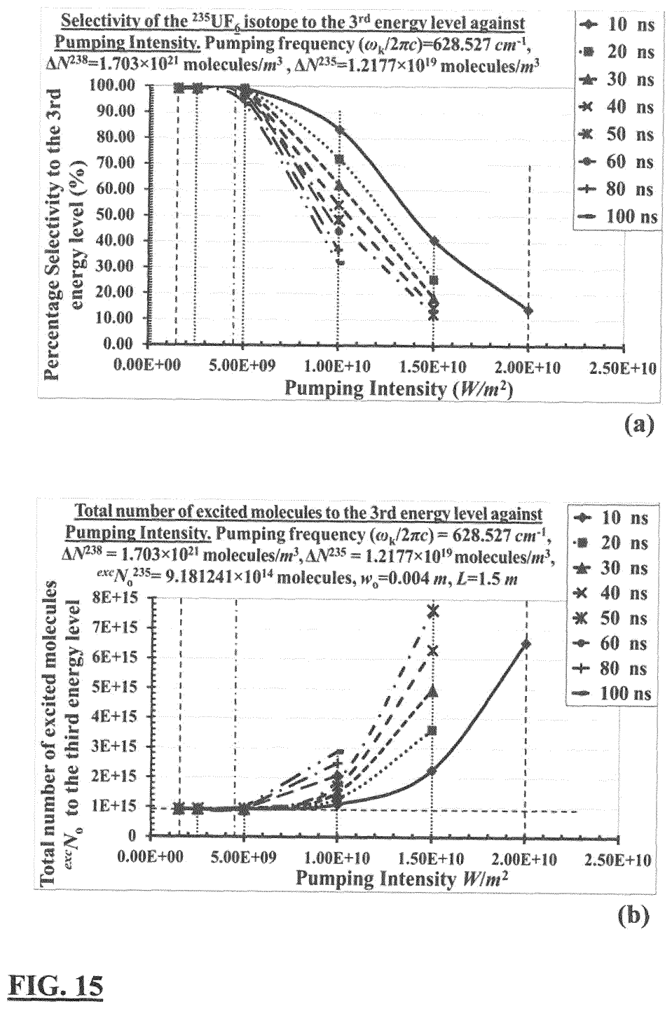

FIG. 15: (a) The percentage selectivity to the third energy excitation level as a function of the pumping intensity for various pumping pulse durations. The vertical broken lines denote the maximum interval over which eq. (71) and conditions (68)-(70) remain strictly valid. The other vertical lines are explained in the text. It can be seen that the shorter the pulse duration the higher the selectivity of the desired isotope. The optimum pumping intensity levels can be seen to be in the interval (4-15)×10⁹ W/m² with pumping pulse durations between (10-30)×10⁻⁹ s; (b) The total number of excited molecules to the third energy excitation level as a function of pumping intensity for various pulse durations, corresponding to the graphs of figure (a). The beam and gas parameters are shown on the graph and they are the same as those in figure (a). All the vertical lines on the graphs denote the same parameter limits as in figure (a). Since all the molecules of the desired isotope ²³⁸UF₆ are excited to the third energy level the increase in the number of excited molecules is due to the excitation of the molecules of the unwanted isotope. Subsequently shorter pulse durations with high intensity are preferable for the preservation of high selectivity to the third energy level. Note that these are the worst scenario cases since, in practice, three photon absorption with the unwanted isotope ²³⁸UF₆ is very difficult to achieve at the pumping frequency of 628.527 cm⁻¹. Much higher intensities can be applied whilst preserving high selectivity. All calculations have been performed under the strictest limiting conditions for the application of the theoretical calculations.

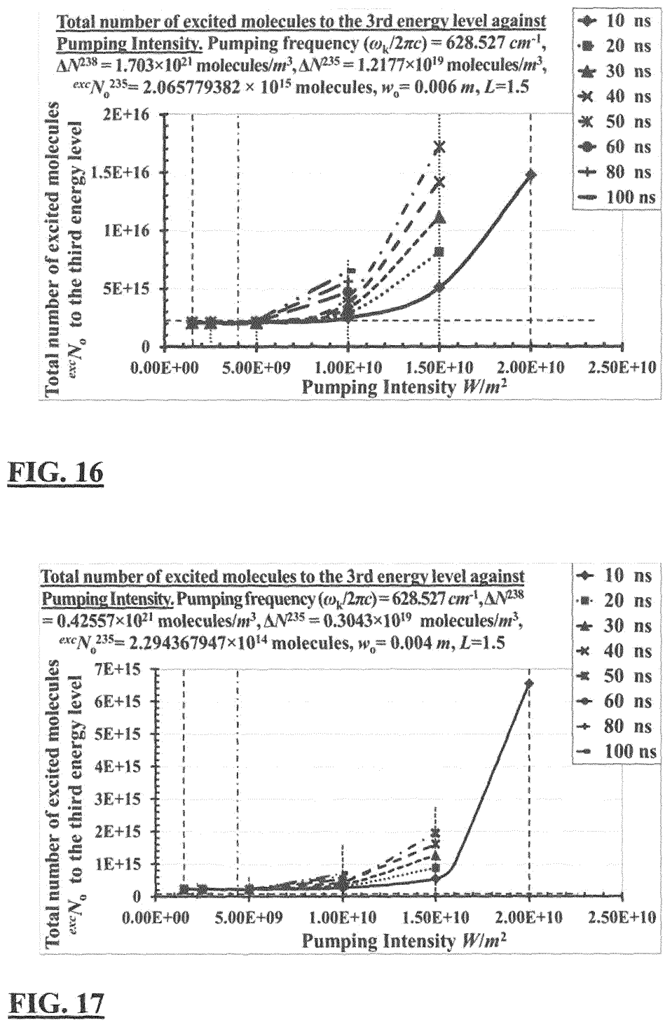

FIG. 16 shows the curves for the total number of excited molecules to the third energy level when the diameter of the pumping beam is increased to 0,012 m. The selectivity curves are the same as those of the smaller diameter beams (0.008 m in FIG. 15(a)) but the number of excited molecules is now more than doubled. The comparison with FIG. 15(b) indicates how the design of the expansion nozzle in effectively accommodating larger diameter beams is of paramount importance to the efficiency of the system.

FIG. 17 shows the curves for the total number of excited molecules to the third energy excitation level as a function of pumping intensity for various pulse durations as in FIG. 15(a) but for smaller gas density parameters ΔN²³³=0.42557×10²¹ molecules/m³, ΔN²³³=0.3043×10¹⁹ molecules/m³. All the interaction parameters as well as the percentage selectivity to the third energy level in the graphs of FIG. 15(a) remain the same. The only results that change are those for the total number of excited molecules to the third energy level and these are to be compared with those of FIGS. 15(b) and 16. Again all the available molecules of the desired isotope ²³⁵UF₆ are elevated to the third energy excitation level. Note that the percentage selectivity does not change with gas density provided the ratio of the number of molecules of the two isotopes in the gas is the same.

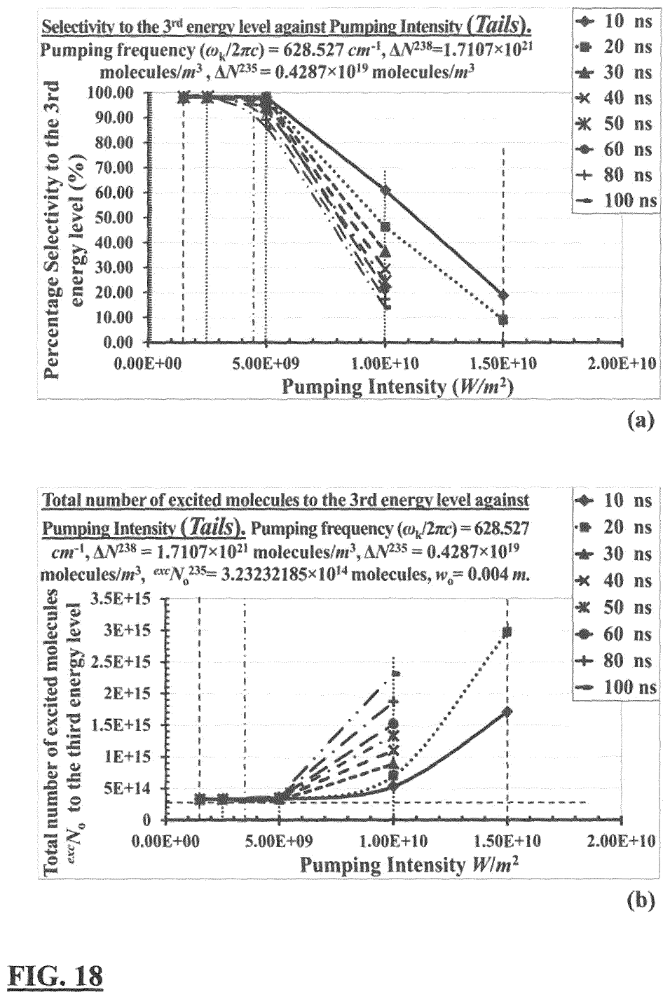

FIG. 18: (a) The selectivity graphs as a function of pumping intensity for various pumping pulse durations for a Tails assay of the desired isotope (²³⁸UF₆ (=99.75% ²³⁵UF₆=0.25%) at a temperature of 60° K; (b) The corresponding graphs for the total number of molecules elevated to the third energy level. The fact that all the available molecules of the desired isotope are elevated to the third energy excitation level makes the shapes of the resulting curves similar to those in FIGS. 15(a) and 15(b). The capability of treating the Tails is one of the most important aspects of the present invention.

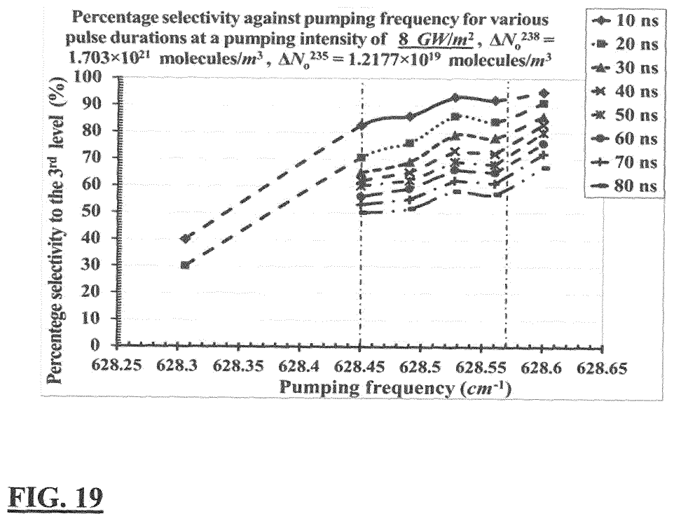

FIG. 19 shows the variation of the selectivity as a function of pumping frequency and pumping pulse duration, for a pumping intensity of 8×10⁹ W/m². We see that for this pumping intensity the frequency region for which eq. (71) is satisfied and conditions (68)-(70) remain strictly valid is between 628.45 cm⁻¹ and 628.56 cm⁻¹. Similar results are obtained for lower expansion supercooled gas assays. The results for Tails assays of the irradiated gas show similar characteristics but with slightly lower percentage selectivities to the third energy excitation level. This corresponds again to strictly limiting cases. Much higher pumping intensities can be employed without significant loss of selectivity.

It is to be emphasized that the results in FIGS. (14) to (19) have been obtained under the strict application of eq. (71) and the conditions (68) to (70). They give, however, a very good indication as to the trends, the intensity levels and the pulse durations for which the present invention can be applied. The actual experimental conditions are much more flexible and higher pumping intensities can be applied to the molecular gas. Note that, in practice, the elevation of the molecules of the unwanted isotope ²³⁸UF₆ is smaller than the one depicted in the graphs since for this isotope it is difficult to establish three photon absorption at the pumping frequency of 628.527 cm⁻¹ rendering the separation process much more favourable.

As with all the Hexafluorides the molecular population is by far greater in the Q-branch of the spectrum, so excitation in the ν₃-vibrational mode of the Q-branch is the desired mode of excitation. Expansion supercooling of the UF₆ enables the absorption bands in this region of the spectrum to be distinct and clear. The difference in the Q-branch absorption bands of ²³⁵UF₆ from ²³⁸UF₆ has been well established to be 0.604 cm⁻¹ and the ratio of the Q-branch peak heights for a sample containing the natural mixture of Uranium isotopes (0.71% in ²³⁵UF₆) is about 140 to 1. Because the integrated absorption coefficient is proportional to the number of molecules per unit volume, any isotope separation scheme will rely heavily on distinguishing between the Q-branches of the two isotopes.

The selective excitation of the ²³⁵UF₆ molecules has always been carried out through the application of a pumping beam whose frequency matches the ground to first level absorption line 628.306 cm⁻¹. Other beams were simultaneously applied to the supercooled molecular UF₆ gas to enhance the dissociation of the molecules.

The process of the selective dissociation of polyatomic molecules is the absorption under collisionless conditions of many infrared photons of the same frequency by a single molecule, by exciting successively higher vibrational states of the molecule until its dissociation is reached. For Uranium Hexafluoride (UF₆) the molecule must be driven through the energy levels to the dissociation energy of ˜2.95 eV (˜23800 cm⁻¹). An important factor in the enhancement of the multiphoton absorption is resonance at the fundamental, either on its own or for the enhancement of higher order absorption processes. Without it, absorption would be limited from the point of view of absorption cross section and the molecule having to be lifted through the vibrational ladder obeying the quantum mechanical selection rules.

The practical aspects affecting the selectivity and dissociation process in polyatomic molecules depend mainly on: (a) The case with which the molecules of the desired isotope ²³⁵UF₆ are selectively driven through the lower vibrational levels. (b) the level up to which the excitation energy remains within the same vibrational mode before being able of escaping to other vibrational modes in the quasicontinuum of states.

As the intensity of the pumping beam increases power broadening of the first few energy excitation levels occurs. In the past the magnitude of the power broadening of the fundamental transition has been grossly overestimated and the proposed schemes wrongly considered that selectivity was affected right from the interaction at the fundamental even at low pumping energies (D. Andreou, UK Patent GB 2256079B dated May 10, 1994 and U.S. Pat. No. 5,591,947 dated Jul. 1, 1997). Furthermore, the induced differential polarizability in the vibrational ladder, as well as other features in the interaction process were overestimated, rendering the selectivity process practically inapplicable.

To a first approximation the correct expression for the power broadening of a spectral line is

$$Δ v = {[ Δ {v}_{o}^{2} + \frac{{μ}^{2} {E}_{o}^{2}}{{π}^{2} {ℏ}^{2}} ]}^{\frac{1}{2}} \qquad ( 1 )$$

where μ is the dipole moment of the transition, Eₒ is the electric field of the applied laser beam and Δνₒ is the natural linewidth of the transition. On substituting the values of the parameters for the ground to first energy excitation level of UF₆ μ≈1.285×10⁻³⁰ C·m, Δνₒ≈0.197 cm⁻¹=5.906×10⁹ s⁻¹, we obtain that even for electric fields as low as 2×10⁶ V/m the second term dominates the value in the brackets

$$( \frac{μ E}{π ℏ} = 0.259 {cm}^{- 1} )$$

compared with Δνₒ=0.197 cm⁻¹. The power broadening of the transition thus becomes the dominant factor in the absorption process.

For a beam with intensity 40×10⁹ W/m² (100 m/within a beam radius r=4×10⁻³ m and a pulse duration r=50×10⁻⁹ s) the electric field is 5.5×10⁶ V/m and we obtain (Δν/2)=0.356 cm⁻¹ as the power broadened Full Width at Half-Maximum of the main ²³⁸UF₆ band. The frequency difference between the ground states of the two isotopes is 0.604 cm⁻¹ and even at these very high intensity levels the ²³⁸UF₆ molecules seem to be safe from absorption. The power broadening of the lower vibrational levels can, however, be properly exploited for the selective elevation of the molecules of the desired ²³⁵UF₆ isotope up the vibrational ladder.

To selectively excite large numbers of molecules of the desired isotope ²³⁵UF₆ and lead them efficiently to dissociation we must exploit the properties of the distinct levels and sublevels of the vibrational ladder and its interaction with the electromagnetic beams at specific frequencies and intensities.

The principles of the process are very delicately hidden under some of the fundamental concepts of the interaction of electromagnetic radiation with a vibrational ladder whose lower levels are a very close match to those of a harmonic oscillator. This is why the molecular gas should be expansion supercooled to very low temperatures below 100° K, and preferably to around 60° K, at which nearly all the molecules are in the ground state and the principles of the invention can be practically applied without any interference from other inherent processes. Then the invention of the method and its practical applicability is very simple: The frequency of the selecting laser must be at 628.527 cm⁻¹, or very close to it, for a three-photon absorption resonance with the [m(A₂):(3ν₃)] sublevel of the third energy excitation state of the desired ²³⁵UF₆ isotope. Having defined the first basic step which is the fixing of the frequency of the selecting laser, the second basic step is to increase the pumping intensity of the selecting laser to a level at which the three-photon absorption resonance with the [m(A₂):(3ν₃)] sublevel of the desired ²³⁵UF₆ isotope is established, elevating all the molecules of the desired isotope ²³⁵UF₆ to the third energy excitation state. This is achieved through the power broadening at the fundamental and the second energy excitation level as the pumping intensity of the selecting laser is increased. Here lies one of the most delicate points of the invention: if the pumping intensity of the selecting laser is low, three-photon resonance with the third energy level will be difficult to establish due to the lack of any resonance at the fundamental and the second energy excitation levels. On the other hand, if the pumping intensity of the selecting laser is very high, and because the quasicontinuum of energy states for the UF₆ molecule can start at the third energy level for very high intensities, the selectively excited molecules could escape to other vibrational modes and also resonances can set in with the higher energy states of the molecules of the unwanted isotope. There is, however, an intensity range for which all the molecules of the desired ²³⁸UF₆ isotope can be selectively elevated to the third energy level through the establishment of a three-photon absorption resonance, without in any way disturbing the molecules of the unwanted isotope ²³⁸UF₆, leaving them unexcited.

To understand the basic process and the principles of the invention we first summarise some of the important properties of the Hexafluorides which have not been analysed before. The molecular Dissociation energy is equivalent to the binding energy of the ν₃-vibrational mode of the molecule which is the energy required for breaking the first XFs-F bond. We have tabulated the Dissociation energies for the ν₃-vibrational modes of the hexafluorides gathered from various references in the literature. For the UF₆ they are perfectly compatible with those given by Jensen et al, Los Alamos Science Vol. 3, pp. 2-33, (1982) and Gilbert et al, SPIE Vol. 669, pp 10-17 Laser Applications in Chemistry (1986). For the UF₆ molecule the dissociation energy [symbol] _{diss}=2.951 eV=23800 cm⁻¹ corresponding to an equivalent number of Dissociation photons η=38 required for dissociating each particular molecule. The values of the other hexafluorides were calculated from the symmetry of their ground electronic states (Δ_{1g}), their common chemical characteristics and their spectra. The estimated values are all compatible amongst themselves.

Transitions up the vibrational ladder of an infrared active mode are generally governed by the angular momentum quantum mechanical selection rule Δl=+1. For higher vibrational levels with Δn>2 it is possible in practice to have transitions where this selection rule is violated. For Δn>5 selection rules become very loose. As a result of this selection rule there is a complete absence of all the first overtones (2ν₃) in the infrared spectra of the molecules belonging to the Oₕ group since they are forbidden.

The most important factor in the multiphoton absorption process and the selective dissociation of polyatomic molecules is the structure of the nν₃ vibrational ladder. Knowledge of the structure of this ladder provides the information needed to picture the possible pathways through which the photon energy can be selectively absorbed by the desired isotope. Taking the ground state of vibration as the zero reference point of the νᵢ-mode of vibration, the actual harmonic frequencies of the i^{th}-mode of vibration can be obtained. The anharmonicity constants Xᵢᵢ (cm⁻¹) are related to the manifold origin of the levels of the νᵢ vibrational mode. We analysed the structure of the ν₃-mode vibrational ladder in this convention from the theoretical results described by Krohn et al, Journal of Molecular Spectroscopy, Vol. 132, pp. 285-309, eq. (7), (1988) and Herzberg G., ‘Molecular Spectra and Molecular Structure, Vol. II, Krieger Publishing Co, p. 211, (1991), with the various constants governing the ν₃-vibrational ladder defined by: Frequencies (cm⁻¹): ω₃^{o} is the effective harmonic frequency; (ν₃) is the manifold origin of the fundamental, (υν₃) being the manifold origin of the higher vibrational levels; ν₃ is the pure vibrational energy of the fundamental excited level. It is this quantity which is used in the determination of the exact position of the levels of the symmetry structure of the higher vibrational states υν₃ (eigenstates of the vibrational manifolds); m(F₁) is the centre of the absorption band of the fundamental (observed frequency) when taking into account the Coriolis shift. Constants (cm⁻¹): B₃ is the rotational constant of 3ν₃; B₀ is the rotational constant of the ground state (υ=0); Bζ₃ is the Coriolis shift for ν₃ to the band origin; X₃₃ is the anharmonicity constant related to the manifold origins of the levels of the ν₃ vibrational mode; G₃₃ is the anharmonicity coefficient related to the vibrational angular momentum [symbol] ²; T₃₃ is the anharmonicity constant related to the state of vibration. On imposing constraint conditions on the particular state of vibration, the relations 2T₃₃+G₃₃≈0 and X₃₃≈6T₃₃ generally hold for the ν₃-vibrational mode of the heavy Hexafluorides. As the molecules become lighter then G₃₃≥−2T₃₃ (T₃₃ negative).

For the first energy excitation level of the UF₆ vibrational modes with υ=1 the degeneracies g_{ν}_{ᵢ} of the various modes of vibration νᵢ (i=1, 2, 3, 4, 5, 6).

$${g}_{{v}_{1}} = 1 , {g}_{{v}_{2}} = 2 , {g}_{{v}_{3}} = {g}_{{v}_{4}} = {g}_{{v}_{5}} = {g}_{{v}_{6}} = 3 \qquad ( 2 )$$

For the first few vibrational levels we arrived at the following relations

$${G}_{33} = - \frac{1}{2} [ ( {v}_{3} ) - {v}_{3} ] , {X}_{33} - {G}_{33} = \frac{1}{6} [ ( 3 {v}_{3} ) - 3 {v}_{3} ] \qquad ( 3 )$$

The frequencies and constants of the ν₃-vibrational ladder of the hexafluorides bear the following relations amongst themselves: (i) The anharmonicity constant for the manifold origins X₃₃ in cm⁻¹ is always negative; (ii) The anharmonicity constant related to the state of vibration T₃₃ in cm⁻¹ is always negative; (iii) The anharmonicity coefficient related to the vibrational angular momentum G₃₃ in cm⁻¹ is always positive.

The effective harmonic frequency ω₃^{o} is always greater than either (ν₃) (the manifold origin of the fundamental in cm⁻¹) or ν₃ (the frequency of the pure vibrational energy of the fundamental in cm⁻¹). Also since G₃₃ is always positive ν₃ is always greater than (ν₃). Thus

$${ω}_{3}^{o} > {v}_{3} , {ω}_{3}^{o} > ( {v}_{3} ) , {v}_{3} > ( {v}_{3} ) , {G}_{33} \geq - \frac{1}{3} {X}_{33} \qquad ( 4 )$$

where the last relation results from the constraint relations above and holds for the heavy hexafluorides if non-bonding interactions are ignored. Detailed analysis of the above structure of the ν₃-vibrational ladder of the hexafluorides results in a set of limiting values of the anharmonicity constant X₃₃ (cm⁻¹) and the effective harmonic frequency ω₃^{o} (cm⁻¹).

$${X}_{33} = \frac{1}{9} [ ( 3 {v}_{3} ) - 3 {ω}_{3}^{o} ] \geq \frac{1}{8} [ ( 3 {v}_{3} ) - 3 {v}_{3} ] \qquad ( 5 )$$

$${ω}_{3}^{o} \leq \frac{1}{3} ( 3 {v}_{3} ) - \frac{3}{8} [ ( 3 {v}_{3} ) - 3 {v}_{3} ] \qquad ( 6 )$$

Note that both conditions (5) and (6) are expressed in terms of the frequency parameters of the ν₃-vibrational ladder defined above. Inequality (5) defines the minimum value the unharmonicity constant of the manifold origins X₃₃ can have, and it is always negative. Inequality (6) defines the maximum value of the effective harmonic frequency ω₃^{o} in cm⁻¹. For heavy hexafluorides, such as UF₆, PuF₆, and WF₆, these limiting values are extremely close to the actually observed values. As we move to the lighter hexafluorides, such as SF₆, the discrepancy of the actual measured experimental values differ from the limiting values defined by inequalities (5) and (6), but not substantially.

It is thus possible to obtain very good values for the vibrational constants of the hexafluorides from simple spectroscopic measurements and recordings. In Table 1 a comparison of the limiting values of X₃₃ and ω₃^{o} dictated by the frequency conditions (5) and (6) with their measured values is made. We notice that for the heavy hexafluorides the calculated values using various methods are extremely close to the measured values. The order of the hexafluorides

TABLE 1
Comparison of the limiting values of X₃₃ and ω₃^{o} dictated by the frequency conditions with their measured values

| Hexa- fluoride | At. No | v₃ (cm⁻¹) | (3v₃) (cm⁻¹) | Number of Dissociation photons η | ${X}_{33} \geq \frac{1}{3} [ ( 3 {v}_{3} ) - 3 {v}_{3} ]$ (cm⁻¹) | X₃₃ (cm⁻¹) | $\text{?} \leq \frac{1}{3} ( 3 {v}_{3} ) - \frac{3}{8}$ [(3v₃) − 3v₃] (cm⁻¹) | ω₃^{o} (calculated) | ω₃^{o} (measured) |
|---|---|---|---|---|---|---|---|---|---|
| ²³⁹PuF₆ | 94 | 620 | 1854.5(3) | ~38 | −0.6875 | −0.683(10)* | 620.23 | 620.22(3) | |
| ²³⁸UF₆ | 92 | 627.724 | 1877.532(10) | 38 | −0.705 | −0.700(10) | 627.96 | | 627.944(4) |
| ²³⁵UF₆ | 92 | 628.328 | 1879.344(10) | 38 | −0.705 | −0.700(10) | 628.563 | | 628.548(4) |
| ¹⁹⁵PtF₆ | 78 | 705 | 2108.5(2) | ~40 | −0.8125 | −0.805(10)* | 705.271 | 705.25(4) | |
| ¹⁸⁶WF₆ | 74 | 713.286 | 2133.0(3) | ~41 | −0.857 | −0.790(10)* | 713.572 | 713.37(4) | |
| ⁹⁸MoF₆ | 42 | 743 | 2223.0(3) | 44 | −0.75 | −0.720(20)* | 743.25 | 743.15(5) | |
| ¹³⁰TeF₆ | 52 | 753.128 | 2252.0(3) | ~41 | −0.923 | −0.890(20)* | 753.436 | 753.337(10) | |
| ⁸⁰SeF₆ | 34 | 780.072 | 2332.0(5) | 40 | −1.027 | −0.952(10)* | 780.41 | 780.19(4) | |
| ³²SF₆ | 16 | 948.103 | 2828.341(1) | 34 | −1.99605 | −1.74256(15) | 948.7684 | | 948.008(4) |
| ³⁴SF₆ | 16 | 930.702 | 2776.138(1) | 34 | −1.99605 | −1.74256(15) | 931.378 | | 930.6072(4) |

$\text{?} \text{indicates text missing or illegible when filed}$

is from the heaviest to the lightest taking them according to their central atoms in groups of (a) The inner transition metals (b) The transition metals (c) The non-metals. Numbers given in parentheses are the estimated error limits in units of the last figure quoted. Values marked * are calculated values obtained through the application of the Morse potential, the frequency conditions, the available published spectroscopic data and the straight line graph of X₃₃ against (λ̅ₑ²/D_{diss}).

Extending the analysis of the basic equations further and employing eqs. (3)-(6) we can calculate all the anharmonic constants for the hexafluorides X₃₃, G₃₃ and T₃₃. For the heavy hexafluorides UF₆, PuF₆ and WF₆ these calculated values are extremely close to the experimentally measured values. It is not possible to give a complete theoretical derivation of the procedure, but for the sake of complicity the results are summarized in Table 2 for the UF₆ molecule. Many more calculations were carried out and the results were checked with the most reliable experimental values available. For the heavy hexafluorides they were in extremely good accordance. As we move towards the lighter hexafluorides the agreement between the calculated and experimental values diminishes. In Table 2 we summarise the best available vibrational constants of the ν₃-vibrational ladder of the two Uranium Hexafluoride isotopes ²³⁸UF₆ and ²³⁵UF₆ obtained through our calculations and the best available experimental measurements. Similar tables have been constructed for all the hexafluorides.

TABLE 2
The vibrational constants of the UF₆ molecule

| | |
|---|---|
| Observed Q-branch frequency | $\{ \begin{matrix}{}^{238} m ( {F}_{1} ) & = & 627.7019 & {cm}^{- 1} \\ {}^{235} m ( {F}_{1} ) & = & 628.306 & {cm}^{- 1}\end{matrix}$ |
| Effective harmonic frequency | $\{ \begin{matrix}{}^{238} {ω}_{3}^{o} & = & 627.944 & ( 3 ) & {cm}^{- 1} \\ {}^{235} {ω}_{3}^{o} & = & 628.548 & ( 3 ) & {cm}^{- 1}\end{matrix}$ |
| Frequency of pure vibrational energy of fundamental | $\{ \begin{matrix}{}^{238} {v}_{3} & = & 627.724 & ( 3 ) & {cm}^{- 1} \\ {}^{235} {v}_{3} & = & 628.328 & ( 3 ) & {cm}^{- 1}\end{matrix}$ |
| Frequency of the origin of the fundamental vibrational level | $\{ \begin{matrix}{}^{238} ( {v}_{3} ) & = & 627.244 & ( 5 ) & {cm}^{- 1} \\ {}^{235} ( {v}_{3} ) & = & 627.848 & ( 5 ) & {cm}^{- 1}\end{matrix}$ |
| Frequency of the origin of the third vibrational energy level | $\{ \begin{matrix}{}^{238} ( 3 {v}_{3} ) & = & 1877.53 & ( 8 ) & {cm}^{- 1} \\ {}^{235} ( 3 {v}_{3} ) & = & 1879.34 & ( 8 ) & {cm}^{- 1}\end{matrix}$ |
| Unharmonicity constant of the manifold origins | X₃₃ = −0.70 (1) cm⁻¹ |

Unharmonicity coefficient of the vibrational

| | |
|---|---|
| angular momentum | G₃₃ = 0.24 (1) cm⁻¹ |

Unharmonicity constant related

| | |
|---|---|
| to the state of vibration | T₃₃ = −0.140 (5) cm⁻¹ |
| Coriolis shift | Bζ₃ = 0.01105 (5) cm⁻¹ |
| Coriolis constant | ζ₃ = 0.1986 (7) |
| Rotational constant | B₃ 0.05563 (4) cm⁻¹ |
| | Bₒ 0.05567 (4) cm⁻¹ |

(The numbers given in parentheses are the estimated error limits in units of the last figure quoted. They have been estimated from the best measurements of the available references in the literature.)

The unharmonicity constants α, β, γ in the Cartesian representation are related to the unharmonicity constants in the Polar representation X₃₃, G₃₃ and T₃₃, by [Harzer et al, Journal of Molecular Spectroscopy, Vol. 132, pp. 310-322, eqs. (2a,b,c), (1988)]

$$\begin{matrix}α = {X}_{33} + 4 {T}_{33} , & β = 2 {X}_{33} - 8 {T}_{33} + 2 {G}_{33} , & γ = - 2 {T}_{33} - {G}_{33}\end{matrix} \qquad ( 7 )$$

The manifold band structures originating from the pure vibrational energies of the levels from υ=0 to υ=4 are listed in Tables 3 and 4 in this notation. [Akulin et al, Soviet Physics, JEPT 45, pp 47-52, (1977)] These tables define the precise positions of the energy states and their sublevels of the ν₃-vibrational ladder of the two UF₆ isotopes which will be very distinct and clear when the UF₆ gas is supercooled to very low temperatures. It is the differences in the frequencies of the lower energy states of the two UF₆ isotopes which we must exploit for the selective dissociation of the desired isotope ²³⁸UF₆. Data for the structure of the energy states of the UF₆ from υ=5 to υ=8 are also available in the literature. We have constructed similar tables for all the hexafluorides and compared and analysed their vibrational ladders.

We now proceed to demonstrate that for the heavy hexafluorides the properties of their lower states are a very close match to those of an ideal harmonic oscillator. The ν₃-vibrational mode of the heavy hexafluorides, such as UF₆ and PuF₆, vibrates in a similar way to the asymmetric stretching mode of a linear molecule of the XY₂ type (such as CO₂), with the amplitude of the motion of the central atom being very small compared to that of the two axial F-atoms, and the amplitudes of the four equatorial F-atoms being virtually negligible by comparison to those of the two axial F-atoms. This type of vibration has six anharmonic constants Xᵢⱼ which are very nearly equal, with the magnitude of each of the anharmonic constants being equal to ⅙ of that of the anharmonic constant of the equivalent diatomic molecule having the same vibrating frequency [Herzberg G., ‘Molecular Spectra and Molecular Structure’, Krieger Publishing Co, Vol. II, p. 206, (1991)]. The vibrational constant can be written as

$${X}_{33} ≅ - \frac{1}{6} {\overline{λ}}_{e} {x}_{e} \qquad ( 8 )$$

where λ̅ₑ (cm⁻¹) [λ̅ₑ≡ν₃] is the Morse frequency and xₑ is a dimensionless constant to be defined below. To check its practical validity we solve the Schrödinger equation for a diatomic molecule using the Morse potential following the procedure of [Pauling L. and Wilson E. B., “Introduction to Quantum Mechanics”, p. 274, McGraw Hill, (1935)]. With the energies of the vibrational levels in reciprocal centimeters (cm⁻¹) the following relations are obtained:

$${\overline{λ}}_{e} = \frac{{β}_{M}}{2 π c} \sqrt{\frac{2 D}{μ}} , {x}_{e} = \frac{ℏ {β}_{M}}{2} \sqrt{\frac{1}{2 μ D}} = \frac{h {\overline{λ}}_{e} c}{4 D} , {B}_{e} = \frac{h}{8 {π}^{2} {I}_{e} c} , {\overline{λ}}_{e} {x}_{e} = \frac{{β}_{M}^{2} h}{8 {π}^{2} c μ} \qquad ( 9 )$$

where the subscript e denotes equilibrium values, λ̅ₑ≡ν₃ (cm⁻¹) is the Morse frequency, D (ergs) is the dissociation energy, β_{M} (cm⁻¹) is the Morse constant, μ (gm) is the reduced mass, xₑ is dimensionless, Bₑ (cm⁻¹) is the rotational constant and Iₑ=μrₑ² is the equilibrium moment of inertia of the molecule. The product λ̅ₑxₑ (cm⁻¹) given by the last of the relations (9) is called the anharmonicity constant. From relations (8) and (9), the spectroscopic data and the Dissociation energy it is possible to determine the vibrational constants of the heavy Hexafluorides to a very high degree of accuracy. It is not possible to give the complete analysis in the short space of a patent application, but from the relations (9) we see that the unharmonicity constant of diatomic molecules, and subsequently of all molecules whose vibrational modes exhibit similar characteristics such as the heavy hexafluorides, is

$${\overline{λ}}_{e} {x}_{e} ∝ \frac{{\overline{λ}}_{e}^{2}}{D} \qquad ( 10 )$$

This proportionality is the result of introducing the Morse potential into the radial part of the Schrodinger equation and from relations (9) we see that it is independent of the Morse constant β_{M}. Thus, from the relations (8) and (10), for the ν₃-vibrational mode of polyatomic molecules, the vibrational constant should be proportional to

$${X}_{33} ∝ \frac{{\overline{λ}}_{e}^{2}}{D} \qquad ( 11 )$$

For the UF₆ molecule all the parameters for the ν₃-vibrational mode in (11) have been very accurately measured. For the lightest of the hexafluorides SF₆, again all the parameters for the

TABLE 3
The Manifold Symmetry Structure Of The Vibrational Ladder Of ²³⁸UF₆
(bracketed numbers in the (υv₃) column are the uncertainties in the manifold origins of the levels)

| | (υv₃) | Symmetry | | | | Coriolis |
|---|---|---|---|---|---|---|
| | (cm⁻¹) | structure | l | QN | Eigenvalue | shift |
| Ground | (0v₃) = | A₁ | 0 | 000 | 0 | 0 |
| Level | 0.00 | | | | | |
| 1^{st} Energy | (1v₃) = | F₁ | 1 | 100 | 1v₃ = 627.724 cm⁻¹ | −2Bζ₃ |
| Excitation | 627.244 | | | | m(F₁) = 627.7019 cm⁻¹ | |
| Level | (0.02) | | | | | |
| 2^{nd} Energy | (2v₃) = | E | 2 | 200 | 2v₃ + 2α − 2γ = 1252,848 cm⁻¹ | 0 |
| Excitation | 1253.088 | | | | m(E) = 1252.85 cm⁻¹ | |
| Level | (0.03) | | | | | 0 |
| | | A₁ | 0 | 200 | 2v₃ +2α + 4γ = 1253.088 cm⁻¹ | |
| | | | | | m(A₁) = 1253.09 cm⁻¹ | |
| | | F₂ | 2 | 110 | 2v₃ + β = 1255.648 cm⁻¹ | +2Bζ₃ |
| | | | | | m(F₂) = 1255.67 cm⁻¹ | |
| 3^{rd} Energy Excitation Level | (3v₃) = 1877.532 (0.12) | F₁ | 1 | 300 | $3 {v}_{3} + 4 α + β + γ - {[ {( β + γ - 2 α )}^{2} + 24 {γ}^{2} ]}^{\frac{1}{2}} = 1875.6 {cm}^{- 1}$ $m ( {F}_{1} ) = 1875.6 {cm}^{- 1}$ | 0 |
| | | F₂ | 3 | 210 | 3v₃ + 2α + 2β − 2γ = 1880.972 cm⁻¹ | 0 |
| | | | | | m(F₂) = 1880.97 cm⁻¹ | |
| | | F₁ | 3 | 210 | $3 {v}_{3} + 4 α + β + γ + {[ {( β + γ - 2 α )}^{2} + 24 {γ}^{2} ]}^{\frac{1}{2}} = 1881.14 {cm}^{- 1}$ $m ( {F}_{1} ) = 1881.14 {cm}^{- 1}$ | 0 |
| | | A₂ | 3 | 111 | 3v₃ + 3β = 1883.772 cm⁻¹ | 0 |
| | | | | | m(A₂) = 1883.77 cm⁻¹ | |
| 4^{th} Energy Excitation Level | (4v₃) = 2500.576 (0.27) | E | 2 | 400 | $4 {v}_{3} + 8 α + 2 β - γ - {[ {( 2 β - 4 α - γ )}^{2} + 24 {γ}^{2} ]}^{\frac{1}{2}} = 2495.772 {cm}^{- 1}$ $m ( E ) = 2495.77 {cm}^{- 1}$ | 0 |
| | | A₁ | 0 | 400 | $4 {v}_{3} + 8 α + 2 β + 2 γ - {2 [ {( β + γ - 2 α )}^{2} + 24 {γ}^{2} ]}^{\frac{1}{2}} = 2495.762 {cm}^{- 1}$ $m ( {A}_{1} ) = 2495.76 {cm}^{- 1}$ | 0 |
| | | F₁ | 4 | 310 | 4v₃ + 6α + 3β − 6γ = 2503.696 cm⁻¹ | 0 |
| | | | | | m(F₁) = 2503.70 cm⁻¹ | |
| | | F₂ | 2 | 310 | $4 {v}_{3} + 4 α + 4 β + 3 γ - {[ {( 2 α - β + 3 γ )}^{2} + 24 {γ}^{2} ]}^{\frac{1}{2}} = 2504.169 {cm}^{- 1}$ $m ( {F}_{2} ) = 2504.17 {cm}^{- 1}$ | 0 |
| | | E | 4 | 220 | $4 {v}_{3} + 8 α + 2 β - γ + {[ {( 2 β - 4 α - γ )}^{2} + 24 {γ}^{2} ]}^{\frac{1}{2}} = 2506.5796 {cm}^{- 1}$ $m ( E ) = 2506.58 {cm}^{- 1}$ | 0 |
| | | A₁ | 4 | 220 | $4 {v}_{3} + 8 α + 2 β + 2 γ + {2 [ {( β + γ - 2 α )}^{2} + 24 {γ}^{2} ]}^{\frac{1}{2}} = 2506.83 {cm}^{- 1}$ $m ( {A}_{1} ) = 2506.83 {cm}^{- 1}$ | 0 |
| | | F₂ | 4 | 211 | $4 {v}_{3} + 4 α + 4 β + 3 γ + {[ {( 2 α - β + 3 γ )}^{2} + 24 {γ}^{2} ]}^{\frac{1}{2}} = 2509.383 {cm}^{- 1}$ $m ( {F}_{2} ) = 2509.38 {cm}^{- 1}$ | 0 |

TABLE 4
The Manifold Symmetry Structure Of The Vibrational Ladder Of ²³⁵UF₆
(bracketed numbers in the (υv₃) column are the uncertainties in the manifold origins of the levels)

| | (υv₃) | Symmertry | | | | Coriolis |
|---|---|---|---|---|---|---|
| | (cm⁻¹) | structure | l | QN | Eigenvalue | shift |
| Ground | (0v₃) = | A₁ | 0 | 000 | 0 | 0 |
| Level | 0.00 | | | | | |
| 1^{st} Energy | (1v₃) = | F₁ | 1 | 100 | 1v₃ = 628.328 cm⁻¹ | −2Bζ₃ |
| Excitation | 627.848 | | | | m(F₁) = 628.306 cm⁻¹ | |
| Level | (0.02) | | | | | |
| 2^{nd} Energy | (2v₃) = | E | 2 | 200 | 2v₃ + 2α − 2γ = 1254.056 cm⁻¹ | 0 |
| Excitation | 1254.296 | | | | m(E) = 1254.06 cm⁻¹ | |
| Level | (0.03) | | | | | |
| | | A₁ | 0 | 200 | 2v₃ + 2α + 4γ = 1254.296 cm⁻¹ | 0 |
| | | | | | m(A₁) = 1254.30 cm⁻¹ | |
| | | F₂ | 2 | 110 | 2v₃ + β = 1256.856 cm⁻¹ | +2Bζ₃ |
| | | | | | m(F₂) = 1256.88 cm⁻¹ | |
| 3^{rd} Energy Excitation Level | (3v₃) = 1879.344 (0.12) | F₁ | 1 | 300 | $3 {v}_{3} + 4 α + β + γ - {[ {( β + γ - 2 α )}^{2} + 24 {γ}^{2} ]}^{\frac{1}{2}} = 1877.42 {cm}^{- 1}$ $m ( {F}_{1} ) = 1877.42 {cm}^{- 1}$ | 0 |
| | | F₂ | 3 | 210 | 3v₃ + 2α + 2β − 2γ = 1882.784 cm⁻¹ | 0 |
| | | | | | m(F₂) = 1882.78 cm⁻¹ | |
| | | F₁ | 3 | 210 | $3 {v}_{3} + 4 α + β + γ + {[ {( β + γ - 2 α )}^{2} + 24 {γ}^{2} ]}^{\frac{1}{2}} = 1882.95 {cm}^{- 1}$ $m ( {F}_{1} ) = 1882.95 {cm}^{- 1}$ | 0 |
| | | A₂ | 3 | 111 | 3v₃ + 3β = 1885.584 cm⁻¹ | 0 |
| | | | | | m(A₂) = 1885.58 cm⁻¹ | |
| 4^{th} Energy Excitation Level | (4v₃) = 2502.992 (0.27) | E | 2 | 400 | $4 {v}_{3} + 8 α + 2 β - γ - {[ {( 2 β - 4 α - γ )}^{2} + 24 {γ}^{2} ]}^{\frac{1}{2}} = 2498.188 {cm}^{- 1}$ $m ( E ) = 2498.19 {cm}^{- 1}$ | 0 |
| | | A₁ | 0 | 400 | $4 {v}_{3} + 8 α + 2 β + 2 γ - {2 [ {( β + γ - 2 α )}^{2} + 24 {γ}^{2} ]}^{\frac{1}{2}} = 2498.178 {cm}^{- 1}$ $m ( {A}_{1} ) = 2498.18 {cm}^{- 1}$ | 0 |
| | | F₁ | 4 | 310 | 4v₃ + 6α + 3β − 6γ = 2506.112 cm⁻¹ | 0 |
| | | | | | m(F₁) = 2506.112 cm⁻¹ | |
| | | F₂ | 2. | 310 | $4 {v}_{3} + 4 α + 4 β + 3 γ - {[ {( 2 a - β + 3 γ )}^{2} + 24 {γ}^{2} ]}^{\frac{1}{2}} = 2506.585 {cm}^{- 1}$ $m ( {F}_{2} ) = 2506.58 {cm}^{- 1}$ | 0 |
| | | E | 4 | 220 | $4 {v}_{3} + 8 α + 2 β - γ + {[ {( 2 β - 4 α - γ )}^{2} + 24 {γ}^{2} ]}^{\frac{1}{2}} = 2508.9955 {cm}^{- 1}$ $m ( E ) = 2508. {cm}^{- 1}$ | 0 |
| | | A₁ | 4 | 220 | $4 {v}_{3} + 8 α + 2 β + 2 γ + {2 [ {( β + γ - 2 α )}^{2} + 24 {γ}^{2} ]}^{\frac{1}{2}} = 2509.246 {cm}^{- 1}$ $m ( {A}_{1} ) = 2509.25 {cm}^{- 1}$ | 0 |
| | | F₂ | 4 | 211 | $4 {v}_{3} + 4 α + 4 β + 3 γ + {[ {( 2 α - β + 3 γ )}^{2} + 24 {γ}^{2} ]}^{\frac{1}{2}} = 2511.97 {cm}^{- 1}$ $m ( {F}_{2} ) = 2511.97 {cm}^{- 1}$ | 0 |

TABLE 5
Vibrational parameters of the UF₆ and SF₆ molecules

| Parameter | ²³⁸UF₆ | ³²SF₆ |
|---|---|---|
| [symbol] ≡ v₃ | 627.724 (cm⁻¹ ) | 948.103 (cm⁻¹) |
| D ≡ [symbol] | 4.727593612 × 10⁻¹² | 6.396156063 × 10⁻¹² |
| | (ergs) | (ergs) |
| X₃₃ | −0.70 ± 0.05 (cm⁻¹) | −1.74256 ± 0.00015 (cm⁻¹ ) |
| $\text{?} / D$ | 8.334841201 × 10¹⁶ | 14.05374243 × 10¹⁶ |
| | (cm⁻²/ergs) | (cm⁻²/ergs) |

[symbol]

indicates data missing or illegible when filed

ν₃-vibrational mode in the proportionality (11) have been very accurately measured. These are tabulated in Table 5. A straight line going through the points (X₃₃, λ̅ₑ²/D) for UF₆ and SF₆ will specify the line on which all the points of the other hexafluorides should lie, according to the proportionality relation (11). Since the values of λ̅ₑ²/D are available for all the hexafluorides, the values of X₃₃ for the other hexafluorides can be obtained from the graph, to a high degree of accuracy for all practical applications.

The values of X₃₃ thus obtained will then have to be compatible with those obtained from eq. (8) through the application of the equivalent Morse potential. They also have to be compatible with the frequency conditions imposed by the analysis of the structure of the vibrational ladder described above. The values of X₃₃ obtained through the application of the equivalent Morse potential are expected to deviate more as we move onto lighter hexafluorides and for SF₆ the deviation is expected to be substantial. Subsequently, the values of all the unharmonicity constants of the hexafluorides and the vibrational frequencies can be determined to a degree of accuracy which is more than sufficient for all practical applications.

FIG. 1 shows the graph of X₃₃ against λ̅ₑ²/D. The fundamental frequencies λ̅ₑ≡ν₃ (cm⁻¹) and the Dissociation energies D are those found in Table 5. The straight line graph for X₃₃ is defined by the accurately measured values for UF₆ and SF₆ (black line). The other line (broken line) corresponds to the equivalent Morse unharmonicity constant (⅙)λ̅ₑxₑ. We see that for the heavy hexafluorides the two values are virtually identical. As we move onto lighter hexafluorides the deviation between the two values generally increases. MoF₆ constitutes a slight exception due to its very high dissociation energy.

From the graphs in FIG. 1 the values of X₃₃ for the other hexafluorides can be calculated to a high degree of accuracy which is more than sufficient for any practical application. Only hexafluorides with totally symmetric electronic ground states (A_{1g}) have been included in the graph. The graphs of FIG. 1 are self evident, in particular for the heavy hexafluorides UF₆ and PuF₆, and no more elaborate analysis can be included in the short space of a patent application. The conclusion is clear that the vibration of the ν₃-vibrational mode of the UF₆ molecule is extremely close to that of an ideal harmonic oscillator. We will not provide any further analysis on this topic except pointing out the fact that the frequency spread of the manifold structures of the vibrational ladders of the hexafluorides (Tables 3 and 4 for the UF₆ molecule) plotted against the square of the vibrational quantum number are straight lines. This testifies a very high accuracy to the frequency values of the sublevels in the manifolds given in tables 3 and 4.

The absorption of light with intensity Iₒ propagating through an absorbing medium is governed by the equation I_{ν}=Iₒe^{-α(ν)1} with α(ν)=ρS_{υ}(ν) where α(ν)(m⁻¹) is the absorption coefficient, ρ (mole/m³) is the density (concentration), S_{υ}(ν) (m²/mole) is the vibrational band strength at frequency ν, I (m) is the path length, ν (m⁻¹) is the wavenumber (frequency) in (m⁻¹). Then

$${S}_{\text{?}} = {\int }_{band} {S}_{\text{?}} ( v ) dv = \frac{1}{p l} {\int }_{band} ln ( \frac{{I}_{\text{?}}}{{I}_{\text{?}}} ) dv \qquad ( 12 )$$

$$\text{?} \text{indicates text missing or illegible when filed}$$

where Sₒ is the vibrational band strength in m/mole and the integration is carried over the entire vibrational band, including all hot bands. The vibrational band strength S_{υ} is obtained by frequency scanning the entire band according to eq. (12). Once the vibrational band strength S_{υ} of a hot absorption band is found we proceed to obtain the dipole moment of a particular absorption band through the Integrated Absorption Coefficient α_{if}^{(t)}(m⁻²).

Further analysis results in the vibrational band strength in terms of the transition dipole moment

$${S}_{\text{?}} = \frac{8 {π}^{3} {N}_{\text{?}} {v}_{\text{?}}}{c h} \frac{1}{4 π {ε}_{\text{?}}} {\vert {μ}_{\text{?}}^{\text{?}} \vert}^{2} \qquad ( 13 )$$

$$\text{?} \text{indicates text missing or illegible when filed}$$

where N_{A} (mole⁻¹) is Avogadro's number, νₒ≡ν_{fi} is the transition frequency in (m⁻¹) (which is the average frequency over which the entire absorption band is measured), ϵₒ (F/m) is the permittivity of free space, μ_{fi}= [symbol] φ_{f}|μ|φᵢ [symbol] =e [symbol] φ_{f}|r|φᵢ [symbol] (C·m) is the dipole moment of the transition between states |φⱼ [symbol] and |φᵢ [symbol] , μ_{fi}^{(z)}, (C·m) is the induced dipole moment approximated to the statistical average of the z-component of μ_{fi} (parallel to the applied electric field) and e (C) is the electronic charge.

The dipole moments for absorption at the fundamental vibration ν₃ and absorption at the third energy excitation level 3ν₃, are then given by

$${\{ {\vert {μ}_{\text{?}}^{\text{?}} \vert}^{2} \}}_{\text{?}} = \frac{4 {πε}_{\text{?}} ch}{8 {π}^{3} {N}_{\text{?}}} \frac{{( {S}_{\text{?}} )}_{\text{?}}}{{{v}^{\text{?}}}_{\text{?}}} = \frac{1}{6.758359883 \times {10}^{\text{?}}} \frac{{( {S}_{\text{?}} )}_{\text{?}}}{{{v}^{\text{?}}}_{\text{?}}} \qquad ( 14 )$$

$${\{ {\vert {μ}_{\text{?}}^{\text{?}} \vert}^{2} \}}_{\text{?}} = \frac{4 {πε}_{\text{?}} ch}{8 {π}^{3} {N}_{\text{?}}} \frac{{( {S}_{\text{?}} )}_{\text{?}}}{{( {{v}^{\text{?}}}_{\text{?}} )}_{\text{?}}} = \frac{1}{6.758359883 \times {10}^{\text{?}}} \frac{{( {S}_{\text{?}} )}_{\text{?}}}{{( {{v}^{\text{?}}}_{\text{?}} )}_{\text{?}}} \qquad ( 15 )$$

$$\text{?} \text{indicates text missing or illegible when filed}$$

Eqs. (14) and (15) are similar to those derived in the literature [Fox and Person, Journal of Chemical Physics, Vol. 64 (12), pp. 5218-5221, (1976); Kim et al, Chemical Physics Letters, Vol. 104 (1), pp. 79-82, (1984)] but all three equations (13)-(15) are here derived and expressed in SI units. They facilitate the determination of the dipole moments through direct experimental observation. After searching most of the experimental results in the literature the most reliable values for the vibrational band strengths for the three hexafluorides UF₆, SF₆ and PuF₆, are summarized in Table 6. We have carried out many comparisons and calculations between theory and experiments and established that these values conform with our equations and the available spectroscopic data but these are outside the scope of the present account.

From eqs. (14) and (15), and the vibrational band strengths from Table 6 we calculate the dipole moments of the transitions. These are summarized in Table 7. All the available experimental results on the vibrational band strengths and the dipole moments have been analysed and compared to the theoretical calculations. There is very close agreement for the heavy

TABLE 6
Vibrational Band Strengths

| Hexafluoride | ³²SF₆ | ²³⁸8UF₆ | ²³⁹PuF₆ |
|---|---|---|---|
| Absorption | vₒ ≡ m(F₁)₍ᵥ_{₃}₎ = 947.9768 cm⁻¹ | vₒ ≡ m(F₁)₍ᵥ_{₃}₎ = 627.702 cm⁻¹ | vₒ ≡ m(F₁)₍ᵥ_{₃}₎ = 620 cm⁻¹ |
| frequencies | (vₒ)₍₃ᵥ_{₃}₎ ≡ m(A₂)₍₃ᵥ_{₃}₎ = 2845.28 cm⁻¹ | (vₒ)₍₃ᵥ_{₃}₎ ≡ m(A₂)₍₃ᵥ_{₃}₎ = 1883.77 cm⁻¹ | (vₒ)₍₃ᵥ_{₃}₎ ≡ m(A₂)₍₃ᵥ_{₃}₎ = 1859.9 cm⁻¹ |
| (S_{υ})ᵥ_{₃} (km mole⁻¹) | 1067 | 702 (±20) | 524 (±20) |
| (S_{υ})₃ᵥ_{₃} (km mole⁻¹) | 0.048 | 0.017 (±0.002) | 0.022 (±0.003) |
| $\frac{{( {S}_{υ} )}_{3 {v}_{3}}}{{( {S}_{υ} )}_{{v}_{3}}}$ | 4.498 × 10⁻⁵ | 2.242 × 10⁻⁵ | 4.1985 × 10⁻⁵ |

Hexafluorides and the discrepancies for the lighter hexafluorides have been accurately accounted for, but the detailed calculations are outside the scope of the present account.

We have analysed a large amount of information on the vibrational spectra of the Uranium Hexafluoride molecule at low temperatures available in the literature [for example, Aldridge et al, Journal of Chemical Physics, Vol. 83 (1), pp. 34-48, (1985); Krohn et al, Journal of

TABLE 7
Dipole Moments
(Units: 1 Debye = 3.3333 × 10⁻³⁰ C · m = 10⁻¹⁸ esu · cm)

| Hexafluoride | | ³²SF₆ | ²³⁸UF₆ | ²³⁹PuF₆ |
|---|---|---|---|---|
| Absorption | | vₒ ≡ m(F₁)₍ᵥ_{₃}₎ = 947.9768 cm⁻¹ | vₒ ≡ m(F₁)₍ᵥ_{₃}₎ = 627.702 cm⁻¹ | vₒ ≡ m(F₁)₍ᵥ_{₃}₎ = 620 cm⁻¹ |
| frequencies | | vₒ ≡ m(A₂)₍₃ᵥ_{₃}₎ = 2845.28 cm⁻¹ | vₒ ≡ m(A₂)₍₃ᵥ_{₃}₎ = 1883.77 cm⁻¹ | vₒ ≡ m(A₂)₍₃ᵥ_{₃}₎ = 1859.9 cm⁻¹ |
| \|μᵥ_{₃}^{(z)}\| | C · m | 1.2835 × 10⁻³⁰ | 1.2864 × 10⁻³⁰ | 1.1183 × 10⁻³⁰ |
| | Debye | 0.385 | 0.386 | 0.3355 |
| \|μ₃ᵥ_{₃}^{(z)}\| | C · m | 5 × 10⁻³³ | 3.654 × 10⁻³³ | 4.18356 × 10⁻³³ |
| | Debye | 0.0015 | 0.0011 | 0.00126 |
| $\frac{\vert {μ}_{3 {v}_{3}}^{( z )} \vert}{\vert {μ}_{{v}_{3}}^{( z )} \vert}$ | — | 3.874 × 10⁻³ | 2.84 × 10⁻³ | 3.741 × 10⁻³ |

Molecular Spectroscopy, Vol. 132, pp. 285-309, (1988)]. At very low temperatures, below 80° K the Q_{A} subbandhead becomes dominant with the Q_{A}(J) components spreading towards the higher frequencies. On the lower frequency side the position of the Q_{G} subbandhead is clearly discernible. The spread of the whole Q-branch subbandheads represents the width of one single quantum state available for a transition. Table 8 lists the wavenumbers at the edges of the subbandheads Q_{A}-Q_{G} for the ν₃ fundamental band of the ²³⁸UF₆ molecule. The frequency difference between the Q_{A}(62) line and the Q_{G} line is 0.197 cm⁻¹ and for all practical purposes this can be taken to be the width of one single quantum state.

The 0→3ν₃ overtone of ²³⁸UF₆ was also studied extensively. Both, the absorption spectra of the ν₃-fundamental band and 3ν₃-fundamental band are dominated by the seven strong absorption lines labelled A-G, whose spacing increases toward lower wavenumbers. There is a striking similarity between the spectra of the Q-branches of the ν₃ and 3ν₃ bands of the UF₆ molecule. For the 3ν₃ overtone band, however, the separation between the B and E edges is

TABLE 8
Subbandhead frequencies (cm⁻¹) for the ν₃-vibrational
mode Q-branch of the ²³⁸UF₆ and ³²SF₆ molecules

| Subband | ²³⁸UF₆ | ³²SF₆ |
|---|---|---|
| head | (cm⁻¹) | (cm⁻¹) |
| Q_{A}(66) | 627.766 | |
| Q_{A}(62) | 627.758 | |
| Q_{A}(58) | 627.750 | |
| Q_{A}(54) | 627.743 | |
| Q_{A}(50) | 627.736 | |
| Q_{A}(46) | 627.730 | |
| Q_{A}(42) | 627.724 | |
| Q_{A}(38) | 627.718 | |
| Q_{A}(30) | 627.712 | |
| Q_{A}(22) | 627.707 | |
| Q_{A} | 627.701 | 947.975 |
| Q_{B} | 627.697 | 947.969 |
| Q_{C} | 627.685 | 947.953 |
| Q_{D} | 627.667 | 947.930 |
| Q_{E} | 627.640 | 947.899 |
| Q_{F} | 627.605 | 947.858 |
| Q_{G} | 627.561 | 947.807 |
| Q_{H} | | 947.754 |

TABLE 9
Wavenumbers and Assignments for
the UF₆ 3ν₃ absorption overtone

| Subband- | | |
|---|---|---|
| head line | 3ν₃ (cm⁻¹) | Identification |
| Q_{A}(8), Q_{A}(10) | 1875.743 | Q_{A}(54) |
| Q_{A}(35), Q_{A}(52) | 1875.720 | Q_{A}(50) |
| Q_{A}(54) | 1875.700 | Q_{A}(46) |
| Q_{A}(26), Q_{A}(34) | 1875.681 | Q_{A}(42) |
| Q_{A}(56) | 1875.665 | Q_{A}(38) |
| Q_{A}(38) | 1875.628 | Q_{A}(56) |
| Q_{A}(42) | 1875.624 | Q_{A}(26), Q_{A}(34) |
| Q_{A}(46) | 1875.621 | Q_{A}(54) |
| Q_{A}(50) | 1875.615 | Q_{A}(35), Q_{A}(52) |
| Q_{A} | 1875.598 | Q_{A}(8), Q_{A}(10) |
| Q_{B′} | 1875.594 | Q_{B′}(23), Q_{B′}(44) |
| Q_{B} | 1875.589 | Q_{B}(13), Q_{B}(15) |
| Q_{C} | 1875.570 | Q(24), Q(26) |
| Q_{D} | 1875.542 | Q(33), Q(35) |
| Q_{E} | 1875.503 | Q(44), Q(46) |
| Q_{F} | 1875.453 | Q(55), Q(57) |
| Q_{G} | 1875.387 | Q(72), Q(74) |

0.086 cm⁻¹ as compared to 0.56 cm⁻¹ for the ν₃ band. The band origin occurs near the peak A. At very low temperatures the Q_{A} subbandhead becomes dominant, with the Q_{A}(J) components spreading towards the higher frequencies. On the higher frequency side the spread of the Q_{A} subbandhead gives discernible peaks up to, and even beyond, J=56. Table 9 lists all the wavenumbers and assignments for the 3ν₃ absorption overtone. The total spread of the Q-branch subbandheads can be considered to be between the [Q_{A}(56)−Q_{G}]_{3ν}_{₃} peaks. This spread is 0.278 cm⁻¹. We also consider it to be valid for a three-photon step wise absorption where the selection rule Δl=±1 such as is the case in multiphoton interaction processes.

In Table 10 the spread of the subbandheads from Q_{A} to Q_{G} for the ν₃-fundamental and the 3ν₃ overtone, for the three Hexafluorides ²³⁸UF₆, ¹⁰⁰MoF₆ and ³²SF₆ have been summarized. All the values listed are those obtained from the available experimental data. The spread of the subbandheads (Q_{A}-Q_{G})_{ν}_{₃} for the ν₃-fundamental is seen to increase as we move from the heavier to the lighter hexafluorides, whilst for the 3ν₃-overtone it is seen to increase by even larger amounts. At low temperatures the effective subbandhead spread (Q_{A}-Q_{G}), including small considerations for the Q_{A} subbandhead spread towards higher frequencies, can be taken to represent the FWHM of the lineshape factor g(ν_{f}) of a normalized Lorentzian distribution centred near the Q_{A} to Q_{B} subbandheads.

From the recordings of the absorption spectra and Table 10 we can obtain very good estimates for the normalized lineshape function g(ν_{f}) given by

$$g 〈 {v}_{f} ) = \frac{2}{πΔ {v}_{f}} , g ( {v}_{o} ) = \frac{2}{πΔ {v}_{o}} \qquad ( 16 )$$

where Δν_{f} is the overall envelope of the distribution consisting of the series of subbandheads of the recorded spectra. The subscript f signifies the final level and the subscript o signifies the fundamental vibration. The value given by eq. (16) is approximate as we have taken it to represent the maximum of a normalized Lorentzian distribution at the centre of the prominent

TABLE 10
Spread of the subbandheads from (Q_{A}-Q_{G}) for the
ν₃-fundamental and the 3ν₃ overtone, for the
three Hexafluorides ²³⁸UF₆, ¹⁰⁰MoF₆, and ³²SF₆

| | ν₃ - fundamental | |
|---|---|---|
| | (Δνₒ)_{ν}_{₃} = | 3ν₃-overtone |
| | (Q_{A}-Q_{G})_{ν}_{₃} | (Δνₒ)₃_{_{ν3}} = |
| Hexa- | (effective) | (Q_{A}-Q_{G})₃_{_{ν3}} |
| fluoride | cm⁻¹ | cm⁻¹ |
| ²³⁸UF₆ | 0.197 | 0.278 |
| ¹⁰⁰MoF₆ | ~0.2 | |
| ³²SF₆ | 0.23 | ~0.54 |

subbandheads (Q_{A}) in the case of supercooled UF₆ gas), equal to the frequency difference between the extended spread of the Q_{A} and the Q_{G} edges. This spread of the whole Q-branch subbandheads represents the width of one single quantum state available for a transition. For all practical purposes, it gives a very sound value for experimental calculations. In the cases of higher order electromagnetic interactions, it can also set a lower practical limit for the value of the resonant denominators which is now determined by the value of g(ν_{f}) corresponding to the smearing out of the final energy state.

By considering the spontaneous transition coefficient A and the induced transition coefficient B [Shimoda K., ‘Introduction to Laser Physics’, second edition, Springer-Verlag, pp. 78-84, eqs. (4.34) and (4.37), (1986); Weissbluth M., ‘Photon-Atom Interactions’, Academic Press, pp. 226-232, eqs. (5.154) and (5.177), (1989)] we have expressed the induced dipole moment for a two-level quantum system μ₁₀^{(z)} in terms of its characteristic parameters only, i.e. the frequency ωₖ and the spontaneous lifetime of the upper level tₛₚₒₙ (in SI units):

$${\vert {μ}_{\text{?}}^{\text{?}} \vert}^{2} = ( \frac{{g}_{\text{?}}}{{g}_{\text{?}}} ) \frac{{πε}_{\text{?}} ℏ {c}^{3}}{{ω}_{k}^{3} {η}^{\text{?}} {t}_{\text{?}}} \qquad ( 17 )$$

$$\text{?} \text{indicates text missing or illegible when filed}$$

where g₁ and g₀ are the degeneracies of the two levels and as in all our expressions for the dipole moment and the spontaneous lifetime we include a power of the refractive index η in accordance with the corresponding power of the speed of light c (η=1). From eq. (17) we note that the lineshape factor g(νₒ) does not enter into the expression for the dipole moment.

The induced absorption transition rate W₀₁ for a two-level quantum system is given by [Yariv A., ‘Quantum Electronics’, second edition, John Wiley & Sons, pp. 162-165, eqs. (8.5-15), (1975)], (in SI units)

$${W}_{01} = {W}_{10} ( \frac{{g}_{\text{?}}}{{g}_{\text{?}}} ) = ( \frac{{g}_{\text{?}}}{{g}_{\text{?}}} ) \frac{{λ}^{2}}{8 π hv {η}^{2}} \frac{1}{{t}_{span}} g ( {v}_{\text{?}} ) {I}_{\text{?}} \qquad ( 18 )$$

$$\text{?} \text{indicates text missing or illegible when filed}$$

where λ (m) is the wavelength, ν (s⁻¹) is the frequency of the applied radiation, tₛₚₒₙ (s) is the spontaneous lifetime of the upper level, η is the refractive index and

$${I}_{\text{?}} ( J / {m}^{2} s )$$

$$\text{?} \text{indicates text missing or illegible when filed}$$

is the intensity of the applied beam. g(νₒ) is the lineshape function in (s) resulting from the smearing out of the position of the final energy state [symbol] , with Δνₒ being the width at half the maximum of the absorption spectrum of the level in (s⁻¹). For an equivalent two-level system of the ground to first energy excitation level of Uranium Hexafluoride (this would be for example the case for a weak probe beam used for absorption such as a diode laser) we have from Table 10 that Δν=0.197 cm⁻¹, giving g(νₒ)=1.07793654×10⁻¹⁰ s. Using the other fundamental constants for the UF₆ molecule ωₖ=1.183509582×10¹⁴ s⁻¹, tₛₚₒₙ=0.087 s in eq. (27) we obtain (W₀₁)_{UF}_{₆}=3.0017 I_{ω}_{ₖ}. This would be the transition rate for absorption between the ground and the first excitation level of the UF₆ molecule had there been no further excitation up the ν₃ mode vibrational ladder. Introducing into eq. (18) the equivalent parameters for the SF₆ molecule we obtain (W₀₁)=1.85058 I_{ω}_{ₖ} from which we see that the equivalent transition rate at the fundamental would be smaller for the lighter hexafluoride than for the heavier one.

On applying elementary quantum mechanical principles to the theory of the harmonic oscillator we have obtained a simple expression for the transition dipole moment

$${μ}_{10}^{( z )}$$

of the fundamental of a molecular system:

$${μ}_{10}^{( z )} = \frac{1}{\sqrt{3}} \vert {μ}_{10} \vert = \frac{e}{\sqrt{3}} 〈 {φ}_{\text{?}} \vert r \vert {φ}_{\text{?}} 〉 = \frac{e}{\sqrt{3}} {r}_{10} = \frac{e}{16 π \sqrt{3}} {( \frac{ℏ}{2 m {ω}_{k}} )}^{1 / 2} \qquad ( 19 )$$

$$\text{?} \text{indicates text missing or illegible when filed}$$

This is a very simple expression for the dipole moments of molecules whose vibrational ladder structure is very close to that of a harmonic oscillator. It gives remarkably accurate values to the experimental ones obtained from the measurement of their vibrational band strengths (eq. (12)). Thus, the dipole moments of the ν₃ vibrational mode of heavy hexafluorides can be calculated from knowledge only of the vibrational frequency of the fundamental ω and the three fundamental constants e, m and ℏ. All dipole moments are of the same magnitude. We have constructed tables for the hexafluorides comparing the results obtained from eq. (19) with the experimental values quoted in the literature.

For heavy hexafluorides, particularly for UF₆, the agreement is extremely good. In particular, the value of

$${μ}_{10}^{( z )}$$

for the UF₆ molecule calculated from eq. (19) is extremely close to the experimental value in Table 7 obtained from the measurement of the vibrational band strength through eq. (14). On the contrary, for the lightest of the hexafluorides SF₆ there is a much larger discrepancy between the experimental and calculated values from eq. (19).

We derived two different expressions, eqs. (17) and (19), for the induced dipole moment μ₀₁^{(z)} of the fundamental transition of a harmonic oscillator. The first one was derived through the spontaneous and induced transition coefficients A and B and the second through the application of elementary harmonic oscillator theory. These two expressions, however, must be equivalent. On comparing the two expressions we obtain

$${t}_{span} = ( \frac{{g}_{\text{?}}}{{g}_{\text{?}}} ) \frac{1536 {π}^{\text{?}} m {ε}_{\text{?}} {c}^{3}}{{e}^{2} {ω}_{k}^{2} {η}^{3}} \qquad ( 20 )$$

$$\text{?} \text{indicates text missing or illegible when filed}$$

from which we see that for a molecular system whose energy levels are a very close match to those of a harmonic oscillator the spontaneous lifetime of the first excited level depends only on the inverse of the square of the frequency difference ωₖ between the two levels, and the degeneracy of the levels. For the ²³⁸UF₆ molecule the frequency of the fundamental ωₖ has been very accurately measured to be ωₖ=627.7019 cm⁻¹=1.182371668×10¹⁴ s⁻¹. The degeneracy of the upper level (υ=1) of the ν₃ vibrational mode is g₁=3 and thus (g₁/gₒ)=3. Substituting these values in eqs. (19) and (20) we obtain

$$\vert {μ}_{10}^{( z )} \vert = 1.2876 \times {10}^{- 30} C m$$

and tₛₚₒₙ=0.086523 s.

The dipole moment and the spontaneous lifetime of the first energy excitation level of UF₆ have been accurately measured to be

$$\vert {μ}_{10}^{( z )} \vert = ( 1.28 \pm 0.012 ) \times 1 {0}^{- 30} C m$$

and tₛₚₒₙ=(0.086±0.003) s [Kim K. C. and Person W. B., Journal of Chemical Physics, Vol. 74(1), pp. 171-178, (1981)] and we see that the values obtained from eqs. (19) and (20) are in very good agreement with the measured experimental values. This further demonstrates the closeness of the vibrational ladder of the UF₆ molecule to that of an ideal harmonic oscillator. As we move to the molecules of lighter hexafluorides the discrepancies between the measured experimental values and those calculated increase. The above equations for the dipole moments pertain only to molecules whose vibrational ladder is a very close match to that of a harmonic oscillator such as the very heavy hexafluorides.

The fundamental quantity which determines the strength of the interaction between matter and radiation is the fine structure constant α_{fs}. From eq. (20) we can obtain an expression for the spontaneous lifetime of an excited quantum system whose energy levels are a very close match to a harmonic oscillator in terms of the fine structure constant:

$$\frac{1}{{t}_{span}} = \frac{4 {α}_{\text{?}} {η}^{2}}{{c}^{2}} \frac{{ω}_{k}^{3}}{{e}^{2}} ( \frac{{g}_{\text{?}}}{{g}_{\text{?}}} ) {\vert {μ}_{10}^{( z )} \vert}^{2} \qquad ( 21 )$$

$$\text{?} \text{indicates text missing or illegible when filed}$$

This is in perfect agreement with that given in the theoretical literature [Weissbluth M., ‘Photon-Atom Interactions’, Academic Press, p. 232, eq. (5.177), (1989)]. It corroborates that all calculations leading up to equations (17) to (21) for the dipole moment and the spontaneous lifetime of the levels, are valid and consistent with one another.

An atomic state cannot be an infinitely sharp state but must have a finite energy spread which will be limited by a level width Δ [symbol] =ℏΓ≈ℏ2πΔν where Δν is the spectral width of the spontaneous emission line of the transition and ℏΓ is interpreted as the level width. It is the minimum possible width assuming all other broadening mechanisms have been eliminated. We have investigated all other broadening mechanisms of the energy levels but they are all negligible compared to the power broadening of the transitions occurring during the interaction in isotope separation processes.

From eqs. (20) and (21) we see that for a harmonic oscillator model

$${ω}_{k}^{3} {t}_{span} = constant , {ω}_{k}^{3} {t}_{span} {\vert {μ}_{10}^{( z )} \vert}^{2} = constant and ω {\vert {μ}_{10}^{( z )} \vert}^{2} = constant ,$$

the last relation resulting from the correspondence relation between classical quantities and the quantum mechanical quantities, and all three relations are perfectly compatible amongst themselves. We have elaborated on the above relations and in conjunction with the available experimental values of the hexafluorides whose values have been very accurately measured we obtained the possible experimental values of the spontaneous lifetimes and the dipole moments of the other hexafluorides. These are in very good agreement with the values available in the literature but further details are outside the scope of the present patent application.

We have derived the absorption coefficient of a classical harmonic oscillator in terms of the fundamental physical constants and also the absorption coefficient of a quantum mechanical oscillator in terms of the dipole moment of system. The two expressions must be completely equivalent and on comparing the two we can establish the correspondence of the classical quantity (e²/m) to its quantum mechanical equivalent in terms of the dipole moment. The value of the classical lifetime of a perfect harmonic oscillator was found to be

$$\frac{1}{{t}_{class}} = 2 γ \to \frac{1}{3 {t}_{span}} = \frac{2}{3} \frac{1}{4 π {ε}_{e}} \frac{{ω}_{o}^{2} {η}^{3}}{{c}^{3}} \frac{{g}_{o}}{{g}_{1}} \frac{2 {ω}_{o}}{3 ℏ} {\vert {μ}_{10} \vert}^{2} = \frac{{g}_{o}}{{g}_{1}} \frac{{ω}_{o}^{2} {e}^{2} {η}^{3}}{4608 {π}^{3} {ε}_{o} m {c}^{3}} \qquad ( 22 )$$

Consider the case of the ν₃-vibrational mode of the Uranium Hexafluoride molecule. If we substitute ωₒ=1.182371856×10¹⁴ s⁻¹ and the numerical value of the degeneracies of the two levels (gₒ/g₁)=⅓, we obtain 1/t_{class}=3.852528 s⁻¹ or tₛₚₒₙ=0.086523 s, a value in perfect agreement with that obtained above through the application of eq. (20). This value for tₛₚₒₙ is in very good agreement with the experimentally measured values reported in the literature [Kim K. C. and Person W. B., Journal of Chemical Physics, Vol. 74 (1), pp. 171-178, (1981)]. The above results demonstrate the consistency of both, the classical and quantum equations used in the calculation of the parameters for the heavy hexafluorides. All the equations given above have been extensively tested with all the available experimental results in the literature and were found to give extremely close values for the heavy hexafluoride molecules.

Through our derivation of the absorption coefficient we have obtained an expression in terms of the linear frequency, for the absorption cross section of a two-level quantum particle whose vibration is equivalent to that of a perfect harmonic oscillator as

$$σ ( v ) = \frac{{g}_{o}}{{g}_{1}} \frac{{ω}_{o}}{2 {ε}_{o} c ℏ} {\vert {μ}_{01}^{( z )} \vert}^{2} g ( v ) \qquad ( 23 )$$

with the value of

$${\vert {μ}_{01}^{( z )} \vert}^{2}$$

given by eq. (19), or its value can be read off Table 7. Eq. (23) is in agreement with expressions given in the literature [Judd O. P., Journal of Chemical Physics, Vol. 71, No 11, p. 4515, [eq. (17)], [FIG. 1], (1979)]. We see from eq. (23) that the absorption cross section depends only on the lineshape function g(ν). Substituting the values of

$${\vert {μ}_{01}^{( z )} \vert}^{2}$$

and ωₒ for the UF₆ ν₃-mode fundamental vibration from the tables we obtain σ(νₒ)=1.167132442×10⁻¹⁰ g(νₒ). The lineshape function g(νₒ) is given by eq. (16), where (Δνₒ)_{ν}_{₃} is the spread of subbandheads of the Q-branch spectrum listed in Table 10. For the heavy hexafluorides the absorption cross sections can be calculated directly from eq. (23) by substituting the effective spread of the subbandheads (Δνₒ)_{ν}_{₃}=Q_{A}-Q_{G} representing one single quantum state. For the lighter hexafluorides the absorption cross sections can best be calculated from eq. (23) using the measured values of the induced dipole moments. In Table 11 we summarised the absorption cross sections of some of the basic hexafluorides where the values of (Δνₒ)_{ν}_{₃} are taken from Table 10.

A similar equation holds for the overtone absorption cross section of the third energy excitation level, where the lineshape function (g(νₒ))_{ν}_{₃} corresponds to (Δν)_{ν}_{₃} the effective spread of the subbandheads of the third energy excitation level Q-branch spectrum and is listed in Table 10. For the third energy excitation level the degeneracies of the Hexafluorides are gₒ=1 and g₃=10, the frequency ω_{ν}_{₃} is given by the m(F₁) line of the 3ν₃ level Table 4, and the measured dipole moment

$$\vert {μ}_{3 {v}_{3}}^{( z )} \vert$$

can be found from Table 7. The results are outside the scope of the present account.

TABLE 11
Absorption Cross Sections of the Fundamental for Some Hexafluorides

| | | Subbandhead | | Absorption cross | |
|---|---|---|---|---|---|
| | | spread | | section | Absorption cross |
| | ν₃-mode | (effective) | | (calculated, | section (from measured |
| | frequency | (Δνₒ)ᵥ_{₃} = | Lineshape | eq. (25) | dipole moments eq. (23)) |
| Hexa- | ωₒ | (Q_{A}-Q_{G})ᵥ_{₃} | function | σ₀₁(νₒ) | σ₀₁(νₒ) |
| fluoride | (×10¹⁴ s⁻¹) | (×10⁹ s⁻¹) | g(νₒ) | (×10⁻²⁰ m²) | (×10⁻²⁰ m²) |
| Molecule | (cm⁻¹) | (cm⁻¹) | (×10⁻¹⁰ s) | (×10⁻¹⁶ cm²) | (×10⁻¹⁶ cm²) |
| ²³⁸UF₆ | 1.82371856 | 5.905911423 | 1.07793654 | 1.258095 | 1.25575 |
| | (627.702) | (0.197) | | | |
| ¹⁰⁰MoF₆ | 1.397669463 | 5.99584916 | 1.0617675 | 1.2392233 | |
| | (742) | (~0.2) | | | |
| ³²SF₆ | 1.785658362 | 6.385579355 | 0.996964781 | 1.16359 | 1.765214 |
| | (947.977) | (0.213) | | | |

We have carried out extensive investigations on the results and the measurements of the absorption cross section available in the literature using powerful probing sources. These bear no consequences to laser isotope separation processes as they pertain to the absorption cross section for the whole vibrational ladder of the molecules. Eq. (23) is not applicable to these cases. There is a clear trend, however, for the absorption cross section of the molecules to increase rapidly as the fluence of the laser beam is lowered.

In order to obtain reliable values for the absorption cross section of the fundamental of the UF₆ molecule, low fluence probing beams must be employed. Spectrophotometer measurements of the absorption cross section of the UF₆ gas at the fundamental frequency of the ν₃-vibrational mode were carried out [Maier II W. B., Holland R. F. and Beattie W. H., Journal of Chemical Physics, Vol. 79, No 10, pp. 4794-4804, Table 1, (15, November 1983)]. These resulted in a value for the absorption cross section of the fundamental transition of 1,155×10⁻²⁰ m² (1.155×10⁻²⁰ cm²). This value is extremely close to the value for the cross section of the UF₆ molecule calculated from the harmonic oscillator analysis from eq. (23) and listed in Table 11 ([σ(νₒ)]_{cal.}=1.258×10⁻²⁰ m²). Note that the calculated value is well within the 10% estimated experimental error claimed. We see that in the case of very heavy hexafluorides, such as UF₆, eq. (23) gives values for the absorption cross section which are completely consistent with the observed experimental results. As a further check, in FIG. 2 we have extended the experimental graph of the absorption cross section of the UF₆ molecule at a gas temperature of 105° K and a frequency of 627.6 cm⁻¹ as a function of laser fluence [Alexander et al, Journal de Chimie Physique, Vol. 80, No 4, pp. 331-337, (1983)]. The experimental points are marked by solid rhombus with the absorption cross section increasing steadily as we go towards lower fluences according to the law

$$σ ∝ {( {φ}_{IR} )}^{- \frac{1}{2}}$$

[or φ_{IR}∝(<n>_{qu})² where <n>_{qu} is the average number of photons actually absorbed by the molecule in the quasicontinuum]. This relation holds for pumping fluence values between 2×10⁻¹ J/m² and 2×10² J/m² (see below for a statistical interpretation and also the effects at higher pumping fluences). The graph is on a logarithmic scale. At low fluences of magnitude 4×10⁻¹ J/m² the absorption cross section of UF₆ approaches an experimentally recorded value of 2×10⁻²¹ m². When the graph is extended to lower fluences it is seen that at a value of 1.4×10⁻² J/m² the absorption cross section is 1×10⁻²⁰ m² and at even lower fluences of the pumping beam it approaches steadily the calculated value for the absorption cross section of the fundamental of an ideal harmonic oscillator, eq. (23), and the values obtained through the use of an infrared spectrophotometer (triangular point).

On substituting eq. (19) into eq. (13), we obtain

$${S}_{o} = \frac{{N}_{A}}{768 π} \frac{1}{4 π {ε}_{o}} ( \frac{{e}^{2}}{m {c}^{2}} ) = \frac{{N}_{A}}{768 π} {r}_{e} \qquad ( 24 )$$

where N_{A} is Avogadro's number in mole⁻¹ and rₑ=2.81794092×10⁻¹⁵ m is the classical radius of the electron. Eq. (24) is a very simple and straightforward result for the vibrational band strength of a molecule whose oscillation is very close to that of a perfect harmonic oscillator. In this case the vibrational band strength depends only on two standard physical constants, Avogadro's number and the classical radius of the electron. On substituting the constants in eq. (24) we obtain the vibrational band strength of the fundamental of a perfect harmonic oscillator to be S_{υ}=703.3503114 km mole⁻¹. This is an extremely close value to the experimentally measured value for the vibrational band strength of the ²³⁸UF₆ molecule in Table 6. It suggests that the vibration of the lower levels of the 13-mode of the UF₆ molecule is a very close match to the vibration of the energy levels of an ideal harmonic oscillator.

On expressing the Integrated Absorption coefficient

$${α}_{if}^{( l )} ( v ) ( {m}^{- 2} )$$

through the vibrational band strength eqs. (12) and (24) we obtained an expression for the linear absorption coefficient α(ν) (m⁻¹) in terms of the lineshape function g(νₒ) (s), eq. (16), and subsequently for the absorption cross section as

$$σ ( v ) = \frac{{α}_{01} ( v )}{Δ N} = \frac{{g}_{o}}{{g}_{1}} g ( {v}_{o} ) \frac{c}{768 π} {r}_{e} = \frac{{g}_{o}}{{g}_{1}} \frac{2}{πΔ v} \frac{c}{768 π} {r}_{e} \qquad ( 25 )$$

where σ(ν) (m²) is the absorption cross section, ΔN (m⁻³) is the number of molecules per unit volume, a₀₁(ν) (m⁻¹) is the absorption coefficient, Δν (s⁻¹) is the linewidth of the transition, c (m/s) is the velocity of light and rₑ (m) is the classical radius of the electron. If we substitute the value of the classical radius of the electron, eq. (25) reduces to eq. (23). Eq. (23) had been derived through the concept of the dipole moment and the harmonic oscillator vibrational parameters, whilst eq. (25) had been arrived at through the concepts of the vibrational band strength and the Integrated Absorption Coefficient. Both approaches lead to the same result for the absorption cross section demonstrating the consistency of the results.

For the UF₆ molecule if we substitute Δν=0.197 cm⁻¹=5.905911423×10⁹ s⁻¹ from Table 10 (the effective spread from the A to the G subbandheads at low temperatures) we obtain the absorption cross section of the fundamental to be υ₂₃₈=1.258094707×10⁻²⁰ m², the same value as the one obtained from eq. (23) above, and tabulated in Table 11. We have obtained many more equations which give values compatible with the experimental results. All the equations derived above, expressed in SI units and incorporating all the necessary characteristics of the levels such as degeneracies, are fully compatible amongst themselves. The values of the various parameters of the heavy hexafluorides obtained through their application are very close to their experimentally measured values. Their extremely close agreement signifies that the properties of the lower levels of the ν₃-mode vibrational ladder of the heavy hexafluorides are very close to those of an ideal harmonic oscillator. Thus, all the parameters of the ν₃-mode vibrational ladder of the UF₆ molecule such as the frequencies, vibrational constants (eqs. (3)-(7)), level and sublevel positions (Tables 3 and 4), the vibrational band strength (eqs. (12, (13) and (24)), the absorption coefficient and the absorption cross sections (eqs. (23) and (25)), the dipole moments (eqs. (14), (15), (17) and (19)), the spontaneous lifetime of the first excited level (eqs. (20) and (21)) and many others, can be obtained through the above equations and they are all fully compatible with the measured experimental results. We have developed further techniques for obtaining the parameters of all the hexafluorides even the lighter ones. It is not possible to give a detailed analysis of all results in the short space of a patent application.

A detailed analysis of the Rabi theory when a two state quantum particle interacts with a radiation field results in the expression for the power broadening of a spectral line given by (see eq. (1) above)

$$Δ {v}_{P} = \frac{{μ}_{01}^{( z )} {E}_{o}}{π ℏ} \qquad ( 26 )$$

where

$${μ}_{01}^{( z )}$$

is the dipole moment and Δν_{P} is the Full Width at Half the Maximum of the power broadened transition. Eₒ is the electric field of the radiation. The probability of a transition for a two-level system under the interaction with a powerful electromagnetic beam, taking into account the power broadening of the levels is

$${\vert {c}_{1} ( t ) \vert}^{2} = \frac{{( \frac{Δ {v}_{P}}{2} )}^{2}}{{( {v}_{01} - v )}^{2} + {( \frac{Δ {v}_{P}}{2} )}^{2}} = \frac{1}{1 + {( \frac{{v}_{01} - v}{\frac{Δ {v}_{P}}{2}} )}^{2}} \qquad ( 27 )$$

where Δω=2πΔν_{P}. From the field strength Eₒ and the dipole moment μ₀₁ we can calculate Δν_{P} and we can plot the probability amplitude of the transition. The curve of |cₜ(t)|² as a function of ν is a near Bell-shaped Lorentzian curve and has a peak centred at (ν-ν₀₁) with a full width at half the maximum Δν_{P} given by eq. (26). In the cases of closely spaced isotopes we can plot the curves for the transitions of both isotopes and see the overlapping occurring for various values of the intensity of the pumping radiation.

The intensity of the beam of a plain sinusoidal electromagnetic wave I as it propagates through a medium can be obtained through the average value of the Poynting vector as

$$\begin{matrix}I = \frac{1}{2} & η & c & {ε}_{o} & {\vert {E}_{o} \vert}^{2}\end{matrix} \qquad ( 28 )$$

where it was assumed that the period of oscillation is very rapid, the relative permeability Kₘ=1, εₒ=8.8541878×10⁻¹² F/m is the permittivity of free space and n is the refractive index of the medium. We have elaborated greatly on the propagation and the structure of the laser beams as they travel through the supercooled molecular gas within the Rayleigh range

$${z}_{o} = \frac{π {w}_{o}^{2}}{λ}$$

but the details are outside the scope present account.

We have calculated and tabulated the power broadening of the fundamental transitions of the three molecules UF₆, MoF₆ and SF₆ under the interaction with a powerful electromagnetic beam. With the vibrational ladder of the UF₆ molecules being a very close match to that of an ideal harmonic oscillator, it is imperative that the selectivity of the desired isotope is achieved over the first few vibrational levels. FIG. 3 shows the power broadened absorption probabilities of the fundamental for the two Uranium Hexafluoride isotopes ²³⁸UF₆ and ²³⁸UF₆, for four different pumping beam intensities ranging from 10×10⁹ W/m² to 60×10⁹ W/m². It demonstrates how the absorption probability of the ground to first energy level of the UF₆ isotopes broadens up as the pumping is increased. The peaks of the curves are located at the centre of the absorption lines. We see that as we increase the pumping intensities the widths of the absorption curves increase rapidly. When the frequency of the pumping beam is set at the absorption frequency of the desired isotope ²³⁵UF₆ at 628.306 cm⁻¹ we see that for low intensities the unwanted isotope ²³⁸UF₆ is hardly absorbent (first two graphs (a) and (b) in FIG. 3). As the intensity of the pumping beam is increased further we see from the successive graphs that the absorption probability of the unwanted isotope ²³⁸UF₆ increases rapidly. But even at high powers (60×10⁹ W/m²) it does not severely affect the selectivity of the desired isotope. The vertical lines indicate frequencies between 628.306 cm⁻¹ and 628.7 cm⁻¹ and their relation to the power broadened curves of the fundamental.

From the standard theory of a harmonic oscillator model of a vibrating molecule [Weissbluth M., ‘Atoms and Molecules’, Academic Press, New York, p. 234, (1978)] we have computed the matrix elements between adjacent energy levels and obtained the identity

$$\sqrt{\frac{m ω}{ℏ}} 〈 {φ}_{{υ}^{′}} \vert r \vert {φ}_{υ} 〉 = \sqrt{\frac{υ + 1}{2}} {δ}_{{υ}^{′} , υ + 1} + \sqrt{\frac{υ}{2}} {δ}_{{υ}^{′} , υ - 1} \qquad ( 29 )$$

with Δυ=υ′−υ=±1. In practice the vibrations of the molecule are anharmonic and the selection rule is replaced by Δυ=±1, ±2, ±3, . . . . The most intense absorption band is the fundamental 0→1 transition. Bands corresponding to transitions 0→2, 0→3 etc are called overtones and in general they are very weak. Eq. (29) can be used to calculate the matrix elements between adjacent levels of the vibrational ladder corresponding to a harmonic oscillator, and subsequently the dipole matrix elements between adjacent levels. The results indicate that the value of [symbol] φ_{υ′}|r|φ_{υ} [symbol] increases according to \sqrt{1}, \sqrt{2}, \sqrt{3}, 4, 5, 6, . . . with increasing vibrational number and the dipole moments between successive higher vibrational levels of a harmonic oscillator increase accordingly with the square root of increasing vibrational number. We will elaborate no more on the subject here.

To a first approximation the power broadening of a transition line is given by eq. (26). On taking the value of the dipole moment of the UF₆ molecule to be 1.285×10⁻³⁰ C·m (Table 7) we have calculated the power broadening of the first six vibrational levels at various pumping intensities. The electric field was calculated using eq. (28). The results are summarized in Table 12. We have investigated all the deviations from the sublevels of the first, second, third and fourth energy states when pumping at the frequency of the fundamental 628.306 cm⁻¹ and at the frequency corresponding to the exact three-photon resonance with the third energy excitation sublevel [m(A₂):(3ν₃)] of the desired isotope ²³⁵UF₆ at 528.527 cm⁻¹ (Table 4). The conclusion was clear that the three-photon absorption process is determined by the power broadening of the first energy level at this frequency. Comparison with the values of Table 12 shows that the mismatch of four-photon resonance with the fourth energy excitation level is even greater when pumping at 628.527 cm⁻¹ than at 628.306 cm⁻¹ and it is well outside the power broadened curve of the level. Note that the successive photon absorption up the sublevels of the first three vibrational levels of the UF₆ molecule corresponds to perfectly allowed transitions with Δ [symbol] =±1.

TABLE 12
PUMPING POWERS AND POWER BROADENING OF THE UF₆ ENERGY LEVELS FOR
VARIOUS PUMPING INTENSITIES AND FOR SPECIFIC BEAM CHARACTERISTICS
Pumping beam parameters: pulse duration τ = 20 × 10⁻⁹ s beam radius r = 0.004 m = 4 × 10⁻³ m

| | | | Power broadening of the first eight levels | | | | | |
|---|---|---|---|---|---|---|---|---|
| | | | 1 | 2 | 3 | 4 | 5 | 6 |
| Intensity (Iₒ) × | Energy ( [symbol] ) × | Electric field | $Δ {v}_{10} = \frac{\begin{matrix}μ & {E}_{o}\end{matrix}}{πℏ}$ | $Δ {v}_{21} = \frac{\begin{matrix}μ \sqrt{2} & {E}_{o}\end{matrix}}{πℏ}$ | $Δ {v}_{32} = \frac{\begin{matrix}μ \sqrt{3} & {E}_{o}\end{matrix}}{πℏ}$ | $Δ {v}_{43} = \frac{\begin{matrix}μ \sqrt{4} & {E}_{o}\end{matrix}}{πℏ}$ | $Δ {v}_{54} = \frac{\begin{matrix}μ \sqrt{5} & {E}_{o}\end{matrix}}{πℏ}$ | $Δ {v}_{65} = \frac{\begin{matrix}μ \sqrt{6} & {E}_{o}\end{matrix}}{πℏ}$ |
| 10⁹ | 10⁻³ | (Eₒ) × 10⁶ | (s⁻¹) | (s⁻¹) | (s⁻¹) | (s⁻¹) | (s⁻¹) | (s⁻¹) |
| (W/m²) | (J) | (V/m) | cm⁻¹ | cm⁻¹ | cm⁻¹ | cm⁻¹ | cm⁻¹ | cm⁻¹ |
| 5 | 5.03E−03 | 1.940954 | 0.252 | 0.356 | 0.436 | 0.503 | 0.562 | 0.616 |
| 10 | 1.01E−02 | 2.744924 | 0.356 | 0.503 | 0.616 | 0.711 | 0.795 | 0.871 |
| 15 | 1.51E−02 | 3.361831 | 0.436 | 0.616 | 0.755 | 0.871 | 0.974 | 1.067 |
| 20 | 2.01E−02 | 3.881908 | 0.503 | 0.711 | 0.871 | 1.006 | 1.125 | 1.232 |
| 30 | 3.02E−02 | 4.754347 | 0.616 | 0.871 | 1.067 | 1.232 | 1.378 | 1.509 |
| 40 | 4.02E−02 | 5.489847 | 0.711 | 1.006 | 1.232 | 1.423 | 1.591 | 1.742 |
| 50 | 5.03E−02 | 6.137836 | 0.795 | 1.125 | 1.378 | 1.591 | 1.778 | 1.948 |
| 60 | 6.03E−02 | 6.723663 | 0.871 | 1,232 | 1.509 | 1.742 | 1.948 | 2.134 |
| 80 | 8.04E−02 | 7.763817 | 1.006 | 1.423 | 1.742 | 2.012 | 2.250 | 2.464 |

It was clear also that when pumping at the frequency of the fundamental 628.306 cm⁻¹ of the desired isotope the selectivity between the two isotopes is inhibited by the mismatch occurring at the second and especially the third energy excitation levels and this mismatch cannot be compensated by the power broadening of the higher level transitions up the vibrational ladder. The reason for the drastic reduction in the selectivity observed experimentally as the pumping intensity was increased is due to the fact that at high pumping powers multiphoton resonances can set up indiscriminately, between the ground level of the undesired isotope or the first excited level of the desired isotope and a higher level in the quasicontinuum of energy states. Subsequently, it is irrelevant whether a molecule exists in the ground or the first excited state and the selectivity between the two isotopes is lost.

Using eq. (26) with the values of

$${μ}_{01}^{( z )} , {μ}_{12}^{( z )} , {μ}_{23}^{( z )} , {μ}_{34}^{( z )}$$

higher vibrational transitions of the UF₆ molecule as obtained from the above results and using Table 12, we plotted the power broadening curves according to eq. (27). The results have been plotted in FIG. 4 for different pumping intensities from 10×10⁹ W/m² to 60×10⁹ W/m². The power broadening of the transitions increases progressively with higher vibrational levels as well as with higher pumping powers. The curves define approximately the probability for absorption as a function of the frequency spread. For all practical purposes, they give more than adequate values for determining the absorption characteristics of the transitions up the vibrational ladder. Their practical significance is up to the fourth energy level of the vibrational ladder of the UF₆ molecule i.e. the discrete energy section of its vibrational ladder.

Experiments with polyatomic molecules have demonstrated the collisionless nature of the excitation process during multiphoton absorption. Normal modes behave initially like harmonic oscillators, but as energy is put into these motions their anharmonic nature becomes more pronounced until dissociation is reached. At higher levels the excited states of the resonant mode mix with other vibrational states of the same energy but of different normal modes. This region of absorption is called the molecular quasicontinuum. The theory assumes (RRKM unimolecular reaction-rate theory) that at high vibrational energies the interaction among the vibrational states is strong enough to continuously maintain a statistical distribution of population among those states giving a huge statistical advantage for absorption. The density of vibrational states is the number of available vibrational states per unit energy interval of the molecule. In this respect there is a profound difference between a diatomic molecule and a larger polyatomic molecule which has considerably larger density of states in the quasicontinuum. There are thus two distinct absorption regions in the excitation process of polyatomic molecules.

The density of vibrational states as a function of the excitation energy has been investigated and published in detail in the literature for all the hexafluorides [D. Jackson, ‘Statistical Thermodynamic Properties of Hexafluoride Molecules’, Los Alamos Scientific Laboratory, Report-LA-6025-MS, (1975)]. From this work the density of vibrational states of a hexafluoride molecule at a particular level of excitation can be obtained. For the UF₆ molecule, even as low a frequency as 1880 cm⁻¹ corresponding to the 3ν₃ level of the ν₃-vibrational mode, the density of states is already more than 1000 vibrational states per cm⁻¹. This includes of course the vibrational states of all the vibrational modes as well as their octahedral symmetry sublevels. It is clear that in the case of an isotope separation process, substantial selectivity between the two isotopes must be achieved through absorption by the desired isotope in the first few excitation states. Subsequently, means must be devised to take the selected molecules to the dissociation limit through the quasicontinuum and continuum of energy states.

Transitions in the lower energy levels of the vibrational ladder are peak power dependent. The electromagnetic radiation interacts with the discrete levels of the vibrational ladder and drives the molecule towards the higher vibrational levels. This is the region of coherent interaction which can best be treated through higher order quantum interaction theory, or else it can be described in terms of the Bloch equations. The first approach, however, can give quantitative results for the first two to three energy levels. The populations of near resonant or resonant laser-coupled energy levels are seen to ‘Rabi oscillate’ inducing a power broadening in the transitions (eq. 26). Because the Rabi frequency depends on the magnitude of the applied electric field, increasing the intensity decreases the effect of the detuning. The off resonant states behave in a resonant manner with population flow between states. Our task is to find at what energy level the discrete region stops and the quasicontinuum of energy levels begins.

The probability of a transition from an initial stationary state |φᵢ [symbol] into a smearing of final states f( [symbol] = [symbol] +ℏω) clustered around a stationary state |φ_{f} [symbol] can be obtained from Fermi's Golden Rule for transitions as

$${\vert \text{?} \vert}^{2} = W \text{?} t = \frac{2 π}{ℏ} {\vert \text{?} \vert}^{2} f ( \text{?} = \text{?} + ℏω ) t \qquad ( 30 )$$

$$\text{?} \text{indicates text missing or illegible when filed}$$

where W_{fi} is the transition rate and the perturbation Hamiltonian is given by [symbol] =μ_{fi}E, where E is the applied electric field, μ_{fi} the dipole matrix element with the ground state and t is the interaction time (pulse duration). The density of final states f( [symbol] ) clustered around the energy level |φ_{f} [symbol] is given by

$$f ( ) = ( {φ}_{f} ) \frac{dn ( {φ}_{f} )}{d}$$

where [symbol] (φ_{f}) is some real positive function governing the normalization of the φ_{f} states which for practical purposes has been checked to be near unity for the range of intensities necessary for our present applications. Eq. (30) is valid under the condition that

$${\vert a \text{?} \vert}^{2} << 1.$$

$$\text{?} \text{indicates text missing or illegible when filed}$$

If this inequality does not hold well, then higher order terms in the time-dependent perturbation expansion must be taken into account involving transitions to higher excitation states. If the inequality is reversed this would correspond to the situation where a quasicontinuum of states sets in and the time dependent perturbation expansion is no longer valid but must be replaced by a statistical thermodynamic approach for the description of the evolution of a quantum system up the quasicontinuum of a vibrational ladder. In the case of a final state in the quasicontinuum, energy can be transferred to other vibrational modes and background states at that particular energy. If Δ [symbol] is the energy width of the band into which the oscillator strength is smeared and μE is the dipole matrix element relative to the ground state then for inequality

$${\vert a \text{?} \vert}^{2} << 1$$

$$\text{?} \text{indicates text missing or illegible when filed}$$

to be reversed marking the beginning of the quasicontinuum of energy states, the following condition must be satisfied [Yablonovitch E., in the ‘The Significance of Nonlinearity in the Natural Sciences’, edited by A. Perlmutter and L. Scott, Plenum Press, New York and London, pp. 207-226, (1977)]:

$$\frac{dn ( {φ}_{f} )}{d} ≫ \frac{Δ}{{\vert {μ}_{f} E \vert}^{2}} \qquad ( 31 )$$

The left hand side of inequality (31) represents the number of states per unit energy interval whilst on the right hand side Δ [symbol] , the energy width of the band into which the oscillator strength is smeared, can be considered to be approximately equal to the maximum spread of the sublevels of the octahedral splitting of the final state (Tables 3 and 4).

We seek to determine the level up the vibrational ladder of the UF₆ molecule from which the quasicontinuum of energy states for the UF₆ molecule starts. From Table 3 the manifold origin of the third vibrational level is at a frequency (3ν₃)=1877.532 cm⁻¹. The density of vibrational states of the UF₆ molecule at this frequency is 750 states/cm⁻¹=3.77558829×10²⁵ states/J (see D. Jackson above). These states correspond to 15 vibrational modes of which only six are non-degenerate. Therefore the density of vibrational states for the ν₃-vibrational mode is

$$\frac{dn ( {φ}_{f} )}{d} \approx 0.251706 \times {10}^{25}$$

states/J. The maximum spread of the sublevels of the third energy state (3ν₃) is equal to (Tables 3 and 4) Δ [symbol] =m(A₂)−m(F₁)=8.17 cm⁻¹≡1.622926×10⁻²² J. For a pumping intensity of 10×10⁹ W/m² corresponding to an electric field Eₒ=2.744924×10⁶ V/m (eq. 28) and the dipole moment of the UF₆ molecule being μ=1.2864×10⁻³⁰ C·m (Table 8) we obtain

$$\frac{Δ}{{( μ {E}_{0} )}^{2}} = 1.30245 \times {10}^{25} {J}^{- 1} .$$

This value violates inequality (31) and thus at this pumping intensities the third energy excitation level of the UF₆ molecule is a pure discrete level of the ν₃-vibrational mode, not being at all affected by other vibrational modes. Note that we have used the value for the dipole moment of the fundamental but any further averaging of the dipole moments of the intermediate states would have not made much difference.

With increasing pumping intensities and at higher vibrational levels the situation changes rapidly. We have repeated the above procedure for higher pumping intensities for the fourth, fifth and sixth energy levels of the UF₆ molecule. The density of states for the various vibrational frequencies are obtained from D. Jackson above. The results for the UF₆ molecule are summarized in Table 13. We observe that for the third energy level the condition for the density of states set by inequality (31) is still smaller than the smearing term up to intensities of 50×10⁹ W/m² (electric fields of up to 6.14×10⁹ V/m), and in eq. (31) is within the limits of being satisfied (bearing in mind the limit of experimental discrepancies). Up to these levels of pumping intensities the third energy level can be considered to be outside the quasicontinuum of energy states. It is clear that there is a maximum intensity level for the selecting laser for avoiding the quasicontinuum of energy states setting in at the third energy level. Table 13 is explicitly clear.

At the fourth energy level, however, the density of states of the UF₆ molecule (a very heavy polyatomic molecule) becomes so large that the quasicontinuum of energy states begins to set in at pumping intensities as low as 10×10⁹ W/m² (electric fields of up to 2.75×10⁶ V/m). At the fifth energy level the density of states of the UF₆ molecule becomes so large that inequality (31) is seen to be satisfied even at very low pumping intensities. At these energy levels the quasicontinuum of energy states is present even at very low pumping intensities.

When pumping at the frequency of the fundamental of the ²³⁵UF₆ isotope (628.306 cm⁻¹) selectivity of the desired isotope ²³⁵UF₆ takes place at the fundamental with the subsequent levels serving as intermediaries towards the higher levels. As the power of the applied beam increases in order to selectively elevate more molecules of the desired isotope to the higher levels, the molecules of both isotopes can proceed to the quasicontinuum of energy states through

TABLE 13
Parameters defining the beginning of the quasicontinuum of energy states for the UF₆ molecule
μ = 1.2864 × 10⁻³⁰ C · m, 1 cm⁻¹ ≡ 1.98644544 × 10⁻²³ J, 1 state/cm⁻¹ ≡ 5.034117625 × 10²² states/J

| | | Third Energy level (3v₃) | | | | Fourth Energy level (4v₃) | | | | Fifth Energy level (5v₃) | | | |
|---|---|---|---|---|---|---|---|---|---|---|---|---|---|
| | | Δ [symbol] = 8.17 cm⁻¹ = | | | | Δ [symbol] = 13.61 cm⁻¹ = | | | | Δ [symbol] = 21.86 cm⁻¹ = | | | |
| | | 1.623 × 10⁻²² J | | | | 2.7036 × 10⁻²² J | | | | 4.3424 × 10⁻²² J | | | |
| | | Density of states = 750/15 = | | | | Density of states = 6300/15 = | | | | Density of states = 37000/15 = | | | |
| | | 50 states/cm⁻¹ = | | | | 420 states/cm⁻¹ = | | | | 2467 states/cm⁻¹ = | | | |
| | | 0.25171 × 10²⁵ states/J | | | | 2.1143 × 10²⁵ states/J | | | | 12.419 × 10²⁵ states/J | | | |
| Inten- sity × | Electric Field | Δ [symbol] × | (μEₒ)² × | $\frac{Δ}{{( μ {E}_{0} )}^{2}} \times$ | $\frac{dn ( {φ}_{f} )}{d} \times$ | Δ [symbol] × | (μEₒ)² × | $\frac{Δ}{{( μ {E}_{0} )}^{2}} \times$ | $\frac{dn ( {φ}_{f} )}{d} \times$ | Δ [symbol] × | (μEₒ)² × | $\frac{Δ}{{( μ {E}_{0} )}^{2}} \times$ | $\frac{dn ( {φ}_{f} )}{d} \times$ |
| 10⁹ | Eₒ × | 10⁻²² | 10⁻⁴⁷ | 10²⁵ | 10²⁵ | 10⁻²² | 10⁻⁴⁷ | 10²⁵ | 10²⁵ | 10⁻²² | 10⁻⁴⁷ | 10²⁵ | 10²⁵ |
| W/m² | 10⁶ V/m | J | J² | J⁻¹ | states/J | J | J² | J⁻¹ | states/J | J | J² | J⁻¹ | states/J |
| 2.5 | 1.372462 | 1623 | 0.31171 | 5.20674 | 0.2517 | 2.7036 | 0.31171 | 8.6734 | 2.1143 | 4.3424 | 0.31171 | 13.9308 | 12.419 |
| 5 | 1.940954 | | 0.62207 | 2.6090 | | | 0.62207 | 4.3461 | | | 0.62207 | 6.9806 | |
| 10 | 2.744924 | | 1.24413 | 1.3045 | | | 1.24413 | 2.1730 | | | 1.24413 | 3.4903 | |
| 15 | 3.361831 | | 1.8662 | 0.86968 | | | 1.8662 | 1.4487 | | | 1.8662 | 2.3269 | |
| 20 | 3.881908 | | 2.48827 | 0.65226 | | | 2.48827 | 1.0865 | | | 2.48827 | 1.7451 | |
| 30 | 4.754347 | | 3.7324 | 0.43484 | | | 3.7324 | 0.72435 | | | 3.7324 | 1.1634 | |
| 40 | 5.489847 | | 4.97653 | 0.32613 | | | 4.97653 | 0.54326 | | | 4.97653 | 0.87257 | |
| 50 | 6.137836 | | 6.22067 | 0.26090 | | | 6.22067 | 0.434614 | | | 6.22067 | 0.69806 | |
| 60 | 6.723663 | | 7.4648 | 0.21742 | | | 7.4648 | 0.36217 | | | 7.4648 | 0.58171 | |
| 80 | 7.763817 | | 9.95306 | 0.16307 | | | 9.95306 | 0.27163 | | | 9.95306 | 0.43628 | |

multiphoton resonances destroying the selectivity. Moreover, the application of a powerful dissociating beam cannot distinguish between the ground levels and the excited levels of the lower states of the two isotopes. Selectivity is lost before substantial numbers of the molecules of the desired isotope are elevated to its higher states. Any resonances with the higher levels, starting from whichever level, destroy selectivity as the molecules are being diffused within the quasicontinuum of energy states.

Similar calculations have been performed for the SF₆, the MoF₆ and the PuF₆ molecules and the results were tabulated. It was found that in the case of the SF₆ molecule even at intensities as high as 100×10⁹ W/m² (electric fields of up to 8.5×10⁶ V/m) inequality (31) easily holds up to the seventh energy excitation state. Under these conditions the quasicontinuum of energy states starts at the seventh or eighth excited energy state. With the absorbed energy staying within one single vibrational mode up to the seventh energy excitation state it is much easier to preserve selectivity up the ν₃-mode vibrational ladder of the SF₆ molecules and thereafter drive them to their dissociation limit. The detailed results are outside the scope of the present account.

Experimental results on the number of photons absorbed per molecule as a function of fluence for widely different pumping pulse lengths but the same energy are available in the literature [Yablonovitch E., in the ‘The Significance of Nonlinearity in the Natural Sciences’, edited by A. Perlmutter and L. Scott, Plenum Press, New York and London, pp. 207-226, (1977)]. Simple considerations on the statistical properties of the quasicontinuum, in connection with the available experimental results can reveal the approximate values of the temperature of the molecules and the approximate interaction rate with it. On considering the quasicontinuum of the vibrational ladder to be analogous to a statistical distribution of energy states, the average rate of interaction Rin can be considered to be given by the Arrhenius equation

$${R}_{int} = {ω}_{qu} exp ( - \frac{{n}_{qu} {d}_{f}}{{〈 n 〉}_{qu}} ) ≡ {ω}_{qu} exp ( - \frac{{k}_{B} T}{} ) \qquad ( 32 )$$

where η_{qu} is the minimum number of photons needed for dissociation from the start of the quasicontinuum onwards with η being the minimum number of photons needed for dissociation from the ground state defined by [symbol] =ηℏω. The quantity [symbol] is the average number of photons actually absorbed by the molecule in the quasicontinuum and de is the number of vibrational degrees of freedom which for the hexafluorides is d_{f}=15. [symbol] =η_{qu}ℏω_{qu}, is the energy absorbed by the molecule from the start of the quasicontinuum onwards and ω_{qu} is an average vibrational frequency. The temperature of the molecule is then given by

$${k}_{B} T = \frac{{〈 n 〉}_{qu} {ℏω}_{qu}}{{d}_{f}} \qquad ( 33 )$$

This is the temperature attained by an incoherently driven oscillator and eq. (33) is justified if the rate of intramolecular vibrational relaxation is faster than the rate of absorption of photons. Absorption cross section measurements confirm that the rate of photon absorption is indeed slower than the intramolecular vibrational times in polyatomic molecules.

For transitions in the quasicontinuum only the energy density, not the peak power, is important. A comparison of the dissociation yield for pulses of various durations but fixed energy, indicated that for a 200-fold increase in peak power the fraction of molecules dissociated increased only by 30%. This demonstrated that absorption of radiation in the quasicontinuum is more important to dissociation than the ‘anharmonicity bottleneck’ in the discrete levels. On applying eqs. (32) and (33) to the results of quantitative experiments on the absorption of photons per pulse as a function of energy fluence we were able to calculate the approximate values of the temperature of the molecules and the approximate interaction rate with the quasicontinuum of energy states. The results for the UF₆ and the SF₆ molecule are summarized in Table 14. All the results pertain to the cases for a near unity probability of the dissociation yield through the quasicontinuum of energy states, which is the minimum flux (J/m²) through the quasicontinuum required for the dissociation of the molecule i.e. Rᵢₙₜ=R_{diss}, with R_{diss}(s⁻¹) being the minimum dissociation rate. At higher pumping fluxes the interaction rate with the states of the quasicontinuum Rᵢₙₜ>R_{diss} (s⁻¹) increases because the rate of the number of photons absorbed increases drastically due to heating of the molecule. The values calculated in the last two columns correspond to the two expressions for the Rᵢₙₜ given in eq. (32). The two expressions give close values in both cases, for the heavier UF₆ molecule as well as for the much lighter SF₆ molecule.

TABLE 14
Temperature and dissociation rate through the quasicontinuum of energy states for the SF₆, and UF₆ molecules

| | | | | ω_{qu} × | | | [symbol] = | | | | | | | |
|---|---|---|---|---|---|---|---|---|---|---|---|---|---|---|
| | [symbol] × | | | 10¹⁴ s⁻¹ | ℏω_{qu} × | 7ℏω_{qu} × | [symbol] − 7ℏω_{qu} × | | | | k_{B}T × | T | R [symbol] (η_{qu}) × | R [symbol] ( [symbol] ) × |
| Molecule | 10⁻¹⁹ J | η | [symbol] | (ν̅_{qu} [symbol] cm⁻¹) | 10⁻²⁰ J | 10⁻²⁰ J | 10⁻¹⁹ J | η_{qu} | [symbol] _{qu} | d_{f} | 10⁻²⁰ J | ° K | 10⁹ s⁻¹ | 10⁹ s⁻¹ |
| SF₆ | 6.39616 | 34 | 48 | 1.7774136 | 1.87441 | 13.12087 | 5.08406909 | 27 | 31 | 15 | 3.873781 | ~2805.8 | ~0.37633 | ~0.35448 |
| | | | | (943.6) | | | | | | | | | | |
| | | | | ω_{qu} × | | | [symbol] = | | | | | | | |
| | [symbol] × | | | 10¹⁴ s⁻¹ | ℏω_{qu} × | 4ℏω_{qu} × | [symbol] − 4ℏω_{qu} × | | | | k_{B}T × | T | R [symbol] (η_{qu}) × | R [symbol] ( [symbol] ) × |
| Molecule | 10⁻¹⁹ J | η | [symbol] | (ν̅_{qu} [symbol] cm⁻¹) | 10⁻²⁰ J | 10⁻²⁰ J | 10⁻¹⁹ J | η_{qu} | [symbol] _{qu} | d_{f} | 10⁻²⁰ J | ° K | 10⁹ s⁻¹ | 10⁹ s⁻¹ |
| UF₆ | 4.72759 | 38 | 55 | 1.174777 | 1.238886 | 4.955546 | 4.23203843 | 34 | 44 | 15 | 3.634067 | ~2632.1 | ~1.08665 | ~1.02895 |
| | | | | (623.67) | | | | | | | | | | |

[symbol]

indicates data missing or illegible when filed

From Table 14 we observe that: (a) the molecular temperature attained for a near unity probability of the dissociation yield for the SE, molecule is greater than for the UF₆ molecule as a result of the lower density of vibrational states in the quasicontinuum requiring much higher fluences for dissociation to occur. (b) the interaction rate Kit through the quasicontinuum for the UF₆ molecule (˜1.0866×10⁹ s⁻¹) is much greater than the one for the SF₆ molecule (˜0.375×10⁹ s⁻¹). This is the result of the much higher density of states in the quasicontinuum for the UF₆ molecule. It is the transition rate through the entire quasicontinuum resulting in the dissociation of the molecule. (c) The transition rate through the quasicontinuum of energy states of the UF₆ molecule resulting in its dissociation (1.08665×10⁹ s⁻¹) is lower than the equivalent two-level transition rate at a pumping intensity as low as 0.5×10⁹ W/m² (see eq. 18). The intensities used in isotope separation experiments are greater than this value and the driving of the molecules through the quasicontinuum of energy states can readily occur.

More photons are actually absorbed in the quasicontinuum than the number necessary for dissociation to occur and subsequently many more photons take part in the interaction process with the quasicontinuum region. From eq. (33) we can calculate the corresponding quasicontinuum temperature T for any number of photons [symbol] higher than the minimum number of photons necessary for dissociation. The temperature T will be proportional to the number of photons [symbol] taking part in the interaction with the quasicontinuum region. Using the values of the dissociation energy [symbol] absorbed by the molecule from the start of the quasicontinuum onwards (Table 14) we can plot the interaction rate Ri given by eq. (32) against the number of photons taking part in the interaction within the quasicontinuum region [symbol] , or against its power

$${( {〈 n 〉}_{qu} )}^{\frac{3}{2}} .$$

At pumping fluxes much higher than those necessary for near unity probability of dissociation, the interaction rate Rim increases, but the rate of the number of photons absorbed by the molecule in the quasicontinuum also increases drastically due to further heating of the molecule. The results for the Uranium Hexafluoride molecule (UF₆) are shown in FIG. 5(a), (b): (a) The number of photons

$${( {〈 n 〉}_{qu} )}^{\frac{3}{2}}$$

interacting with the quasicontinuum of states is proportional to the interaction rate Rᵢₙₜ when the number of absorbed photons is 170< [symbol] <255; (b) The number of photons [symbol] interacting with the quasicontinuum of states is found not to be proportional to the interaction rate Rᵢₙₜ within the same range of absorbed photons. The broken vertical lines on both graphs correspond to an applied number of photons of approximately 170 and 255 interacting with the quasicontinuum

$${R}_{int} ∝ {( {〈 n 〉}_{qu} )}^{\frac{3}{2}} .$$

Since the interaction rate is proportional to the fluence of the pumping beam i.e. Rᵢₙₜ∝φ_{IR}, then

$${φ}_{IR} ∝ {( {〈 n 〉}_{qu} )}^{\frac{3}{2}}$$

resulting in

$${〈 n 〉}_{qu} ∝ {( {φ}_{IR} )}^{\frac{2}{3}} [ i . e . σ ∝ {( {φ}_{IR} )}^{- \frac{1}{3}} ] .$$

This is the result which has been obtained theoretically and experimentally by Okada Y. et al (Journal of Nuclear Science and Tech., Vol. 30, pp. 762-767, August 1993) valid for pumping fluences between 0.1×10³ J/m² and 3×10³ J/m². These are the relations which had previously been derived theoretically by Judd O. P. (J, Chem. Phys., Vol. 71, No 11, pp. 4515-4530 December 1979) for a number of polyatomic molecules. We have obtained similar results for the SF₆ molecule with the

$${( {〈 n 〉}_{qu} )}^{\frac{3}{2}}$$

dependency of the fluence starting at a lower value for the interacting photons (˜120 instead of 170 for the UF₆ molecule) as a result of the fact that, at the intensities considered, the quasicontinuum of energy states starts at a much higher state (7^{th} or 8th) and the density of energy states is much smaller in the quasicontinuum of the SF₆ molecule. In general the relations are more pronounced for the heavier polyatomic molecules.

As previously pointed out above Alexander et al have obtained experimentally that at lower pumping fluences, between 0.1 J/m² and 0.1×10³ J/m², the fluence is proportional to the square of the number of interacting photons in the quasicontinuum, i.e. (, φ_{IR}∝ [symbol] (see FIG. 2). We have followed a similar procedure to the one described above using eqs. (32) and (33) and plotted the interaction rate in the quasicontinuum of energy states of the UF₆ molecule against the square of the number of interacting photons. The results indicate again that the interaction rate Rᵢₙₜ is proportional to the square of the number of interacting photons [symbol] in the interval 135< [symbol] <185. This again is in perfect agreement with the experimental results.

For the UF₆ molecules the experimental results and observations indicate three distinct intervals for the magnitude of the pumping fluence where the interaction follows specific trends: (a) At low fluences the absorption process is independent of the fluence; (b) For a pumping fluence in the interval between 0.1 J/m² and 0.1×10³ J/m² it is proportional to the square of the number of interacting photons in the quasicontinuum, i.e. φ_{IR}∝ [symbol] (see FIG. 2); (c) For higher pumping fluences in the interval between 0.1×10³ J/m² and 3×10³ J/m² it is proportional to

$${φ}_{IR} ∝ {( {〈 n 〉}_{qu} )}^{\frac{3}{2}} .$$

Thus, on the basis of a simple statistical analysis of the interaction of the electromagnetic beam with the quasicontinuum of energy states during the dissociation process we have demonstrated that these experimental results and observations reported in the literature hold true and are readily explainable. Furthermore, we demonstrated that the number of interacting photons where the law φ_{IR}∝ [symbol] holds is between 135< [symbol] <185. The number of interacting photons with the quasicontinuum of states where the law

$${φ}_{IR} ∝ {( {〈 n 〉}_{qu} )}^{\frac{3}{2}}$$

holds is between 170< [symbol] <255. No further analysis on this subject of the quasicontinuum of energy states in the hexafluoride molecules will be presented here. The important point of the above analysis with regard to the isotope separation process is that once high selectivity of the desired isotope is achieved in the distinct energy level section of the ν₃-vibrational ladder of the UF₆ molecule it is easy to drive the selectively excited molecules to dissociation through the quasicontinuum of energy states by suitably adjusting the intensity, fluence and frequency of the dissociating beam.

We have carried out complete analyses of all the above aspects of the ν₃-vibrational mode of the hexafluorides. The vibrational amplitudes of the various nuclei have been drawn to scale, in units of

$$a \cdot m \cdot {u}^{- 1 / 2}$$

[Aldridge et al, Journal of Chemical Physics, Vol. 83(1), pp. 34-48, (1985)] so as to avoid the frequency dependence and have a direct comparison of the amplitudes. A comparison between those of the heavy and the lighter hesafluorides has been made. On all occasions the experimental results for the ν₃-vibrational mode of the heavy hexafluorides are in perfect agreement with the theoretical expressions given above. By comparing the well established experimental values for the UF₆ molecule (a heavy hexafluoride) with those of the SF₆ molecule (the lightest of the hexafluorides) and using the above analyses it was possible to obtain very good values for the parameters of all the other hexaflorides. These are outside the scope of the present account.

We very briefly summarize the basic conclusions which were obtained from the above analysis for the ν₃-vibrational mode of the hexafluoride molecules. These corroborate that on the basis of all the available experimental results and their close agreement to the theoretical analysis developed, the lower levels of the vibrational ladder of the heavy hexafluoride molecules, and in particular of the UF₆ molecule, are a very close match in their behaviour to those of an ideal harmonic oscillator: (1) The vibration of the ν₃-mode of the heavy hexafluorides, and in particular of the UF₆ molecule, is very close to that of an ideal harmonic oscillator. Its vibrational constants can be determined from an analysis of the Schrödinger equation through the use of the Morse potential and its equivalence to that of a diatomic molecule, to a very high degree of accuracy (Table 1); (ii) The anharmonic vibrational constant X₃₃ of the heavy hexafluorides is very close to the anharmonicity constant (⅙)λ̅ₑxₑ, calculated through the Schrödinger equation and the Morse potential (FIG. 1); (iii) Resonance at the fundamental is vital to the absorption process up the whole vibrational ladder with simultaneous resonances between the ground state and all higher levels (three-photon absorption resonance theory); (iv) By imposing the frequency conditions it is possible to obtain all the constants of the vibrational ladder of the hexafluorides to a very high degree of accuracy (Table 1); (v) The dipole moments of heavy hexafluorides, and in particular that of the UF₆ molecule, obtained using the experimentally measured vibrational band strengths (eq. 12), are extremely close to those calculated from elementary quantum mechanical principles for the dipole moment in terms of the vibrating frequency ωₖ of a harmonic oscillator model and the three fundamental physical constants e, m and ℏ (eq. 19); (vi) The experimentally measured value of the spontaneous lifetime of the first excited level of the ν₃-vibrational mode of the UF₆ molecule is found to be extremely close to that calculated from an elementary expression for the spontaneous lifetime of the fundamental transition of a harmonic oscillator which depends only on the inverse of the square of the frequency and the fundamental physical constants (eq. 20). (vii) The measured absorption cross section at the fundamental of the ν₃-vibrational mode of the UF₆ molecule using an infrared spectrophotometer with very low probing intensities (1.155×10⁻²⁰ m²), is very close to the calculated value of the absorption cross section of the fundamental of an ideal harmonic oscillator (1.258×10⁻²⁰ m²) (eq. (23) and FIG. 2); (vii) The quasicontinuum of energy states in lighter hexafluorides starts at higher vibrational levels than for the heavier hexafluorides for the same pumping intensities and the molecular temperature attained for the lighter hexafluoride molecules is much higher than for the heavier hexafluoride molecules (Table 13); (ix) The interaction rate through the quasicontinuum of the heavier hexafluoride molecules (Rᵢₙₜ˜1.08665×10⁹ s⁻¹ for the UF₆ molecule) is much greater than the one for the lighter hexafluoride molecules (Rᵢₙₜ˜0.37633×10⁹ s⁻¹ for the SF₆ molecule) providing an easier elevation of the heavy molecules to dissociation through the quasicontinuum of energy states (Table 14); (x) The vibrational band strength in the case of an ideal harmonic oscillator depends only on two standard physical constants, Avogadro's number and the classical radius of the electron giving an extremely close value to the experimentally measured value for the vibrational band strength of the ²³⁸UF₆ molecule (Sₒ=703.3503114 km mole⁻¹); (xi) The size of the manifold structures of the vibrational levels for the hexafluorides as a function of the square of the vibrational quantum number indicate that the resulting graphs are extremely close to a straight line as required by theory. The widths of the vibrational manifolds for the various hexafluorides varies according to their weight and the vibrational anharmonicity constant X₃₃, indicating an extreme closeness of the vibration of the lower vibrational levels to that of a harmonic oscillator. Thus, we have established that the vibration of the lower levels of the ν₃-mode molecular vibrational ladder of the UF₆ molecule is a very close match in its behaviour to that of an ideal harmonic oscillator. Subsequently, we can proceed to use its properties and exploit schemes for the molecular isotope separation of the UF₆ molecule.

The population of the ground level as a function of temperature is a very important factor in the molecular laser isotope separation process. Following the procedure by Erkens [Erkens J. W., Applied Physics, Vol. 10, pp. 15-31, (1976)] we have calculated the population probabilities of the hot states of the UF₆ gas at various temperatures and for the various energy excitation levels. By using the appropriate frequencies of the fundamentals of the vibrational modes of the UF₆ molecule at various temperatures (gathered from various references) we also calculated the vibrational partition function at various temperatures. Our results, which we have tabulated, are in perfect agreement with those of the above reference but are outside the scope of the present account.

The population probability of the ground state is characterized by υₒ=0 giving a statistical weight of wₒ=υₒ+1=1. Subsequently, the population probability of the ground state is

$${p}_{ground} = \frac{1}{\text{?}} ( \text{?} ) = \frac{1}{\text{?}} \qquad ( 34 )$$

$$\text{?} \text{indicates text missing or illegible when filed}$$

from which we have obtained the population probabilities of the ground state of UF₆ at various temperatures using the corresponding values of the vibrational partition function Z_{υ}. The results have been tabulated giving the Population probabilities of the ground level p_{ground} of the UF₆ gas at various temperatures together with the corresponding values of the Partition Function. They are fully compatible with those in the literature. The results are plotted in FIG. 6 where the variation of the population of the UF₆ gas in the ground state as a function of temperature is plotted. It is evident that for temperatures greater than 100° K, less than 40% of the UF₆ molecules are in the ground state. Most of the UF₆ molecular population lies in other higher vibrational states. If the cooling of the UF₆ molecular gas is not below 100° K many of the higher vibrational levels, of the desired and the unwanted isotopes, will hold most of the molecular population at the time of the interaction process with a dissociating laser. The powerful dissociating laser frequency will not be able to distinguish between these molecules and the molecules which had been selectively excited at the fundamental frequency of the ν₃-vibrational mode. It is thus clear that the temperature of the molecular gas must be less than a 100° K, and preferably much lower, around 60° K to 70%° so that the vast majority of molecules are in the ground state during the interaction process. The drastic change in the percentage of the molecules of the ground state population of the UF₆ gas from 85% ²³⁵UF₆ molecules at a temperature of 60° K to 30% ²³⁸UF₆ molecules at a temperature of 110° K has been overlooked in all the hitherto applications of the MLIS process in prototype experiments. The importance of the expansion supercooling process for application to laser isotope separation systems is evident. This fact has hitherto been overlooked or given very little attention.

The primary dissociation of the UF₆ molecules occurs via the following schemes:

$$\begin{matrix}{}^{235} {UF}_{6} {\to }^{n h v} {}^{235} {UF}_{5} + F & {}^{238} {UF}_{6} {\to }^{n h v} {}^{238} {UF}_{5} + F\end{matrix} \qquad ( 35 )$$

Dissociation experiments indicated that the reverse reactions i.e. the recombination of UF₅ with the F atoms yielding UF₆ parent molecules (UF₅+F→UF₆) occurs significantly in the reaction system. An upper limit for the rate constant of the reverse reactions has been experimentally found to be kᵣ<2.0×10⁻¹² cm³ molecule⁻¹ s⁻¹ [Lyman J. L. et al, Journal of Chemical Physics, Vol. 82, No 1, pp. 175-182, (January 1985)]. Thus, a scavenger gas should be used which reacts rapidly with the F-atoms and yet does not produce any species which could be reactive towards the parent UF₆ molecules. The intrinsic separation factor S effected by radical reaction has been shown to be [Kato S. et al, Journal of Nuclear Science and Technology, Vol. 26, No 2, pp. 256-260, (February 1989)]

$$S = 1 + \frac{α}{1 + η} \leq {S}^{′} \qquad ( 36 )$$

where S′=1+a with α≥1 is the primary separation factor for eqs. (35), independent of the scavenger gas, and 0≤η≤1 is the fraction of radicals R_{ad} which react non-selectively with parent UF₆ molecules. Eq. (36) is valid under the condition [²³⁵UF₆]<<[²³⁸UF₆]. Experiments with H₂, C₂H₆ and CH₄ as scavenger gases have resulted in the following values for η:H₂:η˜0.56 (S′ deterioration ˜30%); C₂H₆: η˜0.85 (S′ deterioration ˜38%); CH₄: η˜0.07 (S′ deterioration ˜5%). The very small value of η indicates that CH₃ radicals hardly deteriorate the primary separation factor. Thus, Methane hardly causes any detrimental radical reactions to lower the separation factor in UF₆ laser isotope experiments and it is considered to be the most suitable scavenger gas. It is stable, has no infrared absorption at 16 μm, has relatively high vapour pressure at low temperatures, even below 100° K, and has high heat capacity ratio.

Uranium Hexafluoride has the highest vapour pressure of all known Uranium compounds. Simple calculations indicate that in order to achieve very low temperatures without condensation of the Uranium Hexafluoride gas it is necessary to have extremely low pressures i.e. very few UF₆ gas molecules. Supersonic expansion processes have been devised in order to achieve spectroscopically acceptable temperatures with sufficient UF₆ molecules for interaction. The cooling attainable by an adiabatically expanded working gas through a supersonic jet stream is determined by the ratio of pressures on both sides of the nozzle and also by the ratio of specific heats γ=c_{P}/c_{ν}. Using available experimental data and expressions for the specific heats of the UF₆ derived from thermodynamic functions we have obtained the values of c_{P} and γ as a function of temperature. By using a carrier gas which is a mixture of a monatomic gas with γ=1.67 (for example Ar) and a diatomic gas with γ=1.4 (for example N₂) we can obtain an effective γ=1.58 which is as near as the highest value possible to avoid any practically inherent condensation problems. The gas equation governing the adiabatic expansion is

$$\frac{T}{{T}_{o}} = \frac{P}{{P}_{o}} {J}^{\frac{γ - 1}{γ}} = {( \frac{ρ}{{ρ}_{o}} )}^{γ - 1} \qquad ( 37 )$$

where Tₒ, Pₒ, ρₒ and Vₒ are the initial temperature, pressure, density and volume of the gas respectively, and T, P, ρ, and V are their corresponding values attained after adiabatic expansion through the supersonic nozzle. The introduction of a carrier gas in the expansion flow process facilitates substantial cooling of the gas with only modest initial pressure and nozzle area expansion ratios, and a collisional environment which ensures continuum fluid flow and thermal equilibrium among the vibrational, rotational and translational degrees of freedom of the UF₆ before irradiation. FIG. 7 depicts a gas dynamic expansion through a two dimensional nozzle, having a slit throat. The gas is pulsed through a pipe constriction towards a long thin slit. The slit runs perpendicular to the plane of the paper. The expansion occurs very rapidly within a short distance from the slit throat. High Mach numbers can be achieved in a uniform flow region of the central core, bounded on each side by thin boundary layers. The small circle after the slit represents the region of a uniform high gas density where the laser beams must be applied. This is usually very close to the slit. Hyperbolic, laval or any other nozzle geometry enables the gas to retain all its fluid properties in the collision dominated regime. The mixture of UF₆, the scavenging gas and the inert gases is introduced into a loop of known volume composed of a series of compressors designed for the use of UF₆. The duration of continuous supersonic flow is set by the volume of the damp tank. A valve actuated at an appropriate repetition rate provides a fully supersonic flow of cooled gas lasting for several milliseconds per pulse at the exit nozzle. After enrichment the dissociated UF₅ molecules rapidly form dimers and the scavenger gas makes them relatively immune to the exchange of fluorine atoms with the UF₆. The enriched product is collected by the passage of the gas through a sonic impactor. More details on the design of the expansion nozzle are outside the scope of the present account but more elaborate relations for the supersonic gas expansion can be found in recently published scientific literature, Table 15 lists some experimental and estimated values of the vibrational relaxation times causing de-excitation of the UP, molecules as a consequence of collisions with the inert gas which have been recorded in the literature. These values refer to the average de-excitation time of the molecules in all the excited levels including transfer of energy to the levels of other vibrational modes of the molecule. This last point is one of the reasons why the effectiveness of ultraviolet dissociation of the UF₆ molecules is limited. The vibrational relaxation times decrease roughly in proportion with the temperature. One important result was the measurement of the collisional de-excitation times of the vibrational energy in UF₆: P τ_{c} (UF₆-UF₆)=0.5 μs·Torr and

TABLE 15
The vibrational relaxation times of UF₆ gas mixtures with
scavenger and inert gases at various temperatures

| | | Vibrational |
|---|---|---|
| | | relaxation |
| | Temperature | (P_{gas} · τ_{c}) |
| Gas Mixture | ° K | (μs · Torr) |
| UF₆:H₂:Ar (measured) | 300 | 2.9 |
| UF₆:H₂:Ar (measured) | 90 | 0.85 |
| UF₆:H₂:Ar (estimated) | 60 | ~0.57 |
| UF₆:H₂:N₂ (measured) | 105 | 2.5 |
| UF₆:H₂:N₂ (estimated) | 60 | ~1.43 |

TABLE 16
The vibrational relaxation times of UF₆ gas and
a mixture with He for various temperatures

| | | Vibrational |
|---|---|---|
| | | relaxation times |
| | Temperature | (P_{gas} · τ_{c}) |
| Gas Mixture | ° K | μs · Torr |
| UF₆ (measured) | 300 | 0.5 |
| UF₆ (estimated) | 60 | ~0.1 |
| UF₆:He (measured) | 300 | 1.5 |
| UF₆:He (estimated) | 60 | ~0.3 |

P τ_{c} (UF₆-He)=1.5 μs·Torr [Alimpiev S. S. et al., Soviet Journal of Quantum Electronics, Vol. 11, No 3, pp. 375-379, (March 1981)]. All measurements were made at a temperature of 300° K. On assuming a rough proportionality relation with temperature the corresponding values at 60° K. were estimated. Table 16 lists the experimental results obtained and the values estimated at 60° K. Nearly all the experimental results we have searched are consistent with the measurements listed in Tables 15 and 16.

In most of the experiments described in the literature molecular gas velocities of 450 m/s to 500 m/s have been reported after expansion supercooling through the nozzle. Typical expansion supercooled mixtures consisted of a combination of the inert gases kr, Ar and/or N₂ together with the scavenger gas CH₄ in the following proportions: Basic gas: UF₆ (0.1%-1%); Scavenger gas: CH₄ (0.5%-5%); Inert carrier gas: Kr, Ar and/or N₂ (94%-99%) [see for example, Takeuchi K. et al., Journal of Nuclear Science and Technology, Vol. 26, No 2, pp 301-303, (February 1989)]. Three possible combinations within the above percentages would be: 1) UF₆: 0.1%, CH₄: 0.9%, Inert gas: 99%; 2) UF₆: 0.5%, CH₄: 2.5%, Inert gas: 97%; 3) UF₆: 1%, CH₄: 4%, Inert gas: 95%. The range over which the UF₆ partial pressures in gas mixtures has been reported in expansion supercooling experiments at temperatures below 100% is usually of the order of: (0.3-2.0) Torr.

By applying eq. (37) to a gas having the proportions of its constituents mentioned above we have evaluated the parameters of the expansion supercooled gas for a number of cases at a temperature of 60° K. The results are summarized in Table 17. Note that the final UF₆ densities

TABLE 17
Expansion supercooling of a mixture of gases containing UF₆ in various percentages
from an initial room temperature of 300° K to a final temperature of 60° K

| | | | Initial | | | Final | Final |
|---|---|---|---|---|---|---|---|
| | Initial | Initial | density | Final | Final | density | Density |
| | Pressure | Temperature | ρₒ | Pressure | Temperature | ρ | of UF₆ |
| Composition | Pₒ | Tₒ | Molecules/m³ × | P | T | Molecules/m³ × | Molecules/m³ × |
| of gas mixture | Torr | ° K | 10²⁴ | Torr | ° K | 10²⁴ | 10²¹ |
| UF₆: 0.1% | 50 | 300 | 1.6085 | 0.62356 | 60 | 0.1003 | 0.1003 |
| CH₄: 0.9% | 250 | 300 | 8.0425 | 3.11781 | 60 | 0.5015 | 0.5015 |
| Inert gas: 99% | 500 | 300 | 16.086 | 6.23562 | 60 | 1.003 | 1.003 |
| | 1000 | 300 | 32.175 | 12.47123 | 60 | 2.006 | 2.006 |
| | 2500 | 300 | 80.438 | 311.78076 | 60 | 5.015 | 5.015 |
| UF₆: 0.5% | 10 | 300 | 0.3217 | 0.1247 | 60 | 0.02006 | 0.1003 |
| CH₄: 2.5% | 50 | 300 | 1.6085 | 0.62356 | 60 | 0.1003 | 0.5015 |
| Inert gas: 97% | 100 | 300 | 3.217 | 1.24712 | 60 | 0.200 | 1.003 |
| | 200 | 300 | 6.435 | 2.49425 | 60 | 0.401 | 2.006 |
| | 500 | 300 | 16.086 | 6.23561 | 60 | 1.003 | 5.015 |
| UF₆: 1% | 5 | 300 | 0.16085 | 0.062356 | 60 | 0.01003 | 0.1003 |
| CH₄: 4% | 25 | 300 | 0.80425 | 0.311781 | 60 | 0.05015 | 0.5015 |
| Inert gas: 95% | 50 | 300 | 1.608 | 0.62356 | 60 | 0.1003 | 1.003 |
| | 100 | 300 | 3.217 | 1.24712 | 60 | 0.20063 | 2.006 |
| | 250 | 300 | 8.043 | 3.11781 | 60 | 0.50158 | 5.015 |

in the table are in the range where it has been claimed they were achieved experimentally. From Table 15 the vibrational de-excitation times for collisions in the gas mixture of the UF₆ with inert gases at 60° K ranges from P τ_{c} (UF₆:H₂:Ar)=˜0.6 μs·Torr to P τ_{c} (UF₆:H₂: Na)=˜1.4 μs·Torr. This means that for laser pulses of up to 100×10⁻⁹ s collisional de-excitation of the vibrational energy during the interaction process is completely avoided. Furthermore, from Table 16 the vibrational de-excitation times for collisions between UF₆ molecules at T=60° K is P τ_{c} (UF₆-UF₆)˜0.1 μs·Torr. The

TABLE 18
Densities of the expansion supercooled
UF₆ gas in the ground state at 60° K

| | | Final Density |
|---|---|---|
| | Final Density | of UF₆ in the |
| Final density | of UF₆ | ground state |
| ρ | ρ_{UF6} | (ρ_{UF6})_{gr} |
| Molecules/ | Molecules/ | Molecules/ |
| m³ × 10²¹ | m³ × 10²¹ | m³ × 10²¹ |
| 0.01003 | 0.1003 | 0.0857 |
| 0.05015 | 0.5015 | 0.4286 |
| 0.1003 | 1.003 | 0.857 |
| 0.20063 | 2.006 | 1.715 |
| 0.50158 | 5.015 | 4.286 |

UF₆ partial pressure in the final gas is ˜1.247×0.01=0.01247 Torr. This means that the average time between collisions is 0.1/0.01247=8.02 μs which is a very long time compared to the duration of a laser pulse. The vibrational de-excitation due to this kind of collisions is far less important even for very long laser pulses, We have used the five values in Table 17 for the final gas density after expansion supercooling, which have been experimentally achieved without condensation occurring, to calculate the corresponding final densities of UF₆ in the ground state at 60° K. The corresponding values of the partition function have been used in the calculations. The values are tabulated in Table 18. It is not possible to list here more calculations and the conclusions from the extensive analysis which we have carried out.

Expansion nozzles over 1 m wide with depths (distance between the orifice and the skimmer top) ranging from 12 mm to 20 mm have already been operated successfully, resulting in the expansion supercooled UF₆ gas at T=60° K with the parameters shown in Table 18. The velocities of the expanded gas just after the slit were in the range υₑₓₚ≈5×10² m/s, By slightly varying the slit opening and changing the depth of the expansion nozzle (distance between the orifice and the skimmer top) in conjunction with the volume of the dump tank the parameters of the expansion supercooled gas can be kept unaltered, whilst changing the cross

TABLE 19
Values for the UF₆ gas densities after supersonic expansion at 60° K

| Density of the UF₆ | | Natural abundance | | Tails reprocessing (depleted Uranium) | |
|---|---|---|---|---|---|
| in the expanded gas | | ²³⁸UF₆ = 0.9929 ²³⁸UF₆ = 0.0071 | | ²³⁸UF₆ = 0.9975 ²³⁸UF₆ = 0.0025 | |
| | Final Density | Final Density | Final Density | Final Density | Final Density |
| Final Density | of UF₆ in the | of ²³⁸UF₆ in the | of ²³⁵UF₆ in the | of ²³⁸UF₆ in the | of ²³⁵UF₆ in the |
| of UF₆ | ground state | ground state | ground state | ground state | ground state |
| ρ_{UF}_{₆} | (ρ_{UF}_{₆})_{gr} | (ρ_{²³⁸}_{UF}_{₆})_{gr} | (ρ_{²³⁵}_{UF}_{₆})_{gr} | (ρ_{²³⁸}_{UF}_{₆})_{gr} | (ρ_{²³⁵}_{UF}_{₆})_{gr} |
| molecules/ | molecules/ | molecules/ | molecules/ | molecules/ | molecules/ |
| m³ × 10²¹ | m³ × 10²¹ | m³ × 10²¹ | m³ × 10¹⁹ | m³ × 10²¹ | m³ × 10¹⁹ |
| 0.1003 | 0.0857 | 0.0851 | 0.06085 | 0.085486 | 0.02143 |
| 0.5015 | 0.4286 | 0.42556 | 0.30431 | 0.42753 | 0.10715 |
| 1.003 | 0.857 | 0.851 | 0.6085 | 0.8548 | 0.2143 |
| 2.006 | 1.715 | 1.703 | 1.2177 | 1.7107 | 0.4287 |
| 5.015 | 4.286 | 4.256 | 3.0431 | 4.2753 | 1.0715 |

sectional area of the volume in which the gas density is uniform, at the values given in Table 18. The same amount of gas will go through this volume at different speeds. Calculations on the parameters of the expansion supercooled UF₆ gas in the irradiation area in a nozzle 1 m wide and cross sectional area 0.001 m² flowing with a velocity of 5×10² m/s have been carried out for the densities in Table 18. These are listed in Table 19 where the ²³⁸UF₆ and ²³⁵UF₆ densities in the expanded gas are shown for two different initial assays. The third and fourth columns list the values for the natural abundance of Uranium whilst the fifth and sixth columns list the values if depleted UF₆ was to be used in the expansion gas (Tails reprocessing). It is not, however possible to give a detailed analysis of the results here.

For the isotope separation of the UF₆ isotopes we must observe the following steps: (i) We must supercool the gas to temperatures much lower than 105° K, preferably around 60° K so that most molecules are in the ground state (greater than 85%, FIG. 6). Otherwise, absorption by molecules in the higher levels of the unwanted ²³⁸UF₆ isotope will take place having a detrimental effect on the selectivity of the process; (ii) We must aim at three-photon resonance with the third energy excitation level [m(A₂):(3ν₃)] of the desired isotope ²³⁵UF₆ i.e. pumping at a frequency of 628.527 cm⁻¹, making use of the power broadening of the first, second and third energy levels for achieving the excitation of the molecules to this level; (iii) The optimum frequencies for attaining maximum overall three-photon absorption selectivity to the third energy excitation level may range between 628.45 cm⁻¹ and 628.56 cm⁻¹ i.e. in the region of establishing three-photon resonance with the [m(A₂):(3ν₃)] sublevel; (iv) The intensity of the pumping beam must be limited to such levels that interaction with the quasicontinuum of energy states has no effect at the third energy level or thereafter (Table 13); (v) when pumping within the narrow frequency range capable of establishing three-photon resonance with the [m(A₂):(3ν₃)] sublevel the pumping intensity should not exceed 50×10⁹ W/m², otherwise the quasicontinuum of energy states could begin at the third energy level of the UF₆ molecule facilitating the escape of the molecules to other vibrational modes and background states, thereby having a detrimental effect on the selectivity process; (vi) Four-photon resonance with the fourth energy level must be avoided at all costs so that no transfer of energy to other vibrational modes can take place through the quasicontinuum of energy states. On summarizing all the aspects of the properties and interaction parameters described above and which we have fully scrutinized in order to arrive at the above six basic steps, we have: (a) The properties of the ν₃-mode vibrational levels are very close to those of a harmonic oscillator; (b) The intensity of the selecting pumping beam relevant to the beginning of the quasicontinuum of energy states must be carefully controlled within a certain range; (c) The detrimental effects of pumping the ²³⁵UF₆ molecules at the frequency of the fundamental transition at 628.306 cm⁻¹ have been analysed; (d) The collisions amongst the UF₆ molecules and with the carrier gas have been shown to be irrelevant for pumping pulses with duration below 80×10⁻⁹ s⁻¹ at the appropriate densities of the expansion supercooled gas for the MLIS process; (e) Restriction of the UF₆ molecules from moving into the quasicontinuum of energy levels and other background states by careful controlling of the pumping intensity and the frequency and intensity of the dissociating laser.

Following the results of the French experiments [Alexander et al, Journal de Chimie Physique, Vol. 80, No 4, pp 331-337, (1983)] all prototype systems have been operated with selecting frequencies at the fundamental of the desired ²³⁵UF₆ isotope or on the lower frequency side. It is however a misleading concept. As the pumping intensity is increased in order to excite higher numbers of molecules, selectivity is lost due to the fact that multiphoton resonances cannot distinguish between molecules in the ground state of the undesired isotope and molecules in the first excited state of the desired isotope. Furthermore, at high pumping intensities (>50×10⁹ W/m²) the quasicontinuum of energy states for the ²³⁵UF₆ molecule can set in at the third energy excitation state, thereby enabling the loss of excited molecules to other vibrational modes and background states (Table 13).

The method of simultaneously tackling the selectivity and dissociation process is conceptually wrong. Any good chess player knows that in order to launch an effective attack he will have to arrange his pieces in the right position beforehand. In an analogous way we first aim at selectively exciting as many molecules as possible to a particular state, from which they cannot immediately escape to other vibrational modes and background states (in the case of the UF₆ molecule the third energy excitation level [m(A₂):(3ν₃)]), giving sufficient time to a second beam, carefully chosen for its frequency and intensity, to drive them to dissociation. This is the object of the present process. The important factor in the selectivity process is to locate the intensity level at which direct three-photon resonance with the [m(A₂):(3ν₃)] sublevel is readily established whilst at the same time the absorption probability resonance at the first energy excitation level is not inhibited. If the pumping intensity is low, producing insufficient power broadening of the first energy excitation level which results in low absorption probability resonance at this level, then the setting up of direct three-photon resonance with the third energy level will be inhibited. The pumping intensity of the selecting beam must be high enough to produce sufficient power broadening at the fundamental, thus enabling the direct three-photon resonance with the [m(A₂):(3ν₃)] sublevel of the third energy excitation state (3ν₃) to be readily accessible. Moreover, the pumping pulses must have sufficient intensity for three photon resonance with the [m(A₂):(3ν₃)] sublevel to be established but at the same time the intensity must be restricted to levels below which the quasicontinuum of energy states will not set in at the third energy excitation level of the ²³⁵UF₆ isotope, thereby facilitating the escape of molecules to other vibrational modes and background states.

With regard to the frequency of the applied radiation we have drawn tables summarizing all the possible frequencies obtainable by stimulated rotational Raman scattering from a CO₂ laser in para-Hydrogen. We have also carried out calculations on the power broadening of the CO₂ laser necessary to obtain Raman frequency shifts to match those required for the present invention. Note that even a 2 arm CO₂ laser can suffice to cover all the required frequencies for the present invention. We also note that one can obtain frequencies near the required one from Raman shifting into the deuterium. Nowadays, however, there exist commercially available isotopic Carbon Dioxide Lasers [¹³C¹⁶O₂] and [¹²C¹⁸O₂] which could produce the required wavelength directly from a rotational line without the need of pressure broadening or other complicated modifications. For example, the P(38)[¹³C¹⁶O₂] at 982.912774 cm⁻¹ when shifted by the parahydrogen line at H₂[S(0)] at 354.275 cm⁻¹ will produce a shifted frequency at 628.5378 cm⁻¹ which is only 0.0108 cm⁻¹ from the three-photon resonance frequency with the [m(A₂):(3ν₃)] level of ²³⁵UF₆ at 628.527 cm⁻¹. The beam diameter of the applied beams can only be as large as they can comfortably cover a cross sectional area of the expanding gas with uniform density, at the maximum concentration numbers of UF₆ available without condensation (FIG. 7). Gaussian spatial profile beams in the interaction region have been used in several experimental works published with spot sizes ranging from 1 mm to 3.2 mm.

The conversion of CO₂ radiation through Raman scattering in para-Hydrogen using repetitive re-focusing in multipass Raman cells does not provide any flexibility in the control of the parameters of the applied beam. Pulses of duration approximately 75 ns are usually produced. The most suitable pulse duration for application to the present invention is between 10×10⁻⁹ s and 40×10⁻⁹ s. The correct way to produce controllable and flexible 16 μm pulses with the required intensity, mode profile and frequency control is through the proper construction and the cavity control of Raman oscillators. The design of such oscillators is now being effected.

A comparison and evaluation of the potentialities of the AVLIS and the MLIS processes has been carried out. It is not possible to present even a summary the extensive analysis here. There are two many engineering problems in the AVLIS process, both in laser technology and in the construction of the interaction systems due to the corrosive nature of atomic Uranium, as well as the fact that the feed material lies outside the fuel cycle rendering an immediate 30% increase in the cost of fuel production due to the conversion process (UF₆→Uₘₑₜₐₗ→UF₆). The problems associated with the MLIS process were specific mainly associated with the interaction process and those are solved with the present invention. It is evident that the AVLIS process was a non starter from the beginning and this is the reason why the MLIS process was deliberately suppressed in the USA as early as 1983. A brief account of the systematic and contradictory statements on the development of the AVLIS process was given as early as 1997 [Andreou D., Nuclear Engineering International, pp 36-39, May 1997]. It is outside the scope of the present account to analyse the deliberate manipulations in the development of the LIS processes here.

We have also carried out a comparison and evaluation analysis with the centrifuge process. The latter can never be anywhere near as efficient as the MLIS process and more important, it hardly has any prospect of improving its present efficiency. The recent disaster with the construction of the large American centrifuge was to be expected. It was not only the enormous engineering problems which had to be overcome in the construction of such enormous systems such as the strength-to-weight ratio of the rotor material, the tensile strength affecting the maximum peripheral speed, the lifetime of the bearings at either end of the rotor, the characteristic vibrations the long rotor experiences as it spins and so many others arising as the size of the centrifuge is increased. One should have realized from the beginning that the UF₆ gas has a very low self-diffusion coefficient D and any large increase in the size of the centrifuge will have an enormous effect on the circulation, movement and diffusion in the rotor. In all centrifuge equations the self-diffusion coefficient is the proportionality constant in the basic terms concerning both the axial variations and the radial variations in the gas [Cohen K., “The Theory of Isotope Separation as Applied to the Large-Scale Production of U²³⁵” Chapter 6: “Centrifuges”, pp 106-109, McGraw-Hill Book Company, (1951)]. The self-diffusion coefficient of the Uranium Hexafluoride at 288° K is Dur, =0.0428×10⁻⁴ m²/s. At 320° K it is D_{UF}_{₆}=0.053×10⁻⁴ m²/s. This is a very low self-diffusion coefficient affecting all the processes in the rotor. Compare this with that of Carbon dioxide at 288° K is Dco₂=0.121×10⁻⁴ m²/s.

Having set out the restrictions imposed on the selectivity process we now proceed to define the appropriate pumping frequencies and the applied pumping intensities with which we can attain the maximum selectivity for the ²³⁵UF₆ isotope. FIG. 8 (a) is indicative of the detrimental effect of pumping the ν₃-vibrational ladder of the UF₆ molecule at the frequency of the fundamental. The solid lines correspond to the power broadening of the energy levels of the desired isotope ²³⁵UF₆ and the broken line corresponds to the power broadening of the energy levels of the undesired isotope ²³⁸UF₆. The thick solid line running through all four graphs corresponds to the pumping frequency at the fundamental of the ²³⁵UF₆ isotope at 628.306 cm⁻¹. Its relation to the power broadened resonances of the first four energy levels of the ν₃-vibrational mode is clearly depicted. The graphs are plotted for a pumping intensity of 30×10⁹ W/m². Even at such high pumping intensities there can only be a limited three-photon resonance with the third energy level and very small discrimination between the three-photon resonances of the two isotopes. We have plotted similar graphs with intensities ranging from 5×10⁹ W/m² to 60×10⁹ W/m².

The conclusion is always that there is very small discrimination between the three-photon resonances of the two isotopes. This means that although one might distinguish and selectively excite the first energy level of the desired isotope it is not easy to drive the molecules to higher levels unless pumping them with very high intensity, but then they will escape into the quasicontinuum of energy states as it can be seen from Table 13. At the same time multiphoton resonance from the ground state of the undesired isotope will elevate the molecules to the quasicontinuum of energy states, and the molecules of the two isotopes will be fully intermixed, making it very difficult to subsequently dissociate them selectively.

FIG. 8 (b) shows the relations of the first four power broadened levels of the UF₆ molecule to the pumping frequency for three-photon resonance with the [m(A₂):(3ν₃)] sublevel of the third energy state of the ²³⁵UF₆ isotope at 628.527 cm⁻¹ at a pumping intensity of 30×10⁹ W/m², as described in the present invention. The solid line curves correspond to the power broadening of the energy levels of the desired isotope ²³⁵UF₆ and the broken line curves correspond to the power broadening of the energy levels of the undesired isotope ²³⁸UF₆. The thick solid line running through all four graphs corresponds to the pumping frequency for three-photon resonance with the third energy level of the ²³⁵UF₆ isotope at 628.527 cm⁻¹, and its relation to the power broadened resonances of the other levels is depicted. We have plotted similar graphs with intensities ranging from 5×10⁹ W/m² to 60×10⁹ W/m² and for beams with frequencies ranging from 628.45 cm⁻¹ to 628.56 cm⁻¹. As the pumping intensity is increased the resonance conditions at the first and second energy excitation states improve and the three-photon absorption to the third energy level is readily enhanced. Even at high pumping intensities the levels of the undesired isotope ²³⁸UF₆ remain largely unexcited with the population of the third level of the desired isotope ²³⁵UF₆ being selectively populated. The high pumping intensities must be limited to levels below which the quasicontinuum of energy states does not acquire importance and detrimental effects to the absorption and dissociation processes cannot set in (Table 13). From Table 5(a) note that the molecules are elevated to the third energy state sublevel [m(A₂):(3ν₃)] via the pathway

$$[ m ( {A}_{1} ) : ( 0 {v}_{3} ) ] ( l = 0 ) \to [ m ( {F}_{1} ) : ( 1 {v}_{3} ) ] ( l = 1 ) \to [ m ( {F}_{2} ) : ( 2 {v}_{3} ) ] ( l = 2 ) \to [ m ( {A}_{2} ) : ( 3 {v}_{3} ) ] ( l = 3 )$$

with the quantum transition rule Δl=±1 being perfectly satisfied. A comparison of FIG. 8(a) with FIG. 8(b) demonstrates the enormous difference in selectively elevating the molecules of the desired isotope ²³⁵UF₆ to the third energy excitation level when pumping at the three-photon resonance frequency of 628.527 cm⁻¹ as compared with pumping at the frequency of the fundamental at 628.306 cm⁻¹. We have also plotted in more detail the power broadening of the individual levels as the intensity of the pumping beam increases showing the relation of the various pumping frequencies near 628.257 cm⁻¹ to the power broadened level. Furthermore we have tabulated the ν₃-vibrational transitions of the lower five levels and their deviations from exact multiphoton absorption resonance for the Uranium Hexafluoride ²³⁵UF₆ isotope for various frequencies in this region. The sublevels involved have been listed, with all the transitions up the ν₃-vibrational ladder obeying the selection rule Δl=±1. Similar tables have been drawn for the Uranium Hexafluoride ²³⁸UF₆ isotope for the same frequencies indicating that they are very far away from any resonances with the same levels.

We now summarize the steps of the process which will selectively excite the molecules to a particular excited state from which they will subsequently be able to be dissociated by a variety of methods. The UF₆ mixture with a carrier gas and a scavenger gas is expansion supercooled to a temperature of 60° K in such a way that the final UF₆ (density is between 1×10²¹ and 5×10²¹ molecules/m³ with the final density of the UF₆ molecules in the ground state being between 0.86×10²¹ molecules/m³ and 4.3×10²¹ molecules/m³ respectively (Tables 18 and 19). The supercooled UF₆ gas mixture is then irradiated with laser beams at the appropriate frequencies and intensities to selectively excite the desired isotope ²³⁵UF₆ to the [m(A₂):(3ν₃)] third energy state sublevel. The following points are of particular importance to the selective excitation of the desired isotope ²³⁵UF₆: (i) Good three photon resonance must be achieved with the [m(A₂):(3ν₃)] sublevel of the third energy excitation state (3ν₃) of the desired ²³⁵UF₆ isotope. The applied selective frequency should therefore be at 628.527 cm⁻¹ or at a nearby frequency; (ii) The applied selective frequency should therefore preferably be between 628.45 cm⁻¹ and 628.6 cm⁻¹ with the most possible preferable range being between 628.49 cm⁻¹ and 628.527 cm⁻¹, values which are dependent on the intensity of the pumping beam; (iii) The intensity of the pumping beam should be between 1×10⁹ W/m² and 50×10⁹ W/m² with the most probable range being between 5×10⁹ W/m² and 30×10⁹ W/m². This range appears to be preferable so that no effect of the quasicontinuum of energy states sets in at the third energy state of the ²³⁵UF₆ molecules enabling them to escape to other vibrational modes and background states; (iv) Restricting the UF₆ molecules from moving into the quasicontinuum of energy levels and other background states enables the effective application of infrared or ultraviolet laser beams to subsequently lead the selectively excited molecules to their dissociation; (v) By applying frequencies in the region of 628.527 cm⁻¹, resonance with the higher energy excitation levels, fourth, fifth etc. of the ²³⁵UF₆ isotope is limited, so that the molecules are kept in the third energy excitation level for a considerable amount of time, sufficient for simultaneous or subsequent dissociation processes to be applied; (vi) By applying the selective frequency for the desired ²³⁵UF₆ isotope at 628.527 cm⁻¹, or at a nearby frequency, resonances with the lower levels of the unwanted ²³⁵UF₆ are practically removed from resonance, further enhancing the selectivity of the desired ²³⁵UF₆ isotope to the third energy excitation level; (vii) The selective excitation of the ²³⁵UF₆ molecules to the third energy level will occur via three-photon resonance with the [m(A₂):(3ν₃)] sublevel of the third energy excitation state assisted by the power broadening of the first and second energy excitation states through power broadening of the first, second and third energy level transitions. The positions of the selective frequency is further removed from the resonances with the levels of the unwanted ²³⁸UF₆ isotope; (viii) The pressure of the expansion supercooled gas should be such that collisional de-excitation of the molecules is limited to long de-excitation times, more than 150 ns; (ix) For a final pressure of the expansion supercooled gas of 1.25 Torr, the average time between collisions of the UF₆ molecules with the carrier gas is much more than 500 ns which is a safe limit for considering that no collisional de-excitation of the UF₆ molecules takes place during the interaction process. Collisional de-excitation by collisions between the UF₆ molecules is much slower and of no particular consequence; (x) The main object of the pumping process is to selectively excite as many ²³⁵UF₆ molecules as possible to the third energy excitation level (nearly all of them can be excited) and keep them there for a sufficiently long time necessary for a subsequent dissociation process to be applied, either by simultaneously irradiating the molecular gas with infrared or ultraviolet lasers, or with a slight delay between them, or by any other dissociation process; (xi) We could also attempt pumping at frequencies slightly higher from the exact three-photon resonance frequency with the third energy excitation level. Resonance at the first and second energy levels may not only occur through power broadening processes. Other effects similar to Raman-type transitions in optically pumped lasers may enhance the transition due to the proximity of the pumping frequency to the resonance frequencies. Classical electrodynamics for near resonance interactions, which encompasses all the quantum effects simultaneously indicates that, during the interaction of electromagnetic radiation with a frequency near the resonance conditions with harmonically bound electrons, the scattering cross section (and similarly absorption) is greatly enhanced. We have taken the power broadening of the levels as a good practical indication of the significance of the level proximity to the absorption process.

FIG. 9 depicts the selectivity of the desired isotope ²³⁵UF₆ to the third energy excitation state through the power broadening of the lower vibrational levels and pumping frequencies near the three photon-resonance with the [m(A₂):(3ν₃)] sublevel of the state, at 628.527 cm⁻¹. The pumping intensity is set at 20 GW/m². The solid line curves correspond to the desired ²³⁵UF₆ isotope whilst the broken line curves correspond to the unwanted ²³⁸UF₆ isotope. The thick black solid line corresponds to the exact three-photon resonance at 628.527 cm⁻¹. The other frequencies correspond to the lines indicated on the figure. The absorption probability resonances at the first and second energy levels at the three-photon resonance frequency of 628.527 cm⁻¹ and the nearby frequencies now have very substantial values. The probability resonance at the third level remains very near the peak of the curve. At 628.49 cm⁻¹ the resonances at the second and third energy levels are now excellent. The probability resonance at the first energy level is 70% and at the second energy level is more than 90% whilst the three-photon resonance at the third energy level remains more than 95% (97% crossing of the curve, see later). At the frequency of 628.45 cm⁻¹ the probability resonance at the first energy level increases to 80%, at the second energy level is near 100%, whilst the three-photon resonance at the third energy level remains more than 75 (85% crossing of the curve, see later). Four-photon resonances with the fourth energy excitation level still remain extremely low. At the pumping frequency of the fundamental 628.306 cm⁻¹, the first level selectivity remains very good but three-photon resonance with the third energy level is still very poor for both isotopes. We have plotted and investigated many such graphs for pumping intensities between 2.5 GW/m² and 50 GW/m². The results are always very impressive.

The next task we have carried out is to check the possibilities of resonances between the sublevels of the first four energy states at the frequencies depicted in FIG. 9. It was found that no such resonances are possible even at high pumping intensities. We have also investigated the possibilities for transitions between the sublevels of the third and fourth energy excitation states, in case there is any fast redistribution of the excited molecules amongst the sublevels of the third energy excitation state within a time comparable to the duration of the pumping pulses. Any escaping of ²³⁵UF₆ molecules to the (4ν₃) state as a result of fast possible redistribution amongst the sublevels of the (3ν₃) state was found to be negligible. All the results were tabulated but it is not possible to present them in the short space available.

The next task we considered were the frequencies of the high power infrared beams necessary for the selective dissociation of the ²³⁵UF₆ molecules. It is important that the simultaneous application of the dissociating beams avoid any multiphoton resonances with the higher levels of the vibrational ladder as much as possible, when starting from the ground state. At the same time they should match as closely as possible the frequency differences between the sublevels of the 3^{rd}, 4^{th}, 5^{th}, 6^{th}, 7^{th} and 8^{th} energy states of the ν₃-mode vibrational ladder when starting from the [m(A₂):(3ν₃)] sublevel of the third energy state. We have drawn many graphs from the 4^{th} to the 8^{th} energy states depicting the relevant sublevels in relation to the CO₂ Raman shifted lines in parahydrogen when considered from the ground state for many pumping beam intensities between 60 GW/m² and 120 GW/m². Most of the frequencies in the range from R(20) to R(12) will miss all multiphoton resonances with the higher vibrational states of the ν₃-vibrational mode of the undesired isotope ²³⁸UF₆ even at high pumping intensities. The most suitable pumping frequencies directly originating from the CO₂ rotational lines shifted in parahydrogen are the R(18)=620.2476393 cm⁻¹ and R(20)=621.5561374 cm⁻¹ lines. We have located two pumping dissociation frequencies at 620.6 cm⁻¹ and 623.3 cm⁻¹ which can match multiphoton resonances between the [m(A₂):(3ν₃)] sublevel of the third energy excitation state and higher levels of the ν₃-vibrational mode up to the eighth energy excitation state of the desired isotope ²³⁵UF₆, without affecting or resonating with any of the levels of the unwanted isotope ²³⁸UF₆ even at high pumping intensities. The details cannot be presented in the short space available.

We now depict the entire selectivity and dissociation process using selectivity frequencies in the region of 628.527 cm⁻¹ and dissociation frequencies in the region of 620.6 cm⁻¹. The latter is approximately the frequency difference between the [m(A₂):(3ν₃)] and [m(F₁):(4ν₃)] of the 3^{rd} and 4^{th} energy states respectively of the ν₃-vibrational mode of the desired ²³⁵UF₆ isotope and can match most of the sublevels up to the eighth energy state thus keeping the excitation energy within one single vibrational mode up to very high energies. FIG. 10 depicts the entire selectivity and dissociation process for a selective beam frequency of 628.527 cm⁻¹ (continuous thick black line in the first three energy excitation states) at a pumping intensity of 20 GW/m² and a dissociating beam frequency of 620.6 cm⁻¹ (thick broken line from the third to the eighth energy excitation state) at a pumping intensity of 80 GW/m². The solid line curves correspond to the desired 333UF₆ isotope whilst the broken line curves correspond to the unwanted ²³⁸UF₆ isotope. We see that the dissociating frequency is in direct resonance with three of the five levels keeping the excitation energy within the ν₃-vibrational mode up to the eighth energy excitation state of the desired isotope ²³⁵UF₆ without affecting or resonating with any of the levels of the unwanted isotope ²³⁸UF₆. We recall that at these higher levels the selection rules are not very strict. The broken arrow line corresponds to the resonances of the unwanted isotope ²³⁸UF₆ when dissociation frequency at 620.6 cm⁻¹ starts from the corresponding third energy sublevel at 1883.77 cm⁻¹. Note that resonances with the higher levels can exist and this is why very good selectivity of the desired isotope must be achieved at the third energy excitation state, hence the importance of not elevating molecules of the unwanted ²³⁸UF₆ isotope to the third energy excitation level. Recall that the selection rules for the higher energy excitation states are loosely applicable. By applying this scheme searching for the most suitable frequencies in the neighbourhood of these frequencies and also obtaining the optimum pumping intensities for the two beams the selectivity of the desired isotope will turn out to be outstanding. We have investigated dozens of schemes like the one in FIG. 10 with different selectivity and dissociation frequencies at various pumping intensities. The nearest dissociating frequency directly derivable from the CO₂ Raman shifted line in parahydrogen is the R(18)=620.2476393 cm⁻¹. The power of the dissociating laser must also be restrained to levels which do not originate processes starting from the ground state to the quasicontinuum thereby affecting selectivity.

We have depicted the position of the absorption frequencies in a number of illustrative ways all of them showing the same trends and values but their presentation is outside the scope of the present patent application.

We have investigated in more detail the selectivity to the third energy excitation level of the ν₃-vibrational mode of UF₆ for each of the energy levels up to the fourth energy state, for various selective frequencies ranging from 628.45 cm⁻¹ to 628.56 cm⁻¹ and pumping powers ranging from 1 GW/m² to 80 GW/m². FIG. 11 shows a summary of the hundreds of graphs drawn for obtaining the selectivity between the two isotopes at the various pumping frequencies and intensities. All four graphs are drawn for a pumping intensity of 20 GW/m². The abscissa |c(t)|² represents the absorption probability for the corresponding frequency on the ordinate. We have then calculated the relative selectivities to the third energy state for the two isotopes UF₆ and ²³⁸UF₆. For the first energy excitation level (fundamental) the absorption cross section follows the power broadened curve of the fundamental transition. The effective selectivity between the two isotopes due to the inherent resonance at the fundamental, would therefore correspond to the ratio of their respective power broadened curves at the position of the pumping frequency. For the second energy excitation level the absorption cross section is proportional to the intensity of the applied beam (two-photon absorption). Since the power broadened curve represents the probability for absorption at a particular frequency, the envelope of the curve is proportional to the intensity of the pumping beam. Again, the effective selectivity between the two isotopes due to inherent two-photon resonance with the second energy excitation level would correspond to the ratio of their respective power broadened curves at the position of the pumping frequency. The situation is different in the case of three-photon resonance with the third energy excitation level. The three-photon absorption cross section with the third energy excitation level is proportional to the square of the pumping intensity (see below eq. (54)). Let Iₒ be the intensity of the pumping beam at the peak of the absorption power broadened curve. Its value at any other point on the curve will be qIₒ where q is the ratio of the abscissa of the curve at the position of the pumping frequency to the peak of the power broadened curve. The three-photon absorption cross section at the peak of the curve is σₒ=K²Iₒ². The absorption cross section at the pumping frequency is σ₁=K² (q² Iₒ²). The ratio of the absorption cross sections at the two frequencies is (σ₁/σₒ)=q². The effective selectivity between the two isotopes due to three-photon resonance with the third energy excitation level would therefore be proportional to the square of the ratio of their respective power broadened curves at the position of the pumping frequency. Similar relations for the absorption cross sections at the higher energy excitation levels will progress accordingly but at these high excitation states and pumping intensity levels other effects may also become dominant.

The positions of six pumping frequencies at 628.306 cm⁻¹, 628.45 cm⁻¹, 628.49 cm⁻¹, 628.527 cm⁻¹, 628.56 cm⁻¹ and 628.6 cm⁻¹ are shown on the graphs of FIG. 11. A look at the first graph (a) demonstrates clearly that at 628.306 cm⁻¹ (frequency of the fundamental transition of the ²³⁵UF₆ isotope) the selectivity at the ground state absorption remains excellent despite the much increased power broadening of the levels. Although at the second energy excitation state a fair amount of selectivity is indicated [graph (b)], the selectivity at the three-photon resonance remains extremely poor [graph (c)], whilst absorption is also limited, especially since we must consider the square of the absorption selectivity values. Thus, at this frequency overall absorption and selectivity of the desired isotope to the third energy excitation level remains extremely poor. At the selecting frequency of 628.527 cm⁻¹ [three-photon resonance with the third level, graph (c)] excellent absorption probability resonance ensues at the third energy level [graph (c)] whilst maintaining very good two-photon resonance conditions at the second energy excitation level [graph (b)]. The now much improved resonance at the first energy excitation level due to power broadening of the ²³⁵UF₆ fundamental, renders

TABLE 20
Pumping Intensity 20 × 10⁹ W/m²

| | | | Frequency for two- | Arbitrary frequency | Frequency for three- | Slightly higher |
|---|---|---|---|---|---|---|
| | | Fundamental | photon resonance | slightly on the | photon resonance | frequency than |
| | PUMPING | frequency of the | with second level at | lower side of | with third level at | the sublevel |
| | FREQUENCY | ²³⁵UF₆ | (1/2) m(F₂):(2v₃) | (1/3) m(A₂):(3v₃) | (1/3) m(A₂)(3v₃) | (1/3) m(A₂)(3v₃) |
| 1^{st} Energy Level | Pumping | 628.306 (cm⁻¹) | 628.45 (cm⁻¹) | 628.49 (cm⁻¹) | 628.527 (cm⁻¹) | 628.6 (cm⁻¹) |
| | frequency | | | | | |
| | Selectivity | 7 | 7.31 | 7.13 | 6.77 | 5.91 |
| | $\frac{Crossing of curve}{peak of {}^{235} {UF}_{6}}$ | 1 | 0.74 | 0.69 | 0.56 | 0.42 |
| | $\frac{Crossing of curve}{peak of {}^{238} {UF}_{6}}$ | 0.15 | 0.1 | 0.097 | 0.084 | 0.072 |
| 2^{nd} Energy Level | Two photon | 1256.612 (cm⁻¹) | 1256.9 (cm⁻¹) | 1256.98 (cm⁻¹) | 1257.054 (cm⁻¹) | 1257.2 (cm⁻¹) |
| | Pumping frequency | | | | | |
| | Selectivity | 5.89 | 12.62 | 13.56 | 12.9 | 10.79 |
| | $\frac{Crossing of curve}{peak of {}^{235} {UF}_{6}}$ | 0.68 | 1 | 0.93 | 0.84 | 0.52 |
| | $\frac{Crossing of curve}{peak of {}^{238} {UF}_{6}}$ | 0.12 | 0.078 | 0.07 | 0.065 | 0.05 |
| 3^{rd} Energy Level | Three photon | 1884.918 (cm⁻¹) | 1885.35 (cm⁻¹) | 1885.47 (cm⁻¹) | 1885.58 (cm⁻¹) | 1885.8 (cm⁻¹) |
| | Pumping frequency | | | | | |
| | Selectivity | 2.47 | 11.27 | 15 | 18.33 | 18.75 |
| | $\frac{Crossing of curve}{peak of {}^{235} {UF}_{6}} ( squared )$ | 0.305 0.093 | 0.805 0.648 | 0.94 0.884 | 1 1 | 0.786 0.617 |
| | $\frac{Crossing of curve}{peak of {}^{238} {UF}_{6}} ( squared )$ | 0.123 0.015 | 0.069 4.74 × 10⁻³ | 0.06 3.6 × 10⁻³ | 0.054 2.9 × 10⁻³ | 0.042 1.76 × 10⁻³ |
| Absorption probability | | 0.063 | 0.48 | 0.57 | 0.47 | 0.134 |
| of the ²³⁵UF₆ isotope | | | | | | |
| to the 3^{rd} energy level | | | | | | |
| Absorption probability | | 0.27 × 10⁻³ | 0.037 × 10⁻³ | 0.0245 × 10⁻³ | 0.0158 × 10⁻³ | 0.0063 × 10⁻³ |
| of the ²³⁸UF₆ isotope | | | | | | |
| to the 3^{rd} energy level. | | | | | | |
| Relative selectivity | | 0.233 × 10⁻³ | 12.97 × 10⁻³ | 23.26 × 10⁻³ | 29.75 × 10⁻³ | 21.27 × 10⁻³ |
| between the two isotopes | | | | | | |
| to the 3^{rd} energy level | | | | | | |
| Selectivity increase | | 1 | 55.7 | 99.8 | 127.7 | 91.29 |
| that of the fundamental | | | | | | |
| ²³⁵UF₆ line at 628.306 cm⁻¹ | | | | | | |
| 4^{th} Energy Level | Four-photon | 2513.22 (cm⁻¹) | 2513.8 (cm⁻¹) | 2513.96 (cm⁻¹) | 2514.11 (cm⁻¹) | 2514.4 (cm⁻¹) |
| | Pumping frequency | | | | | |
| | $\frac{Crossing of curve}{\begin{matrix}peak {of}^{235} {UF}_{6} \\ ( cubed )\end{matrix}}$ | 0.139 2.68 × 10⁻³ | 0.073 0.385 × 10⁻³ | 0.061 0.227 × 10⁻³ | 0.051 0.13 × 10⁻³ | 0.039 0.06 × 10⁻³ |
| | $\frac{Crossing of curve}{\begin{matrix}peak {of}^{238} {UF}_{6} \\ ( cubed )\end{matrix}}$ | 0.017 4.81 × 10⁻⁶ | 0.013 2.19 × 10⁻⁶ | 0.012 1.6 × 10⁻⁶ | 0.01 1.12 × 10⁻⁶ | 0.007 0.27 × 10⁻⁶ |

the overall selectivity to the third energy excitation, at this pumping frequency and intensity, very good. At the nearby frequencies of 628.45 cm⁻¹ and 628.49 cm⁻¹ the absorption probability resonances are now substantial at all three levels rendering the selectivity process to the third energy excitation level excellent. Especially at the frequency 628.49 cm⁻¹ the resonances become very good at all three levels. The three-photon selectivity process at these

TABLE 21
Absorption probability resonances and Selectivities to the Third Energy Level of UF₆

| | | | Frequency for | | Frequency for | |
|---|---|---|---|---|---|---|
| | | | two-photon | Arbitrary frequency | three photon | Slightly higher |
| | | Fundamental | resonance with | slightly on the | resonance with | frequency than |
| Pumping | PUMPING | frequency of | the level at | lower side of | third level at | the |
| Intensity | FREQUENCY | the ²³⁵UF₆ | (1/3) m(F₂):(2v₃) | (1/3) m(A₂):(3v₃) | (1/3) m(A₂):(3v₃) | (1/3) m(A₂):(3v₃) |
| (W/m²) | Pumping frequency | 628.306 (cm⁻¹) | 628.45 (cm⁻¹) | 628.49 (cm⁻¹) | 628.527 (cm⁻¹) | 628.6 (cm⁻¹) |
| 5 × 10⁹ | $\frac{Crossing of the curve}{Peak of {3}^{r d} {level}^{235} {UF}_{6}}$ | 0.097 | 0.5 | 0.81 | 1 | 0.45 |
| | $\frac{Crossing of the curve}{Peak of {3}^{r d} {level}^{238} {UF}_{6}}$ | 0.031 | 0.014 | 0.015 | 0.015 | 0.008 |
| | Selectivity increase to the 3^{rd} | 1 | 423 | 604 | 947 | 193 |
| | level relative to that at | | | | | |
| | 628.306 cm⁻¹ | | | | | |
| 10 × 10⁹ | $\frac{Crossing of the curve}{Peak of {3}^{r d} {level}^{235} {UF}_{6}}$ | 0.18 | 0.65 | 0.857 | 1 | 0.67 |
| | $\frac{Crossing of the curve}{Peak of {3}^{r d} {level}^{238} {UF}_{6}}$ | 0.0675 | 0.034 | 0.032 | 0.028 | 0.0235 |
| | Selectivity increase to the 3^{rd} | 1 | 187.33 | 373.1 | 423.8 | 154.13 |
| | level relative to that at | | | | | |
| | 628.306 cm⁻¹ | | | | | |
| 15 × 10⁹ | $\frac{Crossing of the curve}{Peak of {3}^{r d} {level}^{235} {UF}_{6}}$ | 0.252 | 0.75 | 0.922 | 1 | 0.7273 |
| | $\frac{Crossing of the curve}{Peak of {3}^{r d} {level}^{238} {UF}_{6}}$ | 0.093 | 0.05 | 0.04545 | 0.04 | 0.0325 |
| | Selectivity increase to the 3^{rd} | 1 | 90 | 161.2 | 203 | 110.17 |
| | level relative to that at | | | | | |
| | 628.306 cm⁻¹ | | | | | |
| 20 × 10⁹ | $\frac{Crossing of the curve}{Peak of {3}^{r d} {level}^{235} {UF}_{6}}$ | 0.305 | 0.805 | 0.94 | 1 | 0.786 |
| | $\frac{Crossing of the curve}{Peak of {3}^{r d} {level}^{238} {UF}_{6}}$ | 0.123 | 0.069 | 0.06 | 0.054 | 0.042 |
| | Selectivity increase to the 3^{rd} | 1 | 55.7 | 99.8 | 127.7 | 91.29 |
| | level relative to that at | | | | | |
| | 628.306 cm⁻¹ | | | | | |
| 30 × 10⁹ | $\frac{Crossing of the curve}{Peak of {3}^{r d} {level}^{235} {UF}_{6}}$ | 0.4 | 0.85 | 0.95 | 1 | 0.85 |
| | $\frac{Crossing of the curve}{Peak of {3}^{r d} {level}^{238} {UF}_{6}}$ | 0.171 | 0.095 | 0.089 | 0.08 | 0.064 |
| | Selectivity increase to the 3^{rd} | 1 | 37.32 | 54.39 | 71.9 | 68.21 |
| | level relative to that at | | | | | |
| | 628.306 cm⁻¹ | | | | | |
| 40 × 10⁹ | $\frac{Crossing of the curve}{Peak of {3}^{r d} {level}^{235} {UF}_{6}}$ | 0.46 | 0.896 | 0.96 | 1 | 0.89 |
| | $\frac{Crossing of the curve}{Peak of {3}^{r d} {level}^{238} {UF}_{6}}$ | 0.227 | 0.126 | 0.1143 | 0.1013 | 0.084 |
| | Selectivity increase to the 3^{rd} | 1 | 30.21 | 45.66 | 61.25 | 62.35 |
| | level relative to that at | | | | | |
| | 628.306 cm⁻¹ | | | | | |

frequencies now becomes good and it is only a matter of the level of the pumping intensity to excite the molecules of the ²³⁵UF₆ isotope for the laser isotope separation process. Note that the calculations of the selectivity and the graphic representations are relative and approximate but they give a very good indication of the limits for the intensities, pulse lengths and frequencies which must be applied to the molecular gas for obtaining outstanding selectivity.

All the graphs have been plotted on an enlarged scale and the relative selectivities to the third energy state for the two isotopes ²³⁵UF₆ and ²³⁸UF₆ have been calculated for each pumping intensity by considering the points at which the various frequencies cross the curves as described above. Table 20 is a typical table at a pumping intensity of 20 GW/m². Note the enormous increase in the selectivity to the third energy excitation level when pumping at the three-photon resonance frequency 628.527 cm⁻¹ as compared with pumping at the frequency of the fundamental at 628.306 cm⁻¹ (127 times higher selectivity). Subsequently, we have summarized all the results for all the pumping intensities from 0.5 GW/m² to 80 GW/m². Table 21 is a typical example for pumping intensities between 5×10⁹ W/m² and 40×10⁹ W/m². The third row at each pumping intensity level shows the selectivity increase to the third energy excitation level when pumping at frequencies near the three-photon resonance at 628.527 cm⁻¹ as compared with pumping at the frequency of the fundamental at 628.306 cm⁻¹, as calculated from tables like table 20. Results for pumping intensities below 5×10⁹ W/m² may not have any practical significance because the attainment of three-photon resonance may be difficult to establish. The selectivity for pumping intensities higher than 40×10⁹ W/m² may be hampered by absorption in the quasicontinuum of energy states. The trend with which the selectivity decreases with increasing intensity is clear. The reason of the enormous selectivity at lower pumping intensities is due to the fact that all molecules of the desired isotope ²³⁵UF₆ can be elevated to the third energy level whilst at lower pumping intensities those of the undesired ²³⁸UF₆ isotope remain largely unexcited. Although the results may be considered to be only indicative it is clear that enormous selectivities can be achieved when three photon absorption for the ²³⁵UF₆ isotope is attained at lower pumping intensities with shorter duration pulses (see later).

We have investigated the three-photon absorption process quantitatively by obtaining the transition rate for the three-photon absorption resonance. We have started from the most general form of the Fermi Golden rule for transitions and expanded the terms of the interaction Hamiltonian to higher orders:

$${W \text{?} = \frac{2 π}{ℏ} \vert R \text{?} {\vert}^{2} δ ( - ) = \frac{2 π}{ℏ} \vert 〈 Φ \text{?} \vert R \vert Φ \text{?} 〉}^{2} δ ( - ) \qquad ( 36 )$$

$$\text{?} \text{indicates text missing or illegible when filed}$$

where Φ_{F} and Φ_{I} are the final and initial states of the entire quantum system (atom plus radiation) and the δ-function is given by

$$δ ( - ) = δ ( - - ℏ {ω}_{k} ) = \frac{1}{ℏ} δ ( ω \text{?} - {ω}_{k} ) \qquad ( 37 )$$

$$\text{?} \text{indicates text missing or illegible when filed}$$

where [symbol] and [symbol] are the final and initial energy states of the entire quantum system (atom plus radiation), [symbol] and [symbol] are the final and initial energies of the atomic states, on is the frequency difference between the final and initial atomic states, ωₖ is the frequency of the interacting radiation and eq. (37) ensures the conservation of energy for the system as a whole (atom plus radiation field), R_{FI} is the reaction matrix for the whole quantum system as defined mathematically in eq. (36). The reaction matrix R_{fi} for an atomic system which will reach a final state φ_{f} from an initial atomic state φᵢ can be expanded as

$${R}_{FI} ≡ 〈 {Φ}_{F} \vert R \vert Φ \text{?} 〉 = {R}_{FI}^{( 1 )} , {R}_{FI}^{( 2 )} , {R}_{FI}^{( 3 )} , {R}_{FI}^{( 4 )} + … \qquad ( 38 )$$

$$\text{?} \text{indicates text missing or illegible when filed}$$

where each of the terms

$${R}_{FI}^{( 1 )} , {R}_{FI}^{( 2 )} , {R}_{FI}^{( 3 )} , {R}_{FI}^{( 4 )} + …$$

has been evaluated through the repetitive application of the Lippmann-Schwinger equation describing the evolution of the wavefunction from time tₒ=0 to/through the evolution operator U(t,tₒ). During the three-photon absorption process three incident photons (kζ), (k′ζ′) and (k″ζ″) with nearly the same energy and specified polarization and propagation direction are absorbed by an atomic or molecular system, the latter making a transition to a final state whose energy is approximately (ℏωₖ+ℏω_{k′}+ℏω_{k″}). Thus, in a three-photon absorption process three photons are lost. The evolution of the wavefunction to the third energy state in the case of three-photon absorption occurs through the use of the Dyson chronological operator with the integrations being carried out over all the possible orderings of the times t₁, t₂ and t₃ i.e. the number of ways in which the three photons are being absorbed between levels |φᵢ [symbol] and |φ_{f} [symbol] . The matrix elements of all six possible pathways have been computed and summarized mathematically. All pathways contribute to the third order term in the interaction Hamiltonian during the three-photon absorption process. They are depicted schematically in FIG. 12(a). Subsequently we have obtained the matrix elements for all the terms that contribute to the third order reaction matrix R_{FI}⁽³⁾ in eq. (38). Our analysis followed similar lines to those suggested by Weissbluth on higher order electromagnetic interactions applied to the three-photon absorption process [Weissbluth M., ‘Atoms and Molecules’, Academic Press, New York, pp. 544-547, (1978)]. FIG. 12(b) depicts the situation when the three photons are the same. i.e. ωₖ=ω′_{k′}=ω″_{k″}. Note that the intermediate states |φᵢ [symbol] and |φₘ [symbol] although imaginary they nevertheless constitute solutions to the atomic Schrödinger equation. When the intermediate states |φᵢ [symbol] and |φₘ [symbol] are real atomic or molecular states as in the case of a vibrational ladder the situation is depicted in FIG. 12(c) where their position may differ slightly from exact resonance. This is the case of three-photon resonance with the third energy excitation level [m(A₂):(3ν₃)] of the ²³⁵UF₆ isotope when the vibrational ladder interacts with a one frequency pumping beam i.e with reference to FIGS. 12(a), (b) we set ωₖ=ω′_{k′}=ω″_{k″}, n_{kζ}=n_{k′ζ′}=n_{k″ζ″}, m₁=m₂=m₃=m, l₁=l₂=l₃=l, with the resulting situation being depicted in FIG. 12(c). It is not possible to present the complete derivation here but on noting that in the case of sufficiently powerful pumping beams the electric dipole approximation e^{ik·r}≈1 is valid, giving the identity:

$$〈 φ \text{?} \vert \hat{e} \text{?} \cdot p ) e \text{?} \vert {φ}_{m} 〉 = i m {ω}_{k} \hat{e} \text{?} \cdot 〈 {φ}_{f} \vert r \vert {φ}_{m} 〉 \qquad ( 39 )$$

$$\text{?} \text{indicates text missing or illegible when filed}$$

which when used in the detailed analysis results in the following expression for the three-photon transition rate W_{fi} as (in MKSA units)

$$W \text{?} = − 36 {ℏ ( \frac{2 π {ω}_{k} n \text{?}}{V \text{?}} )}^{3} \times {\sum }_{m} {\sum }_{1} \frac{1}{{( 4 π {ε}_{o} )}^{3}} {\{ \frac{{e}^{3} 〈 {φ}_{f} \vert r \vert {φ}_{m} 〉 〈 {φ}_{m} \vert r \vert {φ}_{l} 〉 〈 {φ}_{l} \vert r \vert φ \text{?} 〉}{( − + 2 ℏ {ω}_{k} ) ( − + ℏ {ω}_{m} )} \}}^{2} g ( {v}_{f} ) \qquad ( 40 )$$

$$\text{?} \text{indicates text missing or illegible when filed}$$

The units of the terms on the right hand side are

$$J s {( \frac{{s}^{- 1}}{{m}^{3}} )}^{3} \frac{1}{{( F / m )}^{3}} ∼ \frac{{C}^{3} {m}^{3}}{{J}^{2}} ) s = {s}^{- 1}$$

which is the unit for the transition rate W_{fi}. Eq. (40) gives the transition rate in s⁻¹ for three-photon absorption from an initial state |φᵢ [symbol] to a final excited state |φ_{f} [symbol] in terms of the number of photons n_{kζ}. The pumping intensity I_{ω}_{ₖ} is given by

$$I \text{?} = \frac{c {n}_{{k}_{δ}} ℏ {ω}_{k}}{{V}_{ol}} \qquad ( 41 )$$

$$\text{?} \text{indicates text missing or illegible when filed}$$

which when substituted into eq. (40) gives the transition rate for the three photon resonance

$$\begin{matrix}W \text{?} = − \frac{4 {I}_{ω}^{3} \text{?}}{{c}^{3} {ε}_{o}^{3} {ℏ}^{2}} {\sum }_{m} {\sum }_{l} {\{ \frac{{e}^{3} 〈 {φ}_{f} \vert r \vert {φ}_{m} 〉 〈 {φ}_{m} \vert r \vert {φ}_{l} 〉 〈 {φ}_{l} \vert r \vert φ \text{?} 〉}{( − + 2 ℏ {ω}_{k} ) ( − + ℏ {ω}_{m} )} \}}^{2} g ( {v}_{f} ) \\ = − \frac{4 ℏ {ω}_{k}^{3}}{{c}^{3} {ε}_{o}^{3}} {I}_{ω}^{3} \text{?} ( x , t ) {\sum }_{m} {\sum }_{l} {\{ \frac{{e}^{3} 〈 {φ}_{f} \vert r \vert {φ}_{m} 〉 〈 {φ}_{m} \vert r \vert {φ}_{l} 〉 〈 {φ}_{l} \vert r \vert φ \text{?} 〉}{( − + 2 ℏ {ω}_{k} ) ( − + ℏ {ω}_{m} )} \}}^{2} g ( {v}_{f} )\end{matrix} \qquad ( 42 )$$

$$with$$

$${I}_{ω} \text{?} = h v {I}_{ω} \text{?} ( x , t ) = ℏ {ω}_{k} {I}_{ω} \text{?} ( x , t ) \qquad ( 43 )$$

$$\text{?} \text{indicates text missing or illegible when filed}$$

where W_{fi}(s⁻¹) is the three-photon transition rate,

$${I}_{ω} \text{?} ( J / {m}^{2} s )$$

$$\text{?} \text{indicates text missing or illegible when filed}$$

is the intensity of the pumping beam, I_{ω}_{ₖ}(x,t) (photons/m²s) is the photon intensity of the pumping beam, ωₖ=2πν (s⁻¹) is the frequency of the applied radiation, g(ν_{f}) (s) is the lineshape function given by eq. (16) resulting from the smearing out of the position of the final energy state [symbol] and Δν_{f}(s⁻¹) is the half width of the absorption spectrum of the level. Eq. (42) gives the transition rate in s⁻¹ for three-photon absorption from an initial state |φᵢ [symbol] to a final excited state |φ_{f} [symbol] in terms of the intensity I_{ω}_{ₖ} and the induced dipole moments. Note the resonances in the denominator. They are resonances of the quantum system between the ground and the 1^{st} energy level, and the ground and the second energy level. They are not between successive energy levels. Two photons are required to match the energy difference between the ground and the second energy excitation level simultaneously with the photon match at the fundamental. This scientific subtlety has always been overlooked in the rather factitious conception of the multiphoton effect, frequently depicted as the stepwise absorption of photons one by one, up the vibrational ladder during its interaction with a laser beam. The transition rate in eq. (42) becomes infinite when one of the terms in the denominator vanishes. This is a consequence of the assumption of infinitely sharp atomic states. Near resonance it is therefore necessary to include a damping factor which must be incorporated in each of the terms in the denominator. This damping factor will be of the order of

$$∼ \frac{1}{2} Γ \to \frac{1}{2} ( ℏ 2 π Δ v )$$

where Δν is the spectral width of the spontaneous emission line of the transition. Thus, the excited atomic state is broadened to a width Γ as a result of the spontaneous emission process, resulting in a Lorentzian line shape in the emission spectrum whose full width at half maximum is Δω=Γ/ℏ. This means that, as a consequence of spontaneous emission, the quantum states cannot be infinitely sharp but must have a finite spread in energy equal to (½ Γ) which corresponds approximately to the natural linewidth of the transition. It is the minimum possible width assuming all other broadening mechanisms have been eliminated. We will not elaborate any further on the theory of three-photon absorption due to extreme shortage of space.

Following eq. (29) above, the dipole moment between successive higher vibrational levels of a harmonic oscillator increases according to the square root of increasing vibrational numbers. Since the first three energy levels of the ν₃-vibrational mode of the Hexafluorides are a very close match to a harmonic oscillator, we can write the transition elements of the dipole moments of the levels as e [symbol] φ_{f}|r|φₘ [symbol] =e\sqrt{3} [symbol] φ₁|r|φᵢ [symbol] and e [symbol] φₘ|r|φ₁ [symbol] =e\sqrt{2} [symbol] φᵢ|r|φᵢ [symbol] with the dipole moment between the ground and the third energy excitation level becoming

$${μ}_{fi} = 〈 {φ}_{f} \vert μ \vert {φ}_{i} 〉 = {e}^{3} 〈 {φ}_{j} \vert r \vert {φ}_{m} 〉 〈 {φ}_{m} \vert r \vert {φ}_{i} 〉 〈 {φ}_{i} \vert r \vert {φ}_{i} 〉 = \sqrt{6} {( e 〈 {φ}_{l} \vert r \vert {φ}_{i} 〉 )}^{3} \qquad ( 44 )$$

measured in units of (C³ m³). This dipole moment for three photon absorption holds true so long as there are intermediate states matching the energy of the individual photons. On denoting the frequency deviations of the photon energies from exact resonance with the first and second vibrational levels by Δω₁ and Δω₂ in (s⁻¹) respectively, for all practical purposes we can approximate the denominator in eq. (42) by

$$( - + 2 {ℏω}_{k} ) ( - + {ℏω}_{k} ) = ( {ℏΔω}_{2} ) ( {ℏΔω}_{1} ) \qquad ( 45 )$$

This is a very sound approximation for practical calculations with the minimum possible values (i.e. exact resonance) limited by the corresponding linewidth of the levels (Δνₒ)₁ and (Δνₒ)₂, as pointed out above, i.e. (ℏΔω₁)ₘᵢₙ=ℏ2π(Δνₒ)₁ and (ℏΔω₂)ₘᵢₙ=ℏ2π(Δνₒ)₂. Thus, for all practical purposes, we can write eq. (42) as

$${W}_{fi} = - \frac{4 {I}_{{ω}_{k}}^{3}}{{c}^{3} {ε}_{0}^{3} {ℏ}^{2}} {\{ \frac{\sqrt{6} {( e 〈 {φ}_{l} \vert r \vert {φ}_{i} 〉 )}^{3}}{( {ℏΔω}_{2} ) ( {ℏΔω}_{1} )} \}}^{2} g ( {v}_{f} ) = - {K}_{w} ( ω ) {I}_{{ω}_{k}}^{3} ( x , t ) \qquad ( 46 )$$

$$where$$

$$( 47 )$$

$${K}_{w} ( ω ) = \frac{4 ℏ {ω}_{k}^{3}}{{c}^{3} {ε}_{0}^{3}} {\{ \frac{\sqrt{6} {( e 〈 {φ}_{l} \vert r \vert {φ}_{i} 〉 )}^{3}}{( {ℏΔω}_{2} ) ( {ℏΔω}_{1} )} \}}^{2} g ( {v}_{f} ) = \frac{24 {ω}_{k}^{3}}{{c}^{3} {ε}_{0}^{3} {ℏ}^{3}} \{ \frac{{( e 〈 {φ}_{l} \vert r \vert {φ}_{i} 〉 )}^{6}}{{( {Δω}_{2} {Δω}_{1} )}^{2}} g ( {v}_{f} )$$

where K_{w}(ω) is in s²m⁶. The absorption or emission cross sections drop proportionally according to the value of their corresponding intensity curve at a particular frequency. The absorption cross section is a constant of proportionality between the transition rate and the intensity of the beam. From eq. (46) the three-photon absorption cross section to the third energy excitation level is proportional to the square of the pumping intensity. Since the third energy level power broadened curve is proportional to the intensity, the three-photon absorption cross section will be proportional to the square of the abscissa of the curve relative to the peak. A correction factor q′ must be introduced into eq. (46) to account for the deviation of the pumping frequency from exact resonance with the third energy level, where q is the ratio of the value of the power broadened curve at the position of the pumping frequency to the peak of the curve. For all practical purposes, a factor q² is introduced and on using eq. (43) the three-photon transition rate in eq. (46) becomes

$${W}_{fi} = - {q}^{2} \frac{24 {ω}_{k}^{3}}{{c}^{3} {ε}_{0}^{3} {ℏ}^{3}} \{ \frac{{( e 〈 {φ}_{l} \vert r \vert {φ}_{i} 〉 )}^{6}}{{( {Δω}_{2} {Δω}_{1} )}^{2}} g ( {v}_{f} ) {I}_{{ω}_{k}}^{3} = - {q}^{2} {K}_{w} ( ω ) \frac{{I}_{{ω}_{k}}^{3}}{{ℏ}^{3} {ω}_{k}^{3}} \qquad ( 48 )$$

where q is the ratio of the value of the power broadened curve at the position of the pumping frequency to the peak of the absorption curve. Equation (48) gives the transition rate W_{fi} (s⁻¹) for three photon absorption up the vibrational ladder in terms of known parameters and measurable quantities of the vibrational ladder and the applied electromagnetic field.

The approximation (45) for the resonant denominators in terms of the frequency deviations Δω₁ and Δω₂ of the photon energies from exact resonance with the first and second vibrational levels respectively is for all practical purposes valid, as well as the frictional term resulting from the spectral width Δν of the spontaneous emission line of the transition in the cases of exact resonance with the levels. The small magnitudes of their values is counterbalanced by the small sizes of the atomic constants and the molecular parameters involved in expressions (46)-(48). Quantum mechanical expressions have been shown to always be in accordance with the experimental results and observations provided the classical constants have been substituted with the corresponding quantum mechanical equivalent parameters of the system according to

$$( \frac{{e}^{2}}{m} ) {←}^{classical quanitity} {\to }^{quantum - mechanical equivalent} \frac{{g}_{o}}{{g}_{1}} \frac{2 {ω}_{o} {\vert {μ}_{f} \vert}^{2}}{3 h} \qquad ( 49 )$$

an expression whose validity has been ensured in all our calculations and evaluation of the experimental results. In expression (49), e is the electronic charge and m its mass, gₒ, g₁ are the degeneracies of the levels, ωₒ the resonant frequency and pun the induced dipole moment between levels f an i. Furthermore, it had been demonstrated in the past that calculations of the cross sections of nonlinear effects through classical electrodynamics near resonant conditions during the interaction of electromagnetic radiation with bound electrons, give the same results as those obtained through quantum mechanical procedures (differing only by factors of 2, 4, 8, etc. due to spin).

For the UF₆ molecule the spreads of the subbandheads for the fundamental transition and the third energy excitation level are (Table 10): (Δνₒ)_{ν}_{₃}→(Q_{A}−Q_{G})_{ν}_{₃}=0.197 cm⁻¹=0.5905911423×10¹⁰ s⁻¹ and

$${( {Δν}_{f} )}_{3 {ν}_{3}} \to {( {Q}_{A} - {Q}_{G} )}_{3 {ν}_{3}} = 0.278 {cm}^{- 1} = 0.833420332 \times {10}^{10} {s}^{- 1} ,$$

giving the corresponding lineshape factors as [eqs. (16) and Table 11]

$${g ( {ν}_{o} )}_{{ν}_{3}} = \frac{2}{{π ( {Δν}_{o} )}_{{ν}_{3}}} = 1.07793654 \times {10}^{- 10} s ,$$

$${g ( {ν}_{f} )}_{3 {ν}_{3}} = \frac{2}{{π ( {Δν}_{f} )}_{3 {ν}_{3}}} = 0.763861505 \times {10}^{- 10} s$$

From Table 7 the dipole moment of the fundamental is

$$\vert {μ}_{{ν}_{3}}^{( 2 )} \vert ≡ e 〈 {φ}_{l} \vert r \vert {φ}_{i} 〉 = 1.2864 \times {10}^{- 30} Cm .$$

Substituting the above values in eq. (48) we obtain the three-photon transition rates to the third energy excitation level for the two Uranium hexafluoride isotopes ²³⁵UF₆ and ²³⁸UF₆ as

$${( {W}_{03} )}_{235} = 3.229366504 \times {10}^{23} \frac{1}{{( {Δω}_{2} {Δω}_{1} )}_{235}^{2}} {q}_{235}^{2} \text{?} \qquad ( 50 )$$

$${( {W}_{03} )}_{238} = 3.229366504 \times {10}^{23} \frac{1}{{( {Δω}_{2} {Δω}_{1} )}_{238}^{2}} {q}_{238}^{2} \text{?} \qquad ( 51 )$$

$$\text{?} \text{indicates text missing or illegible when filed}$$

which give the three-photon transition rates in terms of the measurable quantities: Δω₁→difference between the applied photon frequency and the frequency of the fundamental; Δω₂→difference between the applied two-photon resonance frequency and the second energy excitation level; the value of the ratio of the power broadened curve at the position of the pumping frequency to the peak of the absorption curve q; and the intensity I_{ω}_{ₖ} (J/m²s) of the applied beam. Note the enormous difference with the expression for the induced transition rate for an equivalent two level system [(W₀₁)_{UF}_{₆}=3.0017 I_{ω}_{ₖ}, following eq. (18) above. As pointed out above a minimum practical limit for the value of resonant denominators is determined by the value of the level width arising from spontaneous emission, which in the case of UF₆ is [(Δνₒ)]ₘᵢₙ=0.197/2 cm⁻¹˜0.1 cm⁻¹ The minimum values of the denominators for levels one and two which can be employed during three-photon absorption are thus (ℏΔω₁)ₘᵢₙ=ℏ2π(Δνₒ)₁=ℏ2π×0.1c=1.98644544×10⁻²⁴ J and (ℏΔω₂)ₘᵢₙ=ℏ2π(Δνₒ)₂≈ℏ2π(Δνₒ)₁=ℏ2π0.1 c=1.98644544×10⁻²⁴ J. We will not elaborate any further on these points as for all practical purposes eqs. (50) and (51) give very sound results for applications in experimental calculations.

We have investigated the three-photon absorption during the interaction of a resonant electromagnetic beam with the ν₃-vibrational mode of the UF₆ as it travels through the molecular gas. We have followed the same steps in the derivations as in the standard absorption (or amplifier) equation [Cabezas et al, Journal of Applied Physics, Vol. 38, p. 3487, (1967); Andreou D., ‘Ampification of light pulses in a liquid laser’, Ph.D Thesis, University of London, Chapter 3, pp. 57-60, (1973)]. We have extended the analysis to cover the three-photon absorption during the propagation of a light pulse through a medium consisting of two kinds of absorbing molecules. The variation of the photon intensity I(x) (photons/m²) at a position x along the direction of propagation through the molecular gas turns out to be

$$\frac{dI ( x )}{dx} = 3 [ Δ {N}^{238} ( x , t ) - Δ {N}_{o}^{238} ] + 3 [ Δ {N}^{235} ( x , t ) - Δ {N}_{o}^{235} ] - ℓ I ( x ) \qquad ( 52 )$$

where

$$Δ {N}_{o}^{238} and Δ {N}_{o}^{235}$$

denote the molecular populations in (molecules/m³) for the two isotopic species of the molecules before any absorption takes place and [symbol] (m⁻¹) is the loss coefficient per unit length (other than three-photon absorption) which in general is very small and can be neglected. ΔN²³⁸(x,t) and ΔN²³⁵(x,t) are the respective molecular populations of the two isotopes at the position x and at time t during the interaction process. The energy flux [symbol] (x) (J/m²) of the pumping pulse radiation passing through an absorbing medium at the position x can be shown to be

$$\frac{d ( x )}{dx} = 3 h νΔ {N}_{o}^{238} [ {e}^{- \frac{{( {σ}_{03} )}_{238} ( x )}{h ν}} - 1 ] + 3 h νΔ {N}_{o}^{235} [ {e}^{- \frac{{( {σ}_{03} )}_{238} ( x )}{h ν}} - 1 ] - ℓ ( x ) \qquad ( 53 )$$

where (σ₀₃)₂₃₈ and (σ₀₃)₂₃₅ are the respective three-photon isotopic absorption cross sections in (m²) and hν is the energy of one photon in the pumping beam in (J). Eq. (53) describes the three photon absorption of a light pulse with energy flux [symbol] (J/m²) at the position x propagating through an absorbing medium consisting of two kinds of absorbing molecules ²³⁵UF₆ and ²³⁸UF₆.

By comparing the loss of energy content of the electromagnetic pulse per unit volume per unit time to the energy absorbed by the molecules of the interacting medium per unit volume per unit time as the pulse traverses a thin slab ox at the position x and at time (through the gas, it can be shown that the three-photon absorption cross sections (σ₀₃)₂₃₅ and (σ₀₃)₂₃₈ for the two isotopes are given by

$${( {σ}_{03} )}_{235} = {q}^{2} {K}_{w}^{235} ( ω ) {I}_{{ω}_{k}}^{2} ( x , t ) and {( {σ}_{02} )}_{238} = {q}^{2} {K}_{w}^{238} ( ω ) {I}_{{ω}_{k}}^{2} ( x , t ) \qquad ( 54 )$$

where

$${K}_{w}^{235} ( ω )$$

(s² m⁶) and

$${K}_{w}^{238} ( ω )$$

(s² m⁶) are given by eq. (47). Thus, for a particular frequency the absorption cross section is dependent on the square of the intensity I_{ω}_{ₖ}(x,t) at a particular position x and time t. In the case of a medium consisting of two isotopic species the transition rates in terms of the absorption cross sections are given by:

$${( {W}_{03} )}_{235} = {( {σ}_{03} )}_{235} {I}_{{ω}_{k}} ( x , t ) and {( {W}_{03} )}_{238} = {( {σ}_{03} )}_{238} {I}_{{ω}_{k}} ( x , t ) \qquad ( 55 )$$

with the following relations holding

$$\frac{{( {σ}_{03} )}_{235}}{{( {W}_{03} )}_{238}} = \frac{{( {W}_{03} )}_{235}}{{( {W}_{03} )}_{238}} = \frac{{q}_{235}^{2}}{{q}_{238}^{2}} \frac{{K}_{w}^{235} ( ω )}{{K}_{w}^{238} ( ω )} = \frac{{q}_{235}^{2}}{{q}_{238}^{2}} {\{ \frac{{( {Δω}_{2} {Δω}_{1} )}_{238}}{{( {Δω}_{2} {Δω}_{1} )}_{235}} \}}^{2} \qquad ( 56 )$$

By time integrating the intensity I(x) at a position x over the pulse length τ we obtain the equations describing the change in the molecular populations of the two isotopic species during the three photon absorption of a light pulse propagating through the molecular medium as

$$Δ {N}^{235} ( x , t ) = Δ {N}_{o}^{235} {e}^{- \frac{{q}_{235}^{2}}{{τ}^{2}} {K}_{w}^{235} ( ω ) {I}^{3} ( x )} and \\ Δ {N}^{238} ( x , t ) = Δ {N}_{o}^{238} {e}^{- \frac{{q}_{238}^{2}}{{τ}^{2}} {K}_{w}^{238} ( ω ) {I}^{3} ( x )} \qquad ( 57 )$$

By substituting the expressions for the three-photon absorption cross sections (54) and the expressions for the molecular populations (57) into the propagation equations (52) and (53) we obtain the absorption equation for the energy flux [symbol] in (J m⁻²) of a beam propagating through an absorbing medium consisting of two isotopic species during three-photon absorption resonance as

$$\frac{d ( x )}{dx} = 3 h νΔ {N}_{o}^{238} [ {e}^{- {q}_{238}^{2} {K}^{238} {3}^{} ( x )} - 1 ] + 3 h νΔ {N}_{o}^{235} [ {e}^{- {q}_{235}^{2} {K}^{235} {3}^{} ( x )} - 1 ] \qquad ( 58 )$$

$$where$$

$${K}^{235} = \frac{{K}_{w}^{235} ( ω )}{{( h ν )}^{3} {τ}^{2}} and {K}^{238} = \frac{{K}_{w}^{238} ( ω )}{{( h ν )}^{3} {τ}^{2}} \qquad ( 59 )$$

with

$${K}_{w}^{235} ( ω )$$

(s² m⁶) and

$${K}_{w}^{238} ( ω )$$

(s² m⁶) are given by eq. (47). For a strongly absorbing gas medium the loss term [symbol] can be considered negligible and has been dropped. It is recalled that I_{ω}_{ₖ}(x,t) is the photon intensity in (photons/m² s), I_{ω}_{ₖ}(x) is the photon flux in (photons/m²), I_{ω}_{ₖ} is the intensity in (J/m² s) and [symbol] is the energy flux in (J/m²). q₂₃₅ and q₂₃₈ are the ratios of the values of the power broadened curves at the position of the pumping frequency to the peaks of the respective absorption curves, at the third energy excitation level. Note the importance of the pulse length τ at a particular pumping intensity.

For the UF₆ molecule the fundamental constants are (see above): e [symbol] φ₁|r|φᵢ [symbol] =1.2864×10⁻³⁰ C m and g(ν_{f})_{3ν}_{₃}=0.763861505×10⁻¹⁰ s and on applying a pumping pulse of duration τ, we obtain from expressions (47) and (59) the exponential constants for the two isotopes in eq. (58) to be

$${K}^{235} = 3.229366505 \times {10}^{23} \frac{1}{{τ}^{2}} \frac{1}{{( {Δω}_{2} {Δω}_{1} )}_{235}^{2}} ( {m}^{6} / {J}^{3} ) \qquad ( 60 )$$

$${K}^{238} = 3.229366505 \times {10}^{23} \frac{1}{{τ}^{2}} \frac{1}{{( {Δω}_{2} {Δω}_{1} )}_{238}^{2}} ( {m}^{6} / {J}^{3} ) \qquad ( 61 )$$

The duration of the pumping pulse r defines the total pumping pulse energy density [symbol] (x) in eq. (58), thereby defining the intensity limits which can be applied to the UF₆ molecular gas in order that three-photon absorption resonance is established with the third energy level of the desired isotope ²³⁵UF₆ on the one hand, and the maximum intensity limit above which the quasicontinuum of energy states begins at the third energy level facilitating the escape of molecules to other vibrational modes and background states. In Table 22 we have listed the calculated values of

$$\frac{1}{{( {Δω}_{2} {Δω}_{1} )}_{238}^{2}} and \frac{1}{{( {Δω}_{2} {Δω}_{1} )}_{235}^{2}}$$

using the deviations Δω₁ and Δω₂ of the first and second energy excitation levels from exact resonance respectively during the three-photon absorption resonance with the third energy excitation level, for six different pumping frequencies. The frequency values used for the pumping beam are those used in Tables 20 and 21, for the calculation of the selectivity to the third energy excitation level of the UF₆ molecule. Note also that the values marked with a star are the minimum values possible and are limited by the effective values of the overall spread of the subbandheads from (Q_{A}-Q_{G}) as given in Table 10. Using Table 22 we can calculate the exponential constants K²³⁸ and K²³⁵ in the absorption

TABLE 22
The deviations from the first and second energy excitation levels from exact resonance during the
three-photon absorption resonance with the third energy excitation level for six different pumping

| | ²³⁸UF₆ | | | | ²³⁵UF₆ | | | |
|---|---|---|---|---|---|---|---|---|
| Pumping frequency ω | (Δω₁)₂₃₈ = (ω − ω₁)₂₃₈ [v̅₁ = 627.702] | (Δω₂)₂₃₈ = (2ω − ω₂)₂₃₈ [v̅₂ = 1255.67] | ${( Δ {ω}_{2} Δ {ω}_{1} )}_{238}^{2}$ | $\frac{1}{{( {Δω}_{2} {Δω}_{1} )}_{238}^{2}}$ | (Δω₁)²³⁵ = (ω − ω₁)²³⁵ [v₁ = 628.306] | (Δω₂)₂₃₅ = (2ω − ω₂)₂₃₅ [v₂ = 1256.88] | ${( Δ {ω}_{2} Δ {ω}_{1} )}_{235}^{2}$ | $\frac{1}{{( {Δω}_{2} {Δω}_{1} )}_{235}^{2}}$ |
| cm⁻¹ | s⁻¹ (×10¹¹) | s⁻¹ (×10¹¹) | s⁻⁴ (×10⁴²) | s⁴ (×10⁻⁴³) | s⁻¹ (×10¹⁰) | s⁻¹ (×10¹⁰) | s⁻⁴ (×10⁴²) | s⁴ (×10⁻⁴³) |
| | (cm⁻¹) | (cm⁻¹) | | | (cm⁻¹) | (cm⁻¹) | | |
| 628.306 | 1.13772555 | 1.77439978 | 407.547251 | 0.0245370322 | 1.88365157* | −5.0481862 | 0.904215345 | 11.05931242 |
| | (0.604) | (0.942) | | | (0.1)* | (−0.268) | | |
| 628.45 | 1.40897137 | 2.31689143 | 1065.65273 | 0.0093839200 | 2.712458257 | 1.88365157* | 0.261052147 | 38.30652273 |
| | (0.748) | (1.23) | | | (0.144) | (0.1)* | | |
| 628.49 | 1.48431744 | 2.46758355 | 1341.52049 | 0.0074542283 | 3.465918884 | 1.883651567 | 0.42622403 | 23.46184001 |
| | (0.788) | (1.31) | | | (0.184) | (0.1) | | |
| 628.527 | 1.55401254 | 2.606973777 | 1641.27882 | 0.0060928100 | 4.162869964 | 3.277553727 | 1.861595537\| | 5.37173613 |
| | (0.825) | (1.384) | | | (0.221) | (0.174) | | |
| 628.56 | 1.61617305 | 2.73129477 | 1948.55588 | 0.0051320057 | 4.784474981 | 4.520763762 | 4.678344532 | 2.137508243 |
| | (0.858) | (1.45) | | | (0.254) | (0.24) | | |
| 628.6 | 1.69151911 | 2.8819869 | 2376.50001 | 0.0042078687 | 5.537935608 | 6.027685015 | 11.14286586 | 0.8974352 |
| | (0.898) | (1.53) | | | (0.294) | (0.32) | | |

*the values marked with an asterix are the minimum values possible as limited by the effective values of the overall spread of the subbandheads from (Q_{A} − Q_{G}) as described in the text.

TABLE 23
The exponential constants K²³⁸ and K²³⁵ in cq. (58) for the
two Uranium Hexafluoride isotopes for various pumping pulse
durations τ and for six different pumping frequencies

| | 628.306 cm⁻¹ | | 628.45 cm⁻¹ | | 628.49 cm⁻¹ |
|---|---|---|---|---|---|
| τ | K²³⁸ | K²³⁵ | K²³⁸ | K²³⁵ | K²³⁸ |
| (×10⁹) | (×10⁻⁷) | (×10⁻⁴) | (×10⁻⁷) | (×10⁻⁴) | (×10⁻⁷) |
| s | m⁶/J³ | m⁶/J³ | m⁶/J³ | m⁶/J³ | m⁶/J³ |
| 10 | 79.2390699 | 35.7145731 | 30.304117 | 123.70580 | 24.0724352 |
| 20 | 19.8097675 | 8.92864327 | 7.5760292 | 30.926450 | 6.01810880 |
| 30 | 8.80434112 | 3.96828590 | 3.3671241 | 13.745089 | 2.67471502 |
| 40 | 4.95244187 | 2.23216082 | 1.8940073 | 7.7316126 | 1.50452720 |
| 50 | 3.1695628 | 1.42858292 | 1.2121647 | 4.9482321 | 0.96289740 |
| 60 | 2.20108528 | 0.99207148 | 0.84178103 | 3.4362723 | 0.66867876 |
| 80 | 1.23811047 | 0.55804021 | 0.47350183 | 1.9329031 | 0.37613180 |
| 100 | 0.7923907 | 0.35714573 | 0.30304117 | 1.2370580 | 0.24072435 |

| | 628.49 cm⁻¹ | 628.527 cm⁻¹ | | 628.6 cm⁻¹ | |
|---|---|---|---|---|---|
| τ | K²³⁵ | K²³⁸ | K²³⁵ | K²³⁸ | K²³⁵ |
| (×10⁹) | (×10⁻⁴) | (×10⁻⁷) | (×10⁻⁴) | (×10⁻⁷) | (×10⁻⁴) |
| s | m⁶/J³ | m⁶/J³ | m⁶/J³ | m⁶/J³ | m⁶/J³ |
| 10 | 75.7668802 | 19.6759165 | 17.3473047 | 13.5887502 | 2.898147 |
| 20 | 18.9417200 | 4.91897913 | 4.33682618 | 3.39718756 | 0.7245368 |
| 30 | 8.41854225 | 2.18621295 | 1.92747830 | 1.50986114 | 0.3220164 |
| 40 | 4.73543002 | 1.22974478 | 1.08420655 | 0.84929689 | 0.1811342 |
| 50 | 3.03067521 | 0.78703666 | 0.69389219 | 0.54355001 | 0.1159259 |
| 60 | 2.10463556 | 0.54655324 | 0.48186958 | 0.37746528 | 0.08050409 |
| 80 | 1.18385750 | 0.3074362 | 0.27105164 | 0.21232422 | 0.04528355 |
| 100 | 0.75766880 | 0.19675917 | 0.17347305 | 0.13588750 | 0.02898147 |

TABLE 24
The ratio of the exponential constants (K²³⁵/K²³⁸) in eq. (58) for the two Uranium
Hexafluoride isotopes for the six different pumping frequencies in Table 23

| 628.306 cm⁻¹ | 628.45 cm⁻¹ | 628.49 cm⁻¹ | 628.527 cm⁻¹ | 628.527 cm⁻¹ | 628.6 cm⁻¹ |
|---|---|---|---|---|---|
| K²³⁵/K²³⁸ | K²³⁵/K²³⁸ | K²³⁵/K²³⁸ | K²³⁵/K²³⁸ | K²³⁵/K²³⁸ | K²³⁵/K²³⁸ |
| 450.72 | 4082.15 | 3147.45 | 881.65 | 416.505 | 213.28 |

eq. (58) from eqs. (60) and (61) for the two Uranium Hexafluoride isotopes for various pumping pulse durations τ. The results are listed in Table 23 for five different pumping frequencies, the same frequencies used for the selectivity calculations to the third energy excitation level in Tables 20 and 21. From eqs. (60) and (61) it is evident that the ratio of the exponential constants (K²³⁵/K²³⁸) is independent of the pulse length but it is different for the various pumping frequencies. Table 24 summarizes the ratio of the exponential constants. (K²³⁵/K²³⁸) for the two Uranium Hexafluoride isotopes for the five pumping frequencies in Table 23.

We have investigated eq. (58) for the case when both exponential factors are much less than unity i.e.

$${q}_{238}^{2} {K}^{238} ( x ) ≪ 1 and {q}_{235}^{2} {K}^{235} ( x ) ≪ 1 \qquad ( 62 )$$

The solution to the equation turns out to be

$$\frac{1}{( L )} = \frac{1}{} + 6 h ν [ Δ {N}_{o}^{238} {q}_{238}^{2} {K}^{238} + Δ {N}_{o}^{235} {q}_{235}^{2} {K}^{235} ] L \qquad ( 63 )$$

subject to the additional conditions that

$$\frac{- ( L )}{} ≪ 1 and 139.85 \times \frac{{[ {q}_{238}^{2} {K}^{238} {0}_{3}^{} ]}^{2}}{2} ≪ {q}_{235}^{2} {K}^{235} {0}_{3}^{} \qquad ( 64 )$$

where [symbol] (J/m²) is the initial beam energy flux and L is the length traversed by the pumping pulse through the gas. Because of the conditions (62) and (64) restricting the excitation of the molecules to very small numbers, the same results for the percentages of the excited molecules for the two isotopes should be reachable through the absorption cross section expression (54).

The results in this case are

$$\frac{Δ {N}_{excited}^{235}}{{N}_{o}^{excited}} = \frac{( )}{{( + )}_{total}} and \frac{Δ {N}_{excited}^{238}}{{N}_{o}^{excited}} = \frac{( )}{{( + )}_{total}} \qquad ( 65 )$$

It is not of the present to give an account of the theoretical development and the extensive analysis carried out, but the results were fully compatible in both cases. Although we have carried out a complete investigation of the solution of eq. (58) under the conditions (62) the results have shown that they are of no particular practical use. In the frequency region near the three-photon resonance with the third energy excitation level there is a very limited range of pumping intensities, between 1.0×10⁹ W/m² and 1.5×10⁹ W/m² at very short pulse durations, over which eq. (58) can be applied. Although very high selectivity to the third energy excitation level can be achieved the number of molecules of the desired isotope which can be excited is very small for any practical application. The pulse duration is also very short, much shorter than the pulse durations used in the hitherto applied prototype experiments and moreover at these low pumping intensities three-photon resonance with the third energy level may be very difficult to achieve although at the frequency of the fundamental there is a substantial spread of pumping intensities (0.5×10⁹ W/m² to 2.0×10⁹ W/m²) for which eq. (58) holds. At the other frequencies pumping intensities are very low rendering the establishment of three-photon resonance very difficult to achieve as well as inhibiting the elevation of large numbers of molecules to the third energy excitation level. At the pumping frequency of the fundamental the number of molecules of the desired isotope ²³⁵UF₆ elevated to the third energy level is extremely small rendering it a non-viable proposition. We have carried an extensive analysis of this case (condition (62)) in order to demonstrate the validity of the theory of the three-photon absorption process in selectively elevating the molecules of the desired isotope ²³⁸UF₆ to the third energy excitation level. It has demonstrated the compatibility of all the results, obtained through different procedures. No presentation of the complete analysis is necessary here.

Following eq. (18) for an equivalent two-level system between the ground and the first energy excitation level of Uranium Hexafluoride (i.e. substituting the parameters for the fundamental transition of the ν₃-vibrational mode into eq. (18)), the induced transition rate becomes (W₀₁)_{UF}_{₆}=3.0017 I_{ω}_{ₖ}. This is a straight line proportionality between the equivalent two-level transition rate for the UF₆ fundamental and the pumping beam intensity. The three-photon induced transition rates for the two Uranium Hexafluoride isotopes are given by expressions (50) and (51). Table 22 gives the various frequency terms for the two isotopes in the two expressions for various pumping frequencies. The values of q₂₃₅ and g₂₃₈ for various pumping intensities at the particular pumping frequencies are obtained from Tables such as 20 and the graphs such as in FIG. 8(a),(b), FIG. 9 and FIG. 11. The three-photon transition rates for the two Uranium Hexafluoride isotopes as functions of the intensity of the pumping beam for various frequencies have been calculated and some of the results are tabulated in Table 25 where the equivalent two level transition rate has also been registered for comparison. A comparison of the results is self-evident and the right conclusions can be drawn. The procedure has been repeated for many pumping frequencies and intensities and the results have been plotted and analysed. We will not present

TABLE 25
Three-photon transition rates for the two Uranium Hexafluoride isotopes as a
function of the intensity of the pumping beam for three different frequencies

| Pumping | Two level | | | | | | |
|---|---|---|---|---|---|---|---|
| Intensity | transition | 628.306 cm⁻¹ | | 628.49 cm⁻¹ | | 628.527 cm⁻¹ | |
| I_{ω}_{ₖ} | (W₀₁)_{UF}_{₆} | (W₀₃)/₂₃₅ | (W₀₃)₂₃₈ | (W₀₃)/₂₃₅ | (W₀₃)₂₃₈ | (W₀₃)/₂₃₅ | (W₀₃)₂₃₈ |
| (W/m²) | s⁻¹ | s⁻¹ | s⁻¹ | s⁻¹ | s⁻¹ | s⁻¹ | s⁻¹ |
| 5.00E+08 | 1.50085E+09 | 7.54470357E+05 | 0.00000000E+00 | 8.98443666E+06 | 0.00000000E+00 | 2.16841309E+07 | 0.00000000E+00 |
| 1.00E+09 | 3.00170E+09 | 1.95558717E+05 | 1.33914028E+00 | 1.89417201E+08 | 1.62729662E+00 | 1.73473047E+08 | 7.48176726E−01 |
| 1.50E+09 | 4.50255E+09 | 6.6566384E+05 | 1.01690965E+01 | 9.20567595E+08 | 1.23572837E+01 | 5.85471535E+08 | 4.48906036E+00 |
| 2.50E+09 | 7.50425E+09 | 1.50894071E+07 | 1.26782512E+02 | 5.96782568E+09 | 1.58915685E+02 | 2.71051636E+09 | 4.91897913E+01 |
| 5.00E+09 | 1.50085E+10 | 4.20048023E+08 | 6.33912559E+03 | 6.21383127E+10 | 6.7703724E+03 | 2.16841309E+10 | 3.84295245E+03 |
| 1.00E+10 | 3.00170E+10 | 1.15715217E+10 | 4.37597763E+05 | 5.56469094E+11 | 2.46501736E+05 | 1.73473047E+11 | 1.54259186E+05 |
| 1.50E+10 | 4.50255E+10 | 7.65456161E+10 | 2.82474903E+06 | 2.17377718E+12 | 1.67826902E+06 | 5.85471535E+11 | 1.06249949E+06 |
| 2.00E+10 | 6.00340E+10 | 2.65787853E+11 | 1.11822175E+07 | 5.35580923E+12 | 6.93286133E+06 | 1.38778438E+12 | 4.38999781E+06 |
| 3.00E+10 | 9.00510E+10 | 1.54286956E+12 | 8.76320722E+07 | 1.84624946E+13 | 5.1482995E+07 | 4.68377228E+12 | 3.39999838E+07 |
| 4.00E+10 | 1.20068E+11 | 4.83661035E+12 | 3.57830961E+08 | 4.46891244E+13 | 2.01276217E+08 | 1.11022750E+13 | 1.29221220E+08 |
| 5.00E+10 | 1.50085E+11 | 1.23047865E+13 | 1.03050410E+09 | 8.81950163E+13 | 5.89774662E+08 | 2.16841309E+13 | 3.96691072E+08 |
| 6.00E+10 | 1.80102E+11 | 2.46261267E+13 | 2.58942504E+09 | 1.55256957E+14 | 1.36459518E+09 | 3.74701782E+13 | 9.30919555E+08 |
| 8.00E+10 | 2.40136E+11 | 7.37331647E+13 | 1.06472968E+10 | 3.77523113E+14 | 5.06404416E+09 | 8.88182002E+13 | 3.60236729E+09 |

any further analysis here but the important point to note from the tables is that, for the ²³⁸UF₆ isotope, the three-photon transition rate (W₀₃)₂₃₅ to the third energy excitation level m(A₂):(3ν₃) at the pumping frequency of the fundamental 628.306 cm⁻¹ is much lower than the three-photon transition rate at a pumping frequency in the region of the exact three-photon resonance with the third energy excitation level 628.527 cm⁻¹. This is even more so for some of the pumping frequencies slightly lower than 628.527 cm⁻¹ (for example 628.49 cm⁻¹) and for intensities lower than 60×10⁹ W/m². At pumping intensities between 5×10⁹ W/m² and 20×10⁹ W/m² it is nearly two orders of magnitude greater. In addition, the three-photon transition rate (W₀₃)₂₃₈ for the unwanted isotope to the third energy excitation level at the pumping frequency 628.306 cm⁻¹ is higher than the three-photon transition rate at a pumping frequency in the region of 628.527 cm⁻¹. The preferential excitation of the desired isotope ²³⁵UF₆ to the third energy excitation level can thus be seen to be greatly enhanced at a pumping frequency in the region of 628.527 cm⁻¹, by comparison to pumping at the frequency of the fundamental at 628.306 cm⁻¹. The results concerning the three-photon transition rates have been graphically depicted and extensively analysed. An example is shown in FIG. 13 where the three-photon transition rate is plotted against intensity for six different pumping frequencies. The broken vertical lines on the graphs indicate the intensity level at which the three-photon transition rate to the third energy excitation level, exceeds the equivalent two-level transition rate with the same transition parameters. The dotted vertical lines on the graphs indicate the intensity level at which the selectivity of the desired isotope UF₆ to the third energy excitation level remains very high. It is evident that at the pumping frequency of the fundamental (628.306 cm⁻¹, graph (a)) the intensity at which the three-photon transition rate exceeds that of the equivalent two-level system (broken vertical line) is much higher than the intensity level at which substantial selectivity of the desired isotope to the third energy excitation level can be achieved (dotted vertical line). Subsequently, with the three-photon transition rate being very low and the available pumping intensity range being very limited it is extremely difficult to achieve any considerable selectivity of the desired isotope to the third energy excitation level. The optimum frequency range for achieving high selectivity of the desired isotope ²³⁸UF₆ is between 628.45 cm⁻¹ and 628.527 cm⁻¹ both from the point of view of the effective transition rate to the third energy level and the intensity range over which high selectivity to the third energy excitation level can be achieved 5×10⁹ W/m² to 20×10⁹ W/m (graphs (b), (c) and (d)). It is evident from the graphs of FIG. 13(a)-(f) that the establishment of three photon resonance with the third energy level of the unwanted isotope ²³⁸UF₆ is much more difficult to achieve than with the desired isotope ²³⁵UF₆. It is clear that whilst the induced transition rate for the desired isotope ²³⁵UF₆ takes off to enormous values the corresponding transition rate for the unwanted isotope isotope ²³⁸UF₆ remains extremely low. Many graphical analyses of the three-photon transition rates have been made but no more results will be presented in the short space available here.

According to eq. (58) during the three photon absorption process there is a cubic dependence of the energy flux. Since the frequency of the applied beam is always on the higher frequency side of the fundamental of the ²³⁵UF₆ isotope, then (Δω₂ Δω₁)₂₃₈>>(Δω₂ Δω₁)₂₃₅, Δω₂ and Δω₁ being the deviations in s⁻¹ of the applied frequency from levels 2 and 1 respectively. Then from eqs. (50) and (51) it is evident that K²³⁸<<K²³⁵. This is also clear from the analytical values in Tables 24 and 25. Because of the cubic dependence of the energy flux and this relation of the exponential constants, as the input pumping power is increased there arises a situation where the exponential factors in eq. (58) are simultaneously in the regions governed by

$${q}_{238}^{2} {K}^{238} ( x ) ≪ 1 and {q}_{235}^{2} {K}^{235} ( x ) ≫ 1 \qquad ( 66 )$$

Under these conditions eq. (58) becomes

$$\frac{d ( x )}{dx} = - 3 h ν Δ {N}_{o}^{238} {q}_{238}^{2} {K}^{238} ( x ) - 3 h ν Δ {N}_{o}^{235} \qquad ( 67 )$$

where the requirement has been imposed that the second order term in the expansion of the exponential of the unwanted isotope is always much less than the first order term of the desired isotope

$$\frac{Δ {N}_{o}^{238}}{Δ {N}_{o}^{235}} \frac{{[ {q}_{238}^{2} {K}^{238} ( x ) ]}^{2}}{2} ≪ 1 \qquad ( 68 )$$

with

$$( Δ {N}_{o}^{238} / Δ {N}_{o}^{235} ) = 139.85$$

being the ratio of the numbers of molecules per unit volume of the two isotopes. Inequality (68) gives

$${q}_{238}^{2} {K}^{238} \leq 0.1196 .$$

We take the value of this exponential to be 33% of this maximum value i.e.

$${q}_{238}^{2} {K}^{238} \leq 0.04$$

for eq. (67) to be strictly applicable. The reason for choosing such a small percentage value for the ratio of the second term in the expansion of the exponential term of the undesired isotope to the overall term of the desired isotope is because the percentage grows very rapidly with small changes in the value of the exponential coefficient

$${q}_{238}^{2} {K}^{238} ( x ) .$$

Our choice means that the second term in the expansion of the exponential of the term corresponding to the unwanted isotope ²³⁸UF₆ is less than 5% of the exponential term corresponding to the desired isotope in eq. (58), i.e. of the population of the desired isotope. In practice, and as a consequence of the results in FIG. 13 much higher values can be employed. For higher values eq. (67) is also applicable but we wanted to employ exclusively strictly applicable conditions. A complete analysis of the applicability conditions has been made but it is beyond the scope of the present account. Furthermore, eq. (68) is also subjected to the condition that as the beam energy flux [symbol] (x) travels through the absorbing medium it does not fall below a value which does not satisfy conditions (66) and (67). In practice this is satisfied in most cases because

$$\frac{- ( L )}{} ≪ 1 \qquad ( 69 )$$

We must also consider that for the second of in eq. (66) to hold together with inequality (69) the exponential term for the desired isotope must be greater than

$${q}_{235}^{2} {K}^{235} > 3 \qquad ( 70 )$$

This means that more than 95% of the molecules of the desired isotope ²³⁵UF₆ are elevated to the third energy excitation level.

Separating the variables in eq. (67) and integrating we arrive at the expression

$$ln ( \frac{{( ( L ) + α )}^{2}}{( L ) - α ( L ) + {α}^{2}} ) = \{ ln ( \frac{{( + α )}^{2}}{- α + {α}^{2}} ) + 2 \sqrt{3} {tan}^{- 1} ( \frac{2 - α}{α \sqrt{3}} ) - 18 {α}^{2} h ν Δ {N}_{◦}^{238} {q}_{238}^{2} {K}^{238} L \} - 2 \sqrt{3} {tan}^{- 1} ( \frac{2 ( L ) - α}{α \sqrt{3}} ) \qquad ( 71 )$$

where L (m) is the interacting length of the expansion supercooled UF₆ molecular gas, hv (J) is the quantum energy of one photon, [symbol] (J/m²) is the initial energy flux of the electromagnetic beam at the beginning of the molecular gas, [symbol] (J/m²) and [symbol] (L) (J/m²) are the energy fluxes of the electromagnetic beam, at a distance x and at the output/respectively along the length of the expansion supercooled UF₆ molecular gas,

$$Δ {N}_{◦}^{238}$$

(molecules/m³) is the ground state population density of the ²³⁸UF₆ isotope in the expansion supercooled molecular gas, K²³⁸ (m⁶/J³) is the exponential constant for the ²³⁸UF₆ isotope defined in terms of the interaction parameters by eqs. (47) and (59), 4238 (dimensionless) is the ratio of the power broadened curve of the ²³⁸UF₆ isotope at the position of the pumping frequency to the peak of its respective absorption curve at the third energy excitation level

$$α = {( \frac{Δ {N}_{◦}^{235}}{{q}_{238}^{2} {K}^{238} Δ {N}_{◦}^{238}} )}^{\frac{1}{3}}$$

(J/m²) is a constant resulting from the initial parameters of the expansion supercooled UF₆ molecular gas and the applied electromagnetic beam and

$$Δ {N}_{◦}^{235}$$

(molecules/m³) is the ground stare population density of the ²³⁵UF₆ isotope in the expansion supercooled molecular gas. Conditions (66), (67) and (70) could be relaxed much more with relation (71) remaining valid allowing for much bigger flexibility of the interaction parameters, but we opted for the strictest conditions in order to ensure that there is still a wide range of applicable parameters.

Eq. (71) governs the absorption of energy from the electromagnetic beam as it traverses the length L of the UF₆ molecular gas, under the validity of the conditions (66), (68), (69) and (70). In this case all the ²³⁵UF₆ molecules are excited to the third energy level whilst only a very small fraction of the ²³⁸UF₆ molecules are excited. The expression in the brackets on the right-hand side of equation (71) is a constant depending only on the initial parameters of the interaction process. In order to solve equation (71) and find the value of [symbol] (L) for a particular set of values of the initial parameters we have to: (i) Plot the left hand side expression as a function of [symbol] (Z) covering a big interval of values; (ii) Plot the right-hand side as a function of [symbol] (L) covering a big interval of values; (iii) Locate the crossing point of the two curves; (iv) The value of [symbol] (L) at the crossing point of the two curves is the solution of eq. (71) for the particular parameters chosen as the initial conditions; (v) Subsequently, we may change the initial parameters and find the value of [symbol] (L) for any set of initial conditions; (vi) From the values of [symbol] (L) we can find the values of molecules absorbed by each isotope for any set of initial parameters and conditions and subsequently the selectivity to the third energy excitation level. The exponential factors in inequalities (66) have been calculated for a variety of initial conditions using the values of: (a) The ratios of the power broadened curves q₂₃₈ and q₂₃₅ for various pumping intensities at particular pumping frequencies obtained from tables such as Table 20 and graphs such as 8(b), 9 and 11, previously described; (b) The exponential constants K²³⁵ and K²³⁸ for the various pumping pulse durations at particular pumping frequencies obtained from tables such as Table 23 previously described. The results are tabulated and the particular values of the two exponential factors for which eq. (71) is readily and effectively applicable for a particular pumping frequency have been selected so that inequalities (66), (69) and (70) are duly satisfied. One such example is shown in Table 26 for a pumping frequency of 628.527 cm⁻¹ from which it is seen that inequalities (66), (69) and (70) are only satisfied for pumping intensities between 1.5×10⁹ W/m² to 20×10⁹ W/m² only at the corresponding pulse durations given in the table.

An extensive analysis of the results, which cannot be presented here, indicates some very interesting points which are very briefly summarized here. When pumping at the frequency of the fundamental of the desired ²³⁸UF₆ isotope at 628.306 cm⁻¹ selectivity to the third energy excitation level is very difficult to achieve due to the extremely limited intensity range for which the propagation absorption equation (71) may be applicable (only an extremely narrow

TABLE 26
Exponential terms valid for the application of the propagation absorption equation (71) for the
particular interaction parameters
Pumping frequency: vₖ = 628.527 cm⁻¹ = 1.884276542 × 10¹³ s⁻¹

| Initial beam | Initial beam | duration | | | | | | |
|---|---|---|---|---|---|---|---|---|
| Intensity | Energy flux | Pulse | | | | | | |
| I_{ω}_{ₖ} | Eₒ | τ | q²³⁸ | q²³⁵ | K²³⁸ | K²³⁵ | ${q}_{238}^{2} {K}^{238} {E}_{o}^{3}$ | ${q}_{235}^{2} {K}^{235} {E}_{o}^{3}$ |
| (W/m²) | (J/m²) | ×10⁻⁹ s | (dimensionless) | (dimensionless) | (m⁶/J³) | (m⁶/J³) | (dimensionless) | (dimensionless) |
| 1.50E+09 | 1.50E+01 | 10 | 0.0026 | 1.00 | 1.9675917E−06 | 1.7347305E−03 | 4.489E−08 | 5.855E+00 |
| 1.50E+09 | 3.00E+01 | 20 | 0.0026 | 1.00 | 4.9189791E−07 | 4.3368262E−04 | 8.978E−08 | 1.171E+01 |
| 1.50E+09 | 4.50E+01 | 30 | 0.0026 | 1.00 | 2.186213E−07 | 1.9274783E−04 | 1.347E−07 | 1.756E+01 |
| 1.50E+09 | 6.00E+01 | 40 | 0.0026 | 1.00 | 1.2297448E−07 | 1.0842066E−04 | 1.7956E−07 | 2.3419E+01 |
| 1.50E+09 | 7.50E+01 | 50 | 0.0026 | 1.00 | 7.8703666E−08 | 6.9389219E−05 | 2.6934E−07 | 3.5128E+01 |
| 1.50E+09 | 9.00E+01 | 60 | 0.0026 | 1.00 | 5.4655324E−08 | 4.8186958E−05 | 2.6934E−07 | 3.5128E+01 |
| 1.50E+09 | 1.20E+02 | 80 | 0.0026 | 1.00 | 3.0743620E−08 | 2.7105164E−05 | 3.5912E−07 | 4.6838E+01 |
| 1.50E+09 | 1.50E+02 | 100 | 0.0026 | 1.00 | 1.9675917E−08 | 1.7347305E−05 | 4.4891E−07 | 5.8547E+01 |
| 2.50E+09 | 2.50E+01 | 10 | 0.0040 | 1.00 | 1.9675917E−06 | 1.7347305E−03 | 4.919E−07 | 2.711E+01 |
| 2.50E+09 | 5.00E+01 | 20 | 0.0040 | 1.00 | 4.9189791E−07 | 4.3368262E−04 | 9.838E−07 | 5.421E+01 |
| 2.50E+09 | 7.50E+01 | 30 | 0.0040 | 1.00 | 2.186213E−07 | 1.9274783E−04 | 1.476E−06 | 8.132E+01 |
| 2.50E+09 | 1.00E+02 | 40 | 0.0040 | 1.00 | 1.2297448E−07 | 1.0842066E−04 | 1.9676E−06 | 1.0842E+02 |
| 2.50E+09 | 1.25E+02 | 50 | 0.0040 | 1.00 | 7.8703666E−08 | 6.9389219E−05 | 2.459E−06 | 1.355E+02 |
| 2.50E+09 | 1.50E+02 | 60 | 0.0040 | 1.00 | 5.4655324E−08 | 4.8186958E−05 | 2.9514E−06 | 1.6263E+02 |
| 2.50E+09 | 2.00E+02 | 80 | 0.0040 | 1.00 | 3.0743620E−08 | 2.7105164E−05 | 3.9352E−06 | 2.1684E+02 |
| 2.50E+09 | 2.50E+02 | 100 | 0.0040 | 1.00 | 1.9675917E−08 | 1.7347305E−05 | 4.9190E−06 | 2.7105E+02 |
| 5.00E+09 | 5.00E+01 | 10 | 0.0125 | 1.00 | 1.9675917E−06 | 1.7347305E−03 | 3.843E−05 | 2.168E+02 |
| 5.00E+09 | 1.00E+02 | 20 | 0.0125 | 1.00 | 4.9189791E−07 | 4.3368262E−04 | 7.686E−05 | 4.337E+02 |
| 5.00E+09 | 1.50E+02 | 30 | 0.0125 | 1.00 | 2.186213E−07 | 1.9274783E−04 | 1.153E−04 | 6.505E+02 |
| 5.00E+09 | 2.00E+02 | 40 | 0.0125 | 1.00 | 1.2297448E−07 | 1.0842066E−04 | 1.5372E−04 | 8.6737E+02 |
| 5.00E+09 | 2.50E+02 | 50 | 0.0125 | 1.00 | 7.8703666E−08 | 6.9389219E−05 | 1.921E−04 | 1.084E+03 |
| 5.00E+09 | 3.00E+02 | 60 | 0.0125 | 1.00 | 5.4655324E−08 | 4.8186958E−05 | 2.3058E−04 | 1.3010E+03 |
| 5.00E+09 | 4.00E+02 | 80 | 0.0125 | 1.00 | 3.0743620E−08 | 2.7105164E−05 | 3.0744E−04 | 1.7347E+03 |
| 5.00E+09 | 5.00E+02 | 100 | 0.0125 | 1.00 | 1.9675917E−08 | 1.7347305E−05 | 3.8430E−04 | 2.1684E+03 |
| 1.00E+10 | 1.00E+02 | 10 | 0.0280 | 1.00 | 1.9675917E−06 | 1.7347305E−03 | 1.543E−03 | 1.735E+03 |
| 1.00E+10 | 2.00E+02 | 20 | 0.0280 | 1.00 | 4.9189791E−07 | 4.3368262E−04 | 3.085E−03 | 3.469E+03 |
| 1.00E+10 | 3.00E+02 | 30 | 0.0280 | 1.00 | 2.186213E−07 | 1.9274783E−04 | 4.628E−03 | 5.204E+03 |
| 1.00E+10 | 4.00E+02 | 40 | 0.0280 | 1.00 | 1.2297448E−07 | 1.0842066E−04 | 6.1704E−03 | 6.9389E+03 |
| 1.00E+10 | 5.00E+02 | 50 | 0.0280 | 1.00 | 7.8703666E−08 | 6.9389219E−05 | 7.713E−03 | 8.674E+03 |
| 1.00E+10 | 6.00E+02 | 60 | 0.0280 | 1.00 | 5.4655324E−08 | 4.8186958E−05 | 9.2556E−03 | 1.0408E+04 |
| 1.00E+10 | 8.00E+02 | 80 | 0.0280 | 1.00 | 3.0743620E−08 | 2.7105164E−05 | 1.2341E−02 | 1.3878E+04 |
| 1.00E+10 | 1.00E+03 | 100 | 0.0280 | 1.00 | 1.9675917E−08 | 1.7347305E−05 | 1.5426E−02 | 1.7347E+04 |
| 1.50E+10 | 1.50E+02 | 10 | 0.0400 | 1.00 | 1.9675917E−06 | 1.7347305E−03 | 1.062E−02 | 5.855E+03 |
| 1.50E+10 | 3.00E+02 | 20 | 0.0400 | 1.00 | 4.9189791E−07 | 4.3368262E−04 | 2.125E−02 | 1.171E+04 |
| 1.50E+10 | 4.50E+02 | 30 | 0.0400 | 1.00 | 2.186213E−07 | 1.9274783E−04 | 3.187E−02 | 1.756E+04 |
| 1.50E+10 | 6.00E+02 | 40 | 0.0400 | 1.00 | 1.2297448E−07 | 1.0842066E−04 | 4.2500E−02 | 2.3419E+04 |
| 1.50E+10 | 7.50E+02 | 50 | 0.0400 | 1.00 | 7.8703666E−08 | 6.9389219E−05 | 5.312E−02 | 2.927E+04 |
| 2.00E+10 | 2.00E+02 | 10 | 0.0540 | 1.00 | 1.9675917E−06 | 1.7347305E−03 | 4.590E−02 | 1.388E+04 |

range in the region of 5×10⁹ W/m²). Furthermore, because the probability absorption resonance at the third energy excitation level is very poor (FIGS. 8(a) and 13(a)), the three-photon absorption resonance is very difficult to establish and the number of the selectively excited molecules to the third energy excitation level will be very limited. For pumping frequencies in the region of the three-photon absorption resonance we observe that there is a wide range of pumping intensities for which the propagation absorption equation (71) can be applicable, reaching intensities of 20×10⁹ W/m² for short pulse durations, less than 20×10⁻⁹ s. This can be seen from the example of Table 26. It was observed that as the pulse durations become shorter, higher pumping intensities can be applied for which the propagation absorption equation (71) is readily applicable. This is because three-photon resonance with the third energy excitation level can readily be established with nearly all the molecules of the desired ²³⁵UF₆ isotope being selectively elevated to the third energy excitation level. In general, even higher pumping intensities (more than 20×10⁹ W/m²) can be applied in the frequency region of exact three-photon resonance with the m(A₂):(3ν₃) sublevel of the third energy excitation state, making the establishment of three-photon absorption resonance readily available. The selectivity to the third energy level will, however, be lower and eq. (71) will not be strictly applicable. It is unlikely that intensities over 50×10⁹ W/m² can be applied, otherwise the quasicontinuum of energy states may set in from the third energy excitation state of the ²³⁵UF₆ molecule, facilitating the escape of the excited molecules to other vibrational modes and background states Table 13. The regions of the pumping intensities investigated are those for which the propagation absorption eq. (71) is strictly applicable. Thus, the optimum absorption to the third energy excitation level is a compromise between the frequency deviations (Δω₂ Δω₁), the absorption coefficients K²³⁸ and K²³⁵, and the intensity and pulse duration of the pumping beam, in the frequency region of 628.527 cm⁻¹ (exact three-photon resonance with the m(A₂):(3ν₃) sublevel of the third energy excitation state). The main conclusions to be drawn from our analysis are: (i) Pumping at the frequency of the fundamental of the desired ²³⁵UF₆ isotope at 628.306 cm⁻¹ cannot selectively elevate large numbers of molecules to the third energy excitation state, thereby greatly inhibiting the selectivity and dissociation process in a molecular laser isotope separation process; (ii) Pumping at a frequency very near the exact three-photon resonance with the m(A₂):(3ν₃) sublevel of the third energy excitation state at 628.527 cm⁻¹, will selectively elevate all the molecules of the desired ²³⁵UF₆ isotope to the third energy excitation state when the pumping intensity is within a certain range. This optimum intensity range is between 5×10⁹ W/m² and 30×10⁹ W/m²; (ii) The molecules can then be selectively driven to dissociation by the simultaneous application of dissociating lasers at suitably adjusted frequencies and pumping intensities, through the higher vibrational levels of the ν₃-vibrational mode of the ²³⁵UF₆ isotope, or by any other dissociation or separation process. The available ranges of pumping intensities at the particular pumping frequencies, which can be applied to the supercooled UF₆ gas at a particular pumping pulse duration where eq. (71) remains perfectly applicable have been summarized. As a safety measure we consider the lower intensity level for the ready setting up of the three-photon absorption resonance for the ²³⁵UF₆ molecule to be that at which the three-photon transition rate exceeds that of the equivalent two-photon transition rate with the same interaction parameters. From analytical calculations, such as those in Table 25 we have obtained the intensity values at which the three photon transition rate exceeds the equivalent two-photon transition rate with the same interaction parameters at the various frequencies. Finally we have tabulated the intensity ranges for which eq. (71) is applicable an example of which is Table 27. The conclusions from the table are clear: (i) It is difficult to establish three-photon absorption resonance at the pumping frequency of the fundamental at 628.306 cm⁻¹; (ii) The optimum pumping frequencies for readily establishing three-photon absorption resonance are those between 628.45 cm⁻¹ and 628.527 cm⁻¹. In this frequency range the optimum pumping intensities are between 5×10⁹ W/m² and 20×10⁹ W/m²;

TABLE 27
The range of pumping intensities which can be applied to the supercooled UF₆ gas
at a particular pumping pulse duration where eq. (71) is perfectly applicable

| | Pumping Frequency (cm⁻¹) | | | | | |
|---|---|---|---|---|---|---|
| | 628.306 | 628.45 | 628.49 | 628.527 | 628.56 | 628.6 |
| Pulse | Intensity | Intensity | Intensity | Intensity | Intensity | Intensity |
| duration | range | range | range | range | range | range |
| ×10⁻⁹ s | ×10⁹ W/m² | ×10⁹ W/m² | ×10⁹ W/m² | ×10⁹ W/m² | ×10⁹ W/m² | ×10⁹ W/m² |
| 10 | / | 4-15 | 3.5-15 | 4.5-20 | 8-20 | 14-20 |
| 20 | / | 4-15 | 3.5-15 | 4.5-15 | 8-15 | 14-20 |
| 30 | / | 4-10 | 3.5-15 | 4.5-15 | 8-15 | 14-20 |
| 40 | / | 4-10 | 3.5-10 | 4.5-15 | 8-15 | 14-15 |
| 50 | / | 4-10 | 3.5-10 | 4.5-15 | 8-15 | 14-15 |
| 60 | / | 4-10 | 3.5-10 | 4.5-10 | 8-10 | 14-15 |
| 80 | / | 4-10 | 3.5-10 | 4.5-10 | 8-10 | 14-15 |
| 100 | / | 4-10 | 3.5-10 | 4.5-10 | 8-10 | 14-15 |

(iii) The shorter the pulse duration the wider the range over which three-photon absorption resonance can be established under the conditions for which eq. (71) is valid; (iv) At the higher pumping frequencies between 628.527 cm⁻¹ and 628.6 cm⁻¹ higher pumping intensities are necessary to achieve the establishment of three-photon absorption resonance and the available pumping intensity ranges are more limited. Thus, in order to achieve high selectivity and elevate all the molecules of the desired isotope ²³⁵UF₆ to the third energy excitation level, we select a pumping frequency in the neighbourhood of direct three-photon resonance with the m(A₂):(3ν₃) sublevel of the third energy excitation state, and gradually increase its intensity to levels between 5×10⁹ W/m² and 20×10⁹ W/m². The lower the pumping intensity necessary for selectively elevating all the molecules of the desired isotope ²³⁵UF₆ to the third energy excitation level the less likely the possibility of any other problems inherent to the interaction occurring. The pumping pulse duration should preferably be less than 30×10⁻⁹ s. The optimum intensity level is chosen in conjunction with the frequency and beam parameters of the dissociating laser.

One of the main advantages of the present invention is that the techniques applied enable the MLIS method to be applied to the Tails assays. This is an enormous commercial advantage over all other isotope separation processes. When attempting to separate the isotopes with the percentages taken from material in the tails, the conditions (68) and (69) are slightly changed resulting in more restrictions imposed on the pumping intensity ranges for which eq. (67) is applicable. This is mainly due to the fact that the ratio of the molecular composition of the two isotopes in in eq. (68) changes greatly. We have investigated the whole process for very low percentages of the desired isotope with the Tails composition being: ²³⁸UF₆→99.75% and ²³⁵UF₆→0.25%. Following the same procedure as before we have arrived at a value for the exponential constant of

$${q}_{238}^{2} {K}^{238} {3}^{} ( x ) \leq 0.0236$$

for eq. (67) to be strictly applicable. On considering this value we have found that the pumping beam intensity range for which eq. (67) is applicable is more restricted. It is, however, still very wide for the straightforward separation of the isotopes when employing a supercooled gas with Tails assays. We have investigated the separation of the UF₆ isotopes with the present method using Tails assays for pumping beam frequencies in the region of the three-photon resonance with the third energy excitation level around 628.527 cm⁻¹. The results pose no problem whatsoever. It has also been found that pumping at the frequency of the fundamental of the desired isotope ²³⁵UF₆ at 628.306 cm⁻¹ renders the process practically inapplicable. Tables similar to 26 using the relevant parameters for the separation of Tails assays when pumping at 628.527 cm⁻¹ have been constructed. We have summarized the available ranges of pumping intensities at the particular pumping frequencies, which can be applied to the supercooled UF₆ gas at particular pumping pulse durations where eq. (71) remains perfectly applicable, for the case where supercooled gas assays correspond to the proportions of the isotopes in the Tails. Again, we considered as a safety measure the lower intensity level for the ready setting up of the three-photon absorption resonance for the ²³⁵UF₆ molecule to be that at which the three-photon transition rate exceeds that of the equivalent two-level transition rate with the same interaction parameters. Some of the results are shown in Table 28 for comparison with Table 27. The basic conclusions to be drawn from Table 28 can be summarized: (i) It is now very difficult to establish three-photon absorption resonance at the pumping frequency of the fundamental at 628.306 cm⁻¹; (ii) The optimum pumping frequencies for readily establishing three-photon absorption resonance are those between 628.45 cm⁻¹ and 628.527 cm⁻¹. The pumping intensity range is more limited in this optimum frequency interval to between 5×10⁹ W/m² and 15×10⁹ W/m²; (iii) The shorter pulse duration, however, can widen the range over which three-photon absorption resonance can be established under the conditions for which eq. (71) is valid; (iv) At the higher pumping frequencies between 628.527 cm⁻¹ and 628.6 cm⁻¹ higher pumping intensities are necessary to achieve the establishment of three-photon absorption resonance. The intensity ranges are more restricted but again they can be widened when shorter duration pulses are employed. It is clear that the three-photon absorption process for selectively exciting the molecules of the desired isotope ²³⁵UF₆ to the third energy excitation level can easily be applied in the cases where the supercooled molecular gas has a composition corresponding to that of the Tails.

TABLE 28
(Tails)
The range of pumping intensities which can be applied to the supercooled UF₆ gas at a
particular pumping pulse duration where eg. (71) is perfectly applicable (modified)
(Tails assay ²³⁸UF₆ → 99.75% and ²³⁵UF₆ → 0.25%)

| | Pumping Frequency (cm⁻¹) | | | | | |
|---|---|---|---|---|---|---|
| | 628.306 | 628.45 | 628.49 | 628.527 | 628.56 | 628.6 |
| Pulse | Intensity | Intensity | Intensity | Intensity | Intensity | Intensity |
| duration | range | range | range | range | range | range |
| ×10⁻⁹ s | ×10⁹ W/m² | ×10⁹ W/m² | ×10⁹ W/m² | ×10⁹ W/m² | ×10⁹ W/m² | ×10⁹ W/m² |
| 10 | / | 4-10 | 3.5-15 | 4.5-15 | 8-15 | 14-20 |
| 20 | / | 4-10 | 3.5-10 | 4.5-15 | 8-15 | 14-15 |
| 30 | / | 4-10 | 3.5-10 | 4.5-10 | 8-15 | 14-15 |
| 40 | / | 4-10 | 3.5-10 | 4.5-10 | 8-10 | 14-15 |
| 50 | / | 4-10 | 3.5-10 | 4.5-10 | 8-10 | / |
| 60 | / | 4-10 | 3.5-10 | 4.5-10 | 8-10 | / |
| 80 | / | / | 3.5-10 | 4.5-10 | 8-10 | / |
| 100 | / | / | / | 4.5-10 | 8-10 | / |

Under the conditions (60), (68) and (70) all the ²³⁵UF₆ molecules are excited to the third energy level whilst only a small fraction of the ²³⁸UF₆ molecules are excited. This occurs because of the validity of inequalities (68) and (70) resulting in eq. (67) being applicable, and subject to the condition (69). Since the first of the conditions (66) holds then it is a simple matter of expanding the exponential in eq. (67) to show that the value of this inequality must be less than 2% (0.02) in order for the value of the second order term in the expansion of the exponential to be less than 5% (0.01) of the value of the term corresponding to that for the desired isotope ²³⁵UF₆. The other 99.3% of the molecules constituting the ²³⁸UF₆ isotope will be lifted to the third energy excitation level according to the value of the exponential coefficient

$${q}_{238}^{2} {K}^{238} {E}^{3} ( x ) ,$$

[eq. (67)]. Under these conditions the percentage of the molecules of both isotopes lifted to the third energy excitation level is

$$[ ( {q}_{238}^{2} {K}^{238} {E}_{◦}^{3} ) \times 99.3 + 0.7 ]$$

giving the corresponding percentages of the desired and undesired isotopes as

$$( \% ) of third level {}^{235} {UF}_{6} molecules = \frac{0.7}{[ ( {q}_{238}^{2} {K}^{238} {E}_{◦}^{3} ) \times 99.3 + 0.7 ]} \qquad ( 72 )$$

$$\% of third level {}^{238} {UF}_{6} molecules = \frac{( {q}_{238} {K}^{238} {E}_{◦}^{3} ) \times 99.3}{[ ( {q}_{238}^{2} {K}^{238} {E}_{◦}^{3} ) \times 99.3 + 0.7 ]} \qquad ( 73 )$$

always bearing in mind that condition (69) holds. Expressions (72) and (73) give a very good indication of the values to be expected from the solutions of eq. (71) for the various pumping intensities. They are values obtained under the very strict application of the restriction conditions whilst those obtained through the application of the eq. (71) can have the restriction conditions more relaxed. All the results obtained through the solutions of eq. (71) have been thoroughly checked for their correctness using the expressions (72) and (73). In the cases of
Tails assays with composition of ²³⁵UF₆→99.75% and ²³⁵UF₆→0.25% the corresponding percentages are

$$\% of third level {}^{235} {UF}_{6} molecules = \frac{0.25}{[ ( {q}_{238}^{2} {K}^{238} {}_{◦}^{3} ) \times 99.75 + 0.25 ]} \qquad ( 74 )$$

$$\% of third level {}^{238} {UF}_{6} molecules = \frac{( {q}_{238} {K}^{238} {}_{◦}^{3} ) \times 99.75}{[ ( {q}_{238}^{2} {K}^{238} {}_{◦}^{3} ) \times 99.75 + 0.25 ]} \qquad ( 75 )$$

always bearing in mind that condition (69) holds. Again all the results obtained through the solutions of eq. (71) have been thoroughly checked for their correctness using the expressions (74) and (75).

We have investigated the three-photon absorption selectivity to the third energy excitation level [m(A₂):(3ν₃)] of the UF₆ gas for many different gas expansion and pumping beam parameters within the framework of values and experimental conditions described above. The percentage selectivity as a function of pulse duration and as a function of pumping intensity at various pumping frequencies has been thoroughly analysed, as well as the number of excited molecules for various gas densities. The first point to make is that the results rule out the possibility of obtaining any substantial selectivity to the third energy excitation level when pumping at the frequency of the fundamental of the desired isotope ²³⁸UF₆ at 628.306 cm⁻¹, either from the point of view of the pumping intensity or from the point of view of the number of molecules elevated to the third energy excitation level. We have extensively analysed the results when pumping at frequencies in the region of three-photon resonance with the [m(A₂):(3ν₃)] level of the desired isotope ²³⁵UF₆ between 628.45 cm⁻¹ and 628.6 cm⁻¹, within the limits and the conditions of the theoretical analysis described above. The results have been most impressive but we cannot present here even a fraction of the complete analysis. However, we will present some of the results when pumping at the exact three-photon resonance frequency with the third energy excitation level [m(A₂):(3ν₃)] at 628.527 cm⁻¹.

First we summarize all the values of the relevant quantities for which eq. (71) is valid. Table 29 summarizes all the relevant quantities when pumping at the three-photon resonance frequency at 628.527 cm⁻¹. Note that only pumping intensities, pulse durations and values of the interaction parameters for which eq. (71) is valid are listed in Table 29. The first two horizontal row sections (broken line sections comprising the intensities at 1.5×10⁹ W/m² and 2.5×10⁹ W/m²) correspond to pumping intensities for which the three-photon transition rate (W₀₃)₂₃₅ is lower than the transition rate of the equivalent two-level system (W₀₁)_{UF}_{₆} (4.5×10⁹ (W/m²), Table 25, FIG. 13). The temperature of the expansion supercooled UF₆ gas is at 60° K and the densities of the two isotopes are

$$Δ {N}_{◦}^{238} = 1.703 \times {10}^{21} molecules / {m}^{3} and Δ {N}_{◦}^{235} = 1.2177 \times {10}^{19} molecules / {m}^{3} .$$

All the values quoted have been practically employed and have actually been reported in experimental works [Gilbert M. et al SPIE, Laser Applications in Chemistry, Vol. 669, pp. 10-17, (1986); Lyman J. L., ‘Enrichment Separative Capacity for SILEX’, Los Alamos National Laboratory, Report LA-UR-05-3786, (2005)]. The pumping beam radius is wₒ=0.004 m and the interaction length in the gas is 1.5 m. This can easily be achieved at a temperature of 60° K by having two or more supercooling expansion chambers in series. The densities quoted

TABLE 29
The values of α at a pumping frequency of (ωₖ/2πc) = 628.527 cm⁻¹ where ωₖ = 1.183925869 × 10¹⁴ s⁻¹
for the various beam intensities and pumping pulse durations for which eq. (71) is valid
$\frac{Δ {N}_{o}^{235}}{Δ {N}_{o}^{238}} = \frac{1.2177 \times {10}^{19}}{1.703 \times {10}^{21}} = \frac{0.3043 \times {10}^{19}}{0.42557 \times {10}^{21}} = 7.1503 \times {10}^{- 3}$

| Initial beam Intensity (W/m^{²}) | Pulse duration τ ×10⁻⁹ s | Initial beam Energy flux Eₒ (J/m²) | q²³⁸ | K²³⁸ m⁶/J³ | $α = {( \frac{Δ {N}_{o}^{235}}{{q}_{238}^{2} {K}^{238} Δ {N}_{o}^{238}} )}^{\frac{1}{3}}$ (J/m²) |
|---|---|---|---|---|---|
| 1.50E+09 | 10 | 1.50E+01 | 0.0026 | 1.9675917E−06 | 813.1075495334 |
| 1.50E+09 | 20 | 3.00E+01 | 0.0026 | 4.9189791E−07 | 1290.7277926125 |
| 1.50E+09 | 30 | 4.50E+01 | 0.0026 | 2.186213E−07 | 1691.3318601858 |
| 1.50E+09 | 40 | 6.00E+01 | 0.0026 | 1.2297448E−07 | 2048.9026419133 |
| 1.50E+09 | 50 | 7.50E+01 | 0.0026 | 7.8703666E−08 | 2377.5409180497 |
| 1.50E+09 | 60 | 9.00E+01 | 0.0026 | 5.4655324E−08 | 2684.8219904606 |
| 1.50E+09 | 80 | 1.20E+02 | 0.0026 | 3.0743620E−08 | 3252.4302091536 |
| 1.50E+09 | 100 | 1.50E+02 | 0.0026 | 1.9675917E−08 | 3774.1109224405 |
| 2.50E+09 | 10 | 2.50E+01 | 0.0040 | 1.9675917E−06 | 610.1316645001 |
| 2.50E+09 | 20 | 5.00E+01 | 0.0040 | 4.9189791E−07 | 968.5236559113 |
| 2.50E+09 | 30 | 7.50E+01 | 0.0040 | 2.186213E−07 | 1269.1250052584 |
| 2.50E+09 | 40 | 1.00E+02 | 0.0040 | 1.2297448E−07 | 1537.4354598313 |
| 2.50E+09 | 50 | 1.25E+02 | 0.0040 | 7.8703666E−08 | 1784.0358247555 |
| 2.50E+09 | 60 | 1.50E+02 | 0.0040 | 5.4655324E−08 | 2014.6103807131 |
| 2.50E+09 | 80 | 2.00E+02 | 0.0040 | 3.0743620E−08 | 2440.5266662695 |
| 2.50E+09 | 100 | 2.50E+02 | 0.0040 | 1.9675917E−08 | 2831.9803209772 |
| 5.00E+09 | 10 | 5.00E+01 | 0.0125 | 1.9675917E−06 | 285.4457295430 |
| 5.00E+09 | 20 | 1.00E+02 | 0.0125 | 4.9189791E−07 | 453.1168559622 |
| 5.00E+09 | 30 | 1.50E+02 | 0.0125 | 2.186213E−07 | 593.7510443816 |
| 5.00E+09 | 40 | 2.00E+02 | 0.0125 | 1.2297448E−07 | 719.2781689447 |
| 5.00E+09 | 50 | 2.50E+02 | 0.0125 | 7.8703666E−08 | 834.6483835507 |
| 5.00E+09 | 60 | 3.00E+02 | 0.0125 | 5.4655324E−08 | 942.5210382068 |
| 5.00E+09 | 80 | 4.00E+02 | 0.0125 | 3.0743620E−08 | 1141.7829220405 |
| 5.00E+09 | 100 | 5.00E+02 | 0.0125 | 1.9675917E−08 | 1324.9217108491 |
| 1.00E+10 | 10 | 1.00E+02 | 0.0280 | 1.9675917E−06 | 166.7342695170 |
| 1.00E+10 | 20 | 2.00E+02 | 0.0280 | 4.9189791E−07 | 264.6741575208 |
| 1.00E+10 | 30 | 3.00E+02 | 0.0280 | 2.186213E−07 | 346.8212567707 |
| 1.00E+10 | 40 | 4.00E+02 | 0.0280 | 1.2297448E−07 | 420.1440332302 |
| 1.00E+10 | 50 | 5.00E+02 | 0.0280 | 7.8703666E−08 | 487.5339657654 |
| 1.00E+10 | 60 | 6.00E+02 | 0.0280 | 5.4655324E−08 | 550.5444312004 |
| 1.00E+10 | 80 | 8.00E+02 | 0.0280 | 3.0743620E−08 | 666.9370803278 |
| 1.00E+10 | 100 | 1.00E+03 | 0.0280 | 1.9675917E−08 | 773.9119235707 |
| 1.50E+10 | 10 | 1.50E+02 | 0.0400 | 1.9675917E−06 | 131.4488823486 |
| 1.50E+10 | 20 | 3.00E+02 | 0.0400 | 4.9189791E−07 | 208.6620962412 |
| 1.50E+10 | 30 | 4.50E+02 | 0.0400 | 2.186213E−07 | 273.4246937316 |
| 1.50E+10 | 40 | 6.00E+02 | 0.0400 | 1.2297448E−07 | 331.2304288346 |
| 1.50E+10 | 50 | 7.50E+02 | 0.0400 | 7.8703666E−08 | 384.3588669113 |
| 2.00E+10 | 10 | 2.00E+02 | 0.0540 | 1.9675917E−06 | 107.6137384518 |

| T = 60° K. | $Δ {N}_{o}^{238} = \frac{1.703 \times {10}^{21}}{( molecules / {m}^{3} )}$ | | $\begin{matrix}Δ {N}_{o}^{235} = \frac{1.2177 \times {10}^{19}}{( molecules / {m}^{3} )} \\ \end{matrix}$ | ${( {N}_{o} )}_{total} = \frac{1.71518 \times {10}^{21}}{( molecules / {m}^{3} )}$ |
|---|---|---|---|---|
| L = 1.5 m | wₒ = 0.004 m | zₒ = 3.16 m | l_{eq} (W₀₁)₂₃₅ = 4.5 × 10⁹ (W/m²) | hv = 1.248534593 × 10⁻²⁰ J |

have been achieved experimentally at a temperature of 60° K with a single expansion nozzle having a length of 1 m. Such densities have also been easily achieved and uniformly distributed over a diameter of 0.008 m as reported in the early literature on the subject [Rabinowitch P. et al., Optics Letters, Vol. 7, No 5, pp. 212-214, (May 1982); Okada Y., Tashiro H. and Takeuchi K., Journal of Nuclear Science and Technology, Vol. 30, No. 8, pp. 762-767, (August 1993)]. All other relevant parameters are registered at the bottom of the table.

FIG. 14 shows the selectivity to the third energy excitation level at the beam and gas parameters shown on the graphs, for various pumping intensities. The broken vertical lines indicate the intervals over which eq. (71) and conditions (68)-(70) are valid. The abscissae on all graphs are indicated from 20%-100% for comparisons. The first graph (a) (shaded background) correspond to pumping intensity levels (<4.5×10⁹ W/m²) at which the three-photon transition rate is less than the transition rate of the equivalent two-level system with the same interaction parameters. At these pumping intensity levels difficulties may arise in establishing the three-photon resonance with the third energy excitation level. The last three graphs (c), (d) and (e) correspond to pumping intensity levels (>4.5×10⁹ W/m²) at which the three-photon transition rate is greater than the transition rate of the equivalent two-level system with the same interaction parameters. It can be seen that the selectivity drops with increasing pulse duration and also with increasing intensity levels. For the selective excitation of the molecules of the desired isotope ²³⁵UF₆ to the third energy excitation level [m(A₂):(3ν₃)] the optimum pumping intensities should be in the region 4-15 GW/m² with pulse durations of less than 30×10⁻⁹ s. Note, in particular, the importance of the pulse duration. With these pumping parameters all the molecules of the desired isotope ²³⁵UF₆ are elevated to the third energy excitation level.

To obtain a comparative view we have plotted in FIG. 15(a) the percentage selectivity to the third energy excitation level as a function of the pumping intensity for various pumping pulse durations. The beam and gas parameters are shown on the graph (Pumping frequency (ωₖ/2πc)=628.527 cm⁻¹, ΔN²³⁸=1.703×10²¹ molecules/m³, ΔN²³⁵=1.2177×10¹⁹ molecules/m³). The vertical broken lines denote the maximum interval over which eq. (71) and conditions (68)-(70) remain valid. The vertical dotted lines denote the limits up to which eq. (71) and conditions (68)-(70) remain valid for the particular pulse duration. The vertical broken-dot line corresponds to the pumping intensity level (4.5×10⁹ W/m²) at which the three-photon transition rate becomes greater than the transition rate for the equivalent two-level system with the same interaction parameters. It can be seen that the shorter the pulse duration the higher the selectivity of the desired isotope. The optimum pumping intensity levels can be seen to be in the interval (4-15)×10⁹ W/m² with pumping pulse durations between (10˜30)×10⁻⁹ s.

FIG. 15(b) gives the total number of excited molecules to the third energy excitation level as a function of pumping intensity for various pulse durations, corresponding to the graphs of FIG. 15(a). The beam and gas parameters are shown on the graph and they are the same as those in FIG. 15(a). All the vertical lines on the graphs denote the same parameter limits as in FIG. 15(a). It can be seen that for a particular pumping intensity the shorter the pulse duration the less the total number of molecules excited to the third energy excitation level. Since all the molecules of the desired isotope ²³⁵UF₆ are excited to the third energy level the increase in the number of excited molecules is due to the excitation of the molecules of the unwanted isotope. Subsequently shorter pulse durations with high intensity are preferable for the preservation of high selectivity to the third energy level.

We have investigated larger diameter beams with 2wₒ=0.012 m. Their effective use depends on the design of the expansion nozzle. In this case the curves for the percentage selectivity as a function of pulse duration and as a function of pumping intensity remain the same as in the previous case for 2wₒ=0.008 m, but the total number of molecules excited to the third energy excitation level now greatly increases enhancing the efficiency of the system. FIG. 16 shows the curves for the total number of excited molecules to the third energy level when the diameter of the pumping beam is 0,012 m which follow similar curves as with smaller diameter beams (0.008 m, FIG. 15(a)) but the number of excited molecules is now more than doubled. This indicates how the design of the expansion nozzle in effectively accommodating larger diameter beams is of paramount importance to the efficiency of the system, but their design is outside the scope of the present account.

We have used different sets of gas parameters which are very easily achievable in practice. By changing only the gas parameters to ΔN²³⁸=0.42557×10²¹ molecules/m³, ΔN²³⁵=0.3043×10¹⁹ molecules/m³ all the interaction parameters in Table 29 as well as the percentage selectivity to the third energy level in the graphs of FIG. 15(a) remain the same. The only results that change are those for the total number of excited molecules to the third energy level and these are shown in the graphs of FIG. 17 which is to be compared with FIG. 15(b). Again all the available molecules of the desired isotope ²³⁵UF₆ are elevated to the third energy excitation level. One of the great advantages of the process is the treatment of the Tails assays. We have investigated the case of the expansion supercooled gas having Tails percentages of the two isotopes with densities of

$$Δ {N}_{◦}^{238} = 1.7107 \times {10}^{21} molecules / {m}^{3} ( {}^{238} {UF}_{6} = 99.75 \% ) and Δ {N}_{◦}^{235} = 0.4287 \times {10}^{19} molecules / {m}^{3} ( {}^{235} {UF}_{6} = 0.25 \% )$$

at a temperature of 60° K. The results have a slightly smaller range of available pumping intensities and the pumping pulse duration should be preferably shorter. FIG. 18(a) shows the selectivity graphs as a function of pumping intensity for various pumping pulse durations for a Tails assay of the desired isotope of ²³⁵UF₆=0.25%. FIG. 18(b) shows the corresponding graphs for the total number of molecules elevated to the third energy level. We have also carried out analyses for smaller densities of the expansion supercooled gas with Tails assays such as

$$Δ {N}_{◦}^{238} = 0.427542 \times {10}^{21} molecules / {m}^{3} ( {}^{238} {UF}_{6} = 99.75 \% ) and Δ {N}_{◦}^{235} = 0.107154 \times {10}^{19} molecules / {m}^{3} ( {}^{235} {UF}_{6} = 0.25 \% )$$

at a temperature of 60° K with similar kind of results. The fact that all the available molecules of the desired isotope are elevated to the third energy excitation level (in eq. (70) makes the shapes of the resulting curves similar. We recall that we are only investigating cases for which eq. (71) is strictly applicable. Other cases deviating slightly from the strict application of eq. (71) may be practically suitable for the isotope separation process allowing for a wider range of applicable parameters. The most important general points to notice from the results when pumping at the three-photon resonance frequency with the third energy excitation level of the desired isotope at 628.527 cm⁻¹, are: (i) The percentage selectivity does not change with gas density provided the ratio of the number of molecules of the two isotopes in the gas is the same; (ii) The percentage selectivity does not depend on the pulse duration for a particular isotopic ratio at a certain pumping intensity; (iii) In all cases all the molecules of the desired isotope ²³⁵UF₆ are excited to the third energy level. The total number of molecules excited increases with increasing intensity due to the increase in the excitation of the molecules of the unwanted isotope; (iv) The shorter the pulse duration the higher the selectivity; (v) In general the optimum beam parameters for achieving high selectivity to the third energy excitation level are: Pumping intensities in the region of (5-15)×10⁹ Win with pulse durations in the region of (10-30)×10⁻⁹ s; (vi) It is important to notice that there is a very large interval of pumping intensities where the selectivity to the third energy excitation level is enormous especially with pumping pulses of short duration. The same is true for the Tails percentages; (vii) The significance of the role the pulse duration plays in the interaction process as the beam propagates along the gas and its effect on the selectivity process must be taken special notice of. We have carried out investigations on many frequencies in the region of the three-photon resonance frequency 628.527 cm⁻¹ from 628.45 cm⁻¹ to 628.6 cm⁻¹ for various pumping intensities and gas parameters. The results were similar to those described above with small variations such as the range of available intensities being slightly more limited. When pumping at 628.49 cm⁻¹, however, the fact that both the two-level and three-level resonances are very close to the respective second and third level, renders the establishment of the three-photon absorption resonance easier. As a consequence the pumping intensity level at which the three-photon transition rate becomes greater than the equivalent two-level transition rate with the same interaction parameters is much lower (3.5×10⁹ W/m²). At pumping frequencies greater than 628.56 cm⁻¹ the pumping intensity level at which the three-photon transition rate becomes greater than the equivalent two-level transition rate with the same interaction parameters, is much higher (>8×10⁹ W/m²) and at even higher frequencies such as 628.6 cm⁻¹ it becomes very high (>14×10⁹ W/m²). In these cases higher pumping intensities become necessary for the establishment of three-photon resonance, although they may have some inherent advantages.

FIG. 19 shows the variation of the selectivity as a function of pumping frequency and pumping pulse duration, for a pumping intensity of 8×10⁹ W/m². We see that for this pumping intensity the frequency region for which eq. (71) is satisfied and conditions (68)-(70) remain valid is between 628.45 cm⁻¹ and 628.56 cm⁻¹. In this region the three-photon transition rate is greater than the transition rate of the equivalent two-level system with the same interaction parameters. Similar results are obtained for lower expansion supercooled gas assays. The results for Tails assays of the irradiated gas show similar characteristics but with slightly lower percentage selectivities to the third energy excitation level.

Finally it should be pointed out that the graphs in FIGS. 14-19 constitute the lowest limits for the selectivity applications but in reality the selectivity does not drop so quickly with increasing pumping intensity and the interaction ranges are less restrictive. This is particularly important in the case of the treatment of the Tails where the preservation of high selectivity is significant even at higher pumping powers. It is a consequence of the fact that, the molecules of the unwanted isotope ²³⁸UF₆ cannot be treated in exactly the same way as the molecules of the desired isotope ²³⁵UF₆ with regard to their excitation rate to the third energy level (for example recall FIG. 13). In practice they remain largely unexcited despite their enormous numbers. Thus, much higher pumping intensities and availability ranges can be used for the excitation of the molecules of the desired isotope than those suggested by these figures, without seriously affecting the selectivity. This may prove important in the ease with which the three photon resonance is established.

All the theoretical expressions derived as well as all the calculations, the results, facts and trends established in this patent application are consistent amongst themselves and with all the available experimental results to date.

Having described the fundamental physical concepts and calculated the basic parameters and regions of operation necessary for the successful separation of the Uranium isotopes we proceed to describe the process and the basic steps of the invention:
(i) First we design an expansion nozzle capable of producing a supercooled molecular UF₆ gas at a temperature well below 100° K, preferably in the region of 60° K. At these temperatures nearly all the molecules of the UF₆ gas are in the ground state (FIG. 6). The mixtures of the carrier and the scavenger gases are suitably prepared in the expansion tank as described in the text (Table 17). The parameters of the expansion system are adjusted to produce UF₆ gas densities at the exit of the expansion supercooling nozzle with values preferably near those given in Table 18.
(ii) A high repetition rate laser system operating at a frequency of 628.527 cm⁻¹, corresponding to the three-photon resonance frequency with the [m(A₂):(313)] sublevel of the third energy excitation state of the desired isotope ²³⁵UF₆ (Table 4), producing pulses of duration preferably in the range (10-40)×10⁻⁹ s, and whose intensity can be increased to a required level setting up the three photon resonance, is used to irradiate the supercooled molecular gas.
(iii) This laser will selectively elevate the molecules of the desired isotope ²³⁵UF₆ to the third energy excitation level [m(A₂):(3ν₃)] via the three-photon resonance process [m(A₁):(0ν₃)] (l=0)→[m(F₁): (1ν₃)] (l=1)→[m(F₂): (2ν₃)] (l=2)→[m(A₂):(3ν₃)] (l=3) with the quantum transition rule Δl=#1 being perfectly satisfied, whilst avoiding completely any resonance with the fourth energy excitation level (FIGS. 8(b) and 9).
(iv) A high power infrared dissociating laser beam is simultaneously applied to the expansion supercooled gas, or with a small adjustable time delay, with a frequency preferably in the region of 618 cm⁻¹ to 623.3 cm⁻¹, with the most preferable frequencies being those which can match multiphoton resonances between the [m(A₂):(313)] sublevel of the third energy excitation state and higher levels of the ν₃-vibrational mode up to the eighth energy excitation state of the desired isotope ²³⁵UF₆, without seriously affecting or resonating with any of the levels of the unwanted isotope ²³⁸UF₆ even at these high pumping intensities (FIG. 10). Three examples of such dissociation frequencies are at 620.6 cm⁻¹, 623.3 cm⁻¹ and the exact Raman shifted frequency of the CO₂: R(18) line at 620.2476393 cm⁻¹.
(v) The intensity of the selecting laser at 628.527 cm⁻¹ is gradually increased to a level at which all the molecules of the desired isotope ²³⁵UF₆ are selectively excited to the third energy excitation level whereby the dissociating laser drives them through the higher levels of the ν₃-vibrational mode to the quasicontinuum of energy states and thereby to dissociation. The intensity of the selecting laser is then adjusted at the best optimum value when nearly all the molecules of the desired ²³⁵UF₆ isotope are elevated to the third energy level whilst the molecules of the unwanted isotope ²³⁸UF₆ remain largely unexcited (in eq. (66)). The calculated intensity range over which this state of affairs can be achieved is between 4×10⁹ W/m² and 20×10⁹ W/m², although higher values may be employed. The optimum values can be determined experimentally.
(vi) The selectively excited molecules of the desired ²³⁵UF₆ isotope are then driven to dissociation through the higher vibrational levels and the quasicontinuum of energy states, by the simultaneously applied dissociating laser whose exact intensity and optimum frequency can again be experimentally determined. The estimated intensity range over which this state of affairs can be achieved is between 30×10⁹ W/m² and 120×10⁹ W/m² but the optimum value can again be experimentally obtained. Similarly, the optimum frequency for the dissociation laser may need to be carefully adjusted in order to readily elevate the selectively excited molecules through the higher levels of the ν₃-vibrational mode.
(vii) Any additional infrared or ultraviolet beams may be simultaneously applied to the molecular gas to enhance the dissociation process. The selectivity and dissociation process described can, however, already be so efficient that the application of any further dissociating beams may not be necessary.
(viii) The frequency of the selecting laser can be finely adjusted in the region of the three-photon resonance frequency 628.527 cm⁻¹ with the third energy sublevel [m(A₂):(3ν₃)] between 628.45 cm⁻¹ and 628.6 cm⁻¹ for the best optimum operation, whilst at the same time finely adjusting the pumping intensity of the beam for the best excitation results. The most optimum range appears to be between 628.45 cm⁻¹ and 628.527 cm⁻¹ (see for example FIG. 13). Results pertaining to this frequency range, in conjunction with the available intensity ranges, have been carried out showing excellent selectivity of the desired isotope ²³⁵UF₆ to the third energy level but cannot be presented in detail here due to shortage of space.
(ix) The best possible frequency of the dissociating laser together with its optimum pumping intensity may be slightly trickier to locate. The laser frequency must have the best possible resonances starting from the [m(A₂):(3ν₃)] sublevel of the third energy excitation state with the higher levels of the ν₃-mode vibrational ladder, with sufficient intensity to elevate them to the quasicontinuum of energy states and thereby to dissociation, but not too high to elevate the molecules of the unwanted isotope. ²³⁸UF₆ from the ground state and other lower lying states to the quasicontinuum and the higher levels of other vibrational modes. Adjustments of the frequency and the intensity of the dissociating laser are therefore important for the optimum and efficient operation of the process. No more results can be presented here due to the shortage of space.
(x) Any other process, whether radiational, chemical or mechanical, which can dissociate or separate the selectively elevated molecules of the desired ²³⁵UF₆ isotope from the third energy excitation level to dissociation or separation from the molecular gas can be applied to the separation procedure.

In defining the parameters, frequencies, beam intensities and densities of the molecular gas in the above method and throughout the description of the process in this patent application, we have checked out many other effects that might possibly occur during the process. They were all found negligible or irrelevant to the main process. This is why the temperature of the expansion supercooled gas must be very low, below 100° K, and preferably in the region of 60° K so that all the interactions take place with a minimum of inherent disturbances. The intensity of the selecting laser is adjusted so as to be high enough for three-photon absorption resonance to occur but not too high to enable the selectively excited molecules ²³⁵UF₆ to escape to other vibrational modes and to the quasicontinuum of energy states, nor molecules of the unwanted isotope ²³⁸UF₆ to be elevated to the quasicontinuum of energy states. The frequencies and the intensities of the dissociating laser have been checked so that they do not provide direct multiphoton resonance between the ground level and the higher levels of the unwanted isotope ²³⁸UF₆. The frequency of the dissociating laser was also checked against possible resonances with the higher levels of the unwanted isotope. The possibility of very fast radiationless transitions between the sublevels of the third energy excitation state has been investigated and it was concluded that it can have no effect on the selectivity and dissociation process as formulated above. The same was found for the sublevels of the first and second energy excitation levels.

Although the selectivities obtained above refer to the ideal case it is evident that whatever other losses may occur during the operation of the process on a practical level, will still leave the selectivity of a single stage system outstanding by comparison to any other process. The size of an industrial plant and the throughput of Uranium in a year, are therefore the next important factors to consider for a commercial plant. We have designed and calculated the flow rates and enrichment factors of a typical Centrifuge cascade based on well established standard technology. An ideal cascade consisting of 706 centrifuges of the Areva or Urenco types (˜4 m height by ˜0.20 m diameter) arranged in 10 stages (7 rectifier stages and 3 stripper stages) with a stage separation factor of α=1.3 can produce 0.5 (kg/hour) of reactor grade Uranium at a ²³⁵UF₆ concentration of 4.294% with Tails of 0.25% from natural Uranium (²³⁵UF₆˜0.71%), from a Feed input of 4.3965 (kg/hour). This corresponds to a yearly input of 38.513×10³ kg of Uranium. Looking at Table 18 we see that starting from an expansion supercooled gas with a Uranium density of 2.006×10²¹ molecules/m³ (a value which has already been experimentally achieved and reported in the literature) and using only an 8 mm diameter pumping beam over a gas length of 1 m we can process 12.5054×10³ kg/year of Uranium with an enormous selectivity. This means that a few one-metre expansion nozzles can process the entire feed of a 706 centrifuge cascade at an enormous selectivity. Bearing in mind that in eq. (69) always holds under the conditions of the selective excitation of the desired isotope ²³⁵UF₆ to the third energy level, two or three expansion nozzles can be placed in series pumped by the same beams. The capital costs, the operational costs and the selectivity of the MLIS process using the present invention render the system so efficient in a single pumping step that no other method will be able to compete with it. Reprocessing the enriched product with further stages will result in an enormous separation factor. In fact the selectivity in a single pumping step could turn out to be so high that even the concept of Separative Work Unit (SWU) may be rendered unnecessary. We have carried out more elaborate calculations but the shortage of space does not permit to present them here.

The present process is perfectly suited for the construction of an enrichment plant for the production of enriched Uranium at 19.75% for the needs of European research reactors as proposed by the European Supply Agency (ESA), in July 2016. It could also be applicable to the SILEX process currently under development in the USA. Although not much information is known, the process relies on the formation of dimers by the selectively excited ²³⁵UF₆ isotope (excitation energy ˜0.08 eV) dissociating at a faster rate than those of the unwanted isotope ²³⁸UF₆ due to their much greater excitation energy than that of the Van der Waals bond (˜0.01 eV). Their laser-excited vibrational energy is then converted to translational recoil energy and the ²³⁵UF₆ molecules begin to flee the jet core at a faster rate (Ryan Snyder, Science and Global Security, 23 Jun. 2016, http://dx.doi.org/10.1080/08929882.2016.1184528). The present invention provides a selectively excited state of the desired isotope ((˜0.235 eV) which is enormous by comparison to the Van der Waals bond, thus largely enhancing the flee of the molecules of the excited isotope at an even faster rate in the Laser-Assisted Retardation of Condensation process (SILARC). The simplicity and versatility of the method also enables it to be applied to the separation of any other hexafluoride isotopes or other polyatomic molecules.

The selectivity of the process in a single pumping step could turn out to be outstanding even after the dissociation or separation process is completed. This enormous selectivity in a single pumping step renders the treatment of the Tails very easy, a procedure that no other process can do. The enrichment process becomes very efficient and by far less costly within the nuclear energy cycle. The capability of treating the Tails gives a major advantage to the present invention. At the same time, however, the danger of nuclear proliferation increases enormously. Weapons grade uranium can be reached within very few enrichment stages. Very small enrichment plants which can be rendered undetectable can be constructed. The expansion tanks together with the nozzle expansion and collection chambers will occupy a very small area by comparison to the area for an equivalent centrifuge plant. The number of laser systems necessary for a production plant will be very small. The pumping lasers are thought to be noisy delivering a loud hum at high repetition rates and the Raman converters are fairly large. Multipass Raman cells are in excess of a meter length with a diameter near a half-metre (Lyman J. L., Enrichment separative capacity for SILEX, Los Alamos Laboratory, pp. 1-7, LA-UR-05-378 6, 2005). However, small Raman oscillators can be constructed and employed which can render the process much simpler and easier to operate, with very good beam quality. The entire process can be accommodated in a very small space which would be very difficult to detect.

In the aftermath of the failure and suppression of the MLIS process by the USA an enormous amount of scientific information has been published in the open literature. This is the result of a trend arrogantly practiced and entailing great dangers: If the USA cannot properly succeed in a major project then no one else can, and subsequently all information on the subject can be disseminated. Uncontrolled dissemination of knowledge in areas where the United States have failed does not mean that it cannot be used successfully by others. The recent dissemination of information on the SILEX process is a characteristic example indicating on the one hand an urge for competitive publicity and at the same time that practical problems have now become apparent in the process. In the case of MLIS there was so much scientific information published, both experimental results and theoretical derivations, as if the process was a failure doomed to oblivion in perpetuity. This was carried out under the banner of academic freedom whereby national laboratories and associated universities strongly support a researcher's right to publish. This supercilious attitude by the United States may cause insurmountable problems entailing great dangers. The magnificence of technical and scientific achievements already constitutes the operational framework of the social emotions in the unfathomable havoc of a ubiquitarian anthropomorphic delirium. The impotent naivety of the “Atoms for Peace” doctrine of the 50's was nothing more than a farcical illusion accelerating dramatically the nuclear perils of the world. The imminent resolution of the entanglement problem i.e. that two entangled quantum particles can communicate or not at will, according to the set up of the experimental conditions thereby solving the quantum conundrum in practical experimental terms, will have a devastating effect on all aspects of world affairs. With the action at a distance situation between the two quantum particles being capable to change from false to true at very fast rates and at will, the effect it will have on the operational organization of the world will be drastic, from computers to robotics, to missile technology and nuclear warfare. The destructive power bestowed on humankind has now reached such devastating proportions that security systems can no longer be restricted to espionage, the analysis of collected intelligence data or managerial and organizational practices. This subject is, however, outside the scope of the present patent application.

The efficiency of the present system will be further enhanced by the operation of small Raman oscillators instead of multipass cells. The versatility of such small Raman oscillators, with all the beams operated within the Rayleigh range and diffraction limited optics, enables them to be operated with much smaller CO₂ pumping energies thereby enormously increasing the pump repetition rate. This in turn enables an enormous increase in the amount of the irradiated material leaving very small amounts of unprocessed material in the product stream. Moreover, their pulse duration can easily be controlled as well as their transverse beam profile. Laser cavities which can be operated on one single radiation frequency fixed on a particular value, thus providing a very high stability at the optimum value for the process are now also possible. With the multi-kiloHertz irradiation of the expansion supercooled molecular gas now becoming a practical possibility the efficiency of the process becomes unique.

We have carried out a techno-economic analysis on the optimization costs of enrichment plants using the method of Lagrange's multipliers, for the various enrichment processes. This was done on the basis of practical parameters readily obtainable in the market namely, the cost ep per unit of Product P ($/kg) at an output concentration (percentage) x_{P}, the cost c_{F} per unit of Feed F ($/kg) at an input concentration (percentage) x_{P} and the cost cs of one unit of separative work ΔU ($/kg SWU) (The Ux Consulting Company, LLC; http://www.uxc.com/). Because the selectivity of the MLIS process can be very high, we have used the Full Value Function in our calculations (we have also carried out the calculations using the Approximate Value Function) resulting in the following expression for the determination of the optimum Waste concentration (x_{W})ₒₚₜ for various Feed to Separative Work costs c_{F}/c_{S} as:

$$\frac{{c}_{F}}{{c}_{S}} + ( 1 - 2 {x}_{F} ) ln {R}_{F} + 1 = {( {K}_{{x}_{W}} )}_{Full} = {x}_{F} ( \frac{1}{{x}_{W}} - \frac{1}{1 - {x}_{W}} ) + ( 1 - 2 {x}_{F} ) ln \frac{{x}_{W}}{1 - {x}_{W}} + \frac{{x}_{W}}{1 - {x}_{W}} \qquad ( 76 )$$

where the subscript (Full) stands for the case where the equation has been derived using the corresponding Full Value Function and R_{F} is the relative isotopic abundance of the Feed. We have analysed eq. (76) for the determination of the optimum Waste concentration (x_{W})ₒₚₜ for various Feed to Separative Work costs c_{F}/c_{S} starting from natural Uranium with x_{F}=0.0071. Some of the results are listed in Table 30. The optimum value of the Waste

TABLE 30
The optimum Waste concentration (x_{W})ₒₚₜ for various
Feed to Separative Work costs (c_{F}/c_{S}) starting from natural
Uranium with x_{F} = 0.0071 [eq. (76)].

| (x_{W})ₒₚₜ | (Kₓ_{_{W}})_{Full} | c_{F}/c_{S} (SWU) |
|---|---|---|
| 0.00075 | 2.367789 | 5.33 |
| 0.00100 | 0.285215 | 3.33 |
| 0.00150 | −1.680753 | 2.667 |
| 0.00200 | −2.579497 | 1.226 |
| 0.00225 | −2.857335 | 0.98 |
| 0.00275 | −3.232258 | 0.7187 |

concentration (x_{W}) up is principally determined by the ratio of the Feed cost c_{F} ($/kg) to the Separative Work cost c_{S} ($/kg SWU). It can be seen from Table 30 that as the cost of the Separative Work cs ($/kg SWU) decreases (i.e. c_{F}/c_{S} increases for approximately constant c_{F}) the optimum Waste concentration (x_{W})ₒₚₜ becomes very small, i.e. not much material is being wasted in the Tails. We have carried out many techno-economic analyses on the optimization costs of enrichment plants, both for the optimum product costs (c_{P})ₒₚₜ and for various input and output concentrations, but these are outside the scope of the present patent application.

All the apparatus needed for the application of the process is readily available, Expansion supercooling tanks and the expansion supercooling nozzles, of hyperbolic and laval type shapes, have already been designed and operated. Any laser company will provide CO₂ lasers, at the specification needed and operating at very high repetition rates, within a few months or even weeks. All the equations presented and derived here with regard to the vibrational ladder and to the expansion supercooled gas, as well as those describing the interaction of the electromagnetic radiation with the molecular gas are fully compatible amongst themselves and also they are in perfect agreement with all the experimental results published in the literature. We have checked and investigated every equation presented in the text with all the available experimental results and observations and a perfect agreement was established. We have established through the use of all the equations that all the various experimental results are compatible amongst themselves when reduced to the same experimental basis. In the tables we have presented as many experimental and theoretical results as possible, most of which were not previously available, though they constitute a very small specimen of all the results we have derived. The graphical results presented are few and are limited only to those necessary for the understanding of the principles of the patent application. The method and the system described are completely original, they are easily applicable and render the MLIS process by far the most practical and efficient way for the separation of the UF₆ isotopes.

1. A method of preferentially exciting and selectively dissociating the molecules of the desired ²³⁵UF₆ isotope, in a supercooled UF₆ gas mixture at low temperature such that the sublevels of the energy excitation states of the UF_{6 N3}-vibrational mode are distinct and clear, by irradiating the UF₆ gas with a narrow bandwidth laser beam whose frequency is in three-photon resonance with the [m(A₂):(3_{ν3})] sublevel of the third energy excitation state (3_{ν3}) of the desired ²³⁵UF₆ isotope at 628.527 cm⁻¹, or a frequency sufficiently near to it for three photon resonance to be established with the [m(A₂):(3ν₃)] sublevel, the three-photon resonance being achieved through the adjustment of the pumping intensity of the selecting laser beam at 628.527 cm⁻¹ to a required specific intensity range whereby it is sufficiently intense to establish three photon resonance with the [m(A₂):(3_{ν3})] sublevel but it is kept below the intensity level of establishing multiphoton absorption with the higher levels, and the subsequent dissociation of the ²³⁵UF₆ molecules through the simultaneous or slightly adjustable time delayed application of other infrared or ultraviolet laser beams, or by any other dissociation or separation process following the original excitation of the ²³⁵UF₆ molecules to the third energy excitation state (3_{ν3}) through three-photon resonance with the [m(A₂):(3_{ν3})] sublevel.

2. A highly selective dissociation method of claim 1 wherein the intensity of the selecting laser beam at 628.527 cm⁻¹ in three-photon resonance with the [m(A₂):(3_{ν3})] sublevel of the desired ²³⁵UF₆ isotope, or at a nearby frequency sufficiently close to it for three photon resonance to be established with the [m(A₂):(3_{ν3})] sublevel, is adjusted at a pumping level within an intensity range at which the molecules of the desired isotope ²³⁵UF₆ are selectively elevated to the third energy excitation state.

3. The method of claim 1 of preferentially elevating the molecules of the desired ²³⁵UF₆ isotopic species to the [m(A₂):(3_{ν3})] sublevel of the third energy excitation state (3_{ν3}) whereby the appropriate pumping intensity level ensuring the simultaneous validity of inequalities (66) and the validity of inequalities (68), (69) and (70), is achieved by adjusting the pumping power level and the time duration of the applied selecting beam in the frequency region of three-photon absorption resonance with the [m(A₂):(3_{ν3})] sublevel at 628.527 cm⁻¹.

4. The method of claim 2 of preferentially elevating the molecules of the desired ²³⁵UF₆ isotopic species to the [m(A₂):(3_{ν3})] sub level of the third energy excitation state (3_{ν3}) whereby the intensity of the selecting laser beam at 628.527 cm⁻¹, or at a nearby frequency sufficiently close to it for three photon resonance to be established with the [m(A₂):(3_{ν3})] sublevel, is limited to intensity levels below which no other processes leading to the absorption of radiation by the unwanted isotope ²³⁸UF₆ can take place or drive the molecules of the desired isotope ²³⁵UF₆ through the quasicontinuum stages.

5. A method of preferentially exciting and selectively dissociating the molecules of the desired ²³⁵UF₆ isotope in the Molecular Laser Isotope Separation (MLIS) process according to claim 1 wherein the selectively excited ²³⁵UF₆ molecules to the third energy level are driven to dissociation through the simultaneous application, or with a small adjustable time delay, of an additional powerful infrared beam or any other beams driving the molecules of the desired ²³⁵UF₆ isotope through the quasicontinuum of energy states to dissociation.

6. A selective excitation and dissociation method of preferentially exciting and selectively dissociating the molecules of the desired ²³⁵UF₆ isotope in the Molecular Laser Isotope Separation (MLIS) process of claim 5 wherein a powerful dissociating infrared beam whose frequency closely matches the energy level differences between most of the levels from the third to the eighth energy states of the ν₃-vibrational mode of the ²³⁵UF₆ isotope, is simultaneously applied to the supercooled molecular gas.

7. The method of claim 5, wherein the frequency of the dissociating powerful infrared laser beam lies in the range from 618 cm⁻¹ to 623.3 cm⁻¹ and its intensity is adjusted for the optimum dissociation of the selectively excited ²³⁵UF₆ molecules, and wherein additional infrared or ultraviolet beams can be simultaneously applied to the expansion supercooled UF₆ gas mixture in order to further enhance the selective dissociation of the desired ²³⁵UF₆ isotope.

8. The method of claim 1, wherein the selectively elevated molecules of the desired ²³⁵UF₆ isotope to the [m(A₂):(3_{ν3})] sublevel of the (3_{ν3}) energy excitation state of the _{ν3}-vibrational mode can be selectively separated from the molecular gas by any procedure, whether dissociation, radiational, chemical, mechanical or any other process.

9. A highly selective dissociation method of preferentially exciting and elevating the molecules of the desired ²³⁵UF₆ to the third energy excitation level [m(A₂):(3_{ν3})] in the Molecular Laser Isotope Separation (MLIS) process, according to claim 1, wherein the selective three-photon absorption resonance frequency at 628.527 cm⁻¹ can be finely tuned between 628.45 cm⁻¹ and 628.6 cm⁻¹ for selecting the most optimum frequency for the best selectivity results.

10. A method of preferentially elevating the molecules of the desired ²³⁵UF₆ isotope to the third energy excitation level [m(A₂):(3_{ν3})] in the Molecular Laser Isotope Separation (MLIS) process, according to claim 1 wherein the intensity of the selecting laser at the three-photon resonance frequency of 628.527 cm⁻¹ can be adjusted between 4×10⁹ W/m² and 40×10⁹ W/m² and its pulse duration from 10×10⁻⁹ s to 40×10⁻⁹ s for obtaining the optimum operating conditions for maximum selectivity.

11. A method of preferentially exciting the molecules of the desired isotope ²³⁵UF₆ to the sublevel [m(A₂):(3_{ν3})] of the third energy excitation state (3_{ν3}) of the _{ν3}-vibrational mode according to claim 1, wherein the duration of the selecting pumping beam in three-photon resonance with the [m(A₂):(3_{ν3})] sublevel at 628.527 cm⁻¹ is adjusted in conjunction with the frequency deviations of the intermediate levels Δω₁, and Δω₂ to facilitate the ready establishment of three-photon resonance and the selective excitation of the molecules of the desired isotope ²³⁵UF₆ to that level.

12. Apparatus for preferentially exciting and selectively dissociating the molecules of the desired ²³⁵UF₆ isotope in the molecular laser isotope separation process, comprising the design of an expansion nozzle capable of producing a supercooled molecular UF₆ gas mixture at temperatures below 100° K, preferably in the region of 60° K, wherein the selecting laser beam and the dissociating laser of the method of claim 1 can be applied to the molecular UF₆ gas at very high pulse repetition rates capable of irradiating all the molecules of the expansion supercooled gas.

13. Apparatus for the selective dissociation of the molecules of the desired isotope ²³⁵UF₆ in a supercooled UF₆ gas mixture, comprising the design of an expansion nozzle of claim 12 whereby the selective and dissociating beams can be applied collinearly and where two, three or more expansion nozzles can be placed in series for a more efficient separation process in a single pumping step.

14. A selective excitation and separation method for preferentially exciting and selectively dissociating or separating the molecules of the desired ²³⁵UF₆ isotope, according to claim 1, wherein different UF₆ gas assays can be employed as well as assays corresponding to the Tails percentages from other separation processes, or assays for higher enrichment separation factors, and where the pumping intensity parameters and the frequency parameters can be slightly adjusted to obtain the optimum efficiency for the isotope separation process.

15. A high selectivity isotope separation process for preferentially exciting and selectively dissociating or separating the molecules of the desired ²³⁵UF₆ isotope, of claim 14, wherein the Feed percentage of the desired isotope ²³⁵UF₆ can vary from high values to low values and where the isotope separation process described herein can be applied to produce more highly enriched Uranium Hexafluoride or applied to the treatment and separation of the desired isotope ²³⁵UF₆ of the Tails percentages, or to the treatment and separation of the desired isotope ²³⁵UF₆ of the Tails percentages of other separation processes, or to any other treatment of low percentage depleted Uranium.

16. A selective excitation method for the molecular laser isotope separation process according to claim 1, wherein the process is applied to the isotope separation of any other hexafluoride molecule wherein the frequency of the selecting laser corresponds to the frequency of three photon resonance with the [m(A₂):(3_{ν3})] sublevel of the third energy excitation state (3_{ν3}) of the said other hexafluoride molecule, and which has similar energy structure for the _{ν3}-vibrational mode, with its pumping intensity being adjusted within a specific intensity range set by the interaction parameters of the said molecules to fulfil the conditions described in the specification for the said molecules, the process being capable of application to any other polyatomic molecule with similar vibrational structure.

17. A selective excitation and separation process according to claim 1, wherein the method is applied to the SILEX process (a Separation of Isotopes by Laser Excitation (SILEX) process for the enhancement of the selective separation of the desired ²³⁵UF₆ isotope and the efficiency of the said process.

18. A method of preferentially exciting and selectively dissociating or separating the desired ²³⁵UF₆ isotope when used in the separation or enrichment of the Uranium Hexafluoride isotopes, or of any other hexafluoride molecules or similar isotopic species of claim 16.

19. A method of preferentially exciting and selectively dissociating or separating the desired isotope in a molecular laser isotope separation or enrichment process substantially as described herein and with reference to FIG. 9, FIG. 8(b), FIG. 10, FIG. 11, or FIGS. 9, 8(b), 10, 11 and 12(c) of the accompanying drawings.
